(19) United States
(12) Patent Application Publication
(10) Pub. No.: US 2023/0251547 A1
(43) Pub. Date: Aug. 10, 2023

(54) LENS ASSEMBLY INCLUDING PATH CORRECTION DEVICE

(71) Applicant: Meta Platforms Technologies, LLC, Menlo Park, CA (US)

(72) Inventors: Hsien-Hui CHENG, Woodinville, WA (US); Lu LU, Kirkland, WA (US); Xuan WANG, Kirkland, WA (US); Jin YAN, San Jose, CA (US)

(21) Appl. No.: 17/666,979

(22) Filed: Feb. 8, 2022

(51) Int. Cl. G02F 1/29; G02B 17/00; G02B 5/32; G03H 1/02; G02B 27/28; G01B 11/27

(52) U.S. Cl. CPC G02F 1/29; G02B 17/006; G02B 5/32; G03H 1/0248; G02B 27/283; G02B 27/286; G01B 11/272; G02F 2203/24; G02B 27/0172

(57) ABSTRACT

A device includes a polarization non-selective partial reflector configured to transmit a first portion of a first light and reflect a second portion of the first light. The device also includes a polarization selective reflector configured to reflect the first portion of the first light received from the polarization non-selective reflector back to the polarization non-selective reflector. The device further includes a path correction device disposed between the polarization non-selective partial reflector and the polarization selective reflector, and configured to forwardly steer the first portion of the first light propagating between the polarization non-selective partial reflector and the polarization selective reflector.

### TECHNICAL FIELD

The present disclosure generally relates to optical systems, devices, or assemblies and, more specifically, to a lens assembly including a path correction device.

### BACKGROUND

An artificial reality system, such as a head-mounted display (“HMD”) or heads-up display (“HUD”) system, generally includes a near-eye display (“NED”) system in the form of a headset or a pair of glasses, and configured to present content to a user via an electronic or optic display within, for example, about 10-20 mm in front of the eyes of a user. The NED system may display virtual objects or combine images of real objects with virtual objects, as in virtual reality (“VR”), augmented reality (“AR”), or mixed reality (“MR”) applications. It is often desirable to make NEDs that are compact and light weight, and have a high resolution, a large field of view (“FOV”), and a small form factor. An NED may include a light source (e.g., a display element) configured to generate an image light and a lens assembly configured to direct the image light towards eyes of a user. To achieve a compact size and light weight while maintaining satisfactory optical characteristics, the lens assembly may be designed to fold the optical path from the display element to the eye.

### SUMMARY OF THE DISCLOSURE

One aspect of the present disclosure provides a device that includes a polarization non-selective partial reflector configured to transmit a first portion of a first light and reflect a second portion of the first light. The device also includes a polarization selective reflector configured to reflect the first portion of the first light received from the polarization non-selective reflector back to the polarization non-selective reflector. The device further includes a path correction device disposed between the polarization non-selective partial reflector and the polarization selective reflector, and configured to forwardly steer the first portion of the first light propagating between the polarization non-selective partial reflector and the polarization selective reflector.

Another aspect of the present disclosure provides a method including detecting, by a controller based on a signal received from a sensor, a misalignment of at least one of a polarization non-selective partial reflector or a polarization selective reflector. The polarization non-selective partial reflector is configured to transmit a first portion of a first light and reflect a second portion of the first light, and the polarization selective reflector is configured to reflect the first portion of the first light received from the polarization non-selective reflector back to the polarization non-selective reflector. The method also includes controlling, by the controller, a path correction device disposed between the polarization non-selective partial reflector and the polarization selective reflector, to forwardly steer the first portion of the first light propagating between the polarization non-selective partial reflector and the polarization selective reflector.

Other aspects of the present disclosure can be understood by those skilled in the art in light of the description, the claims, and the drawings of the present disclosure.

### BRIEF DESCRIPTION OF THE DRAWINGS

The following drawings are provided for illustrative purposes according to various disclosed embodiments and are not intended to limit the scope of the present disclosure. In the drawings:

FIG. 1A schematically illustrates a diagram of a system including a conventional lens assembly for folding an optical path;

FIGS. 1B-1D schematically illustrate optical paths in the system shown in FIG. 1A including various types of misalignments of optical elements in the conventional lens assembly;

FIG. 2A schematically illustrates a diagram of a system including a lens assembly for folding an optical path, according to an embodiment of the present disclosure;

FIG. 2B illustrates an optical path of an image light in the system shown in FIG. 2A, according to an embodiment of the present disclosure;

FIG. 2C illustrates effects of a misalignment on the optical path when no path correction is provided in a first path folding segment of the lens assembly shown in FIG. 2A;

FIG. 2D illustrates a path correction provided by a path correction device included in the first path folding segment of the lens assembly shown in FIG. 2A, according to an embodiment of the present disclosure;

FIG. 2E illustrates effects of a misalignment on the optical path when no path correction is provided in a second path folding segment of the lens assembly shown in FIG. 2A;

FIG. 2F illustrates a path correction provided by a path correction device included in the second path folding segment of the lens assembly shown in FIG. 2A, according to an embodiment of the present disclosure;

FIG. 2G illustrates path corrections provided by path correction devices included in the system shown in FIG. 2A, when misalignments occur to both the first path folding segment and the second path folding segment of the lens assembly, according to an embodiment of the present disclosure;

FIG. 3A schematically illustrates a diagram of a system including a lens assembly for folding an optical path, according to an embodiment of the present disclosure;

FIG. 3B schematically illustrates a diagram of a system including a lens assembly for folding an optical path, according to an embodiment of the present disclosure;

FIG. 3C schematically illustrates a diagram of a system including a lens assembly for folding an optical path, according to an embodiment of the present disclosure;

FIG. 4A schematically illustrates a diagram of a system including a lens assembly for folding an optical path, according to an embodiment of the present disclosure;

FIG. 4B illustrates an optical path of an image light in the system shown in FIG. 4A, according to an embodiment of the present disclosure;

FIG. 4C schematically illustrates a diagram of a system including a lens assembly for folding an optical path, according to an embodiment of the present disclosure;

FIG. 4D illustrates an optical path of an image light in the system shown in FIG. 4C, according to an embodiment of the present disclosure;

FIG. 4E illustrates a path correction provided by a path correction device included in the lens assembly shown in FIG. 4A, according to an embodiment of the present disclosure;

FIG. 5 is a flowchart illustrating a method of providing an optical path correction to an image light, according to an embodiment of the present disclosure;

FIG. 6A schematically illustrates a diagram of a polarization selective beam steering device, according to an embodiment of the present disclosure;

FIG. 6B schematically illustrates a diagram of a polarization selective beam steering device, according to an embodiment of the present disclosure;

FIG. 6C illustrates a spatially varying phase profile provided by the polarization selective beam steering device shown in FIG. 6A, according to an embodiment of the present disclosure;

FIG. 6D illustrates a spatially varying phase profile provided by the polarization selective beam steering device shown in FIG. 6B, according to an embodiment of the present disclosure;

FIG. 6E schematically illustrates a diagram of a polarization selective beam steering device, according to an embodiment of the present disclosure;

FIG. 6F schematically illustrates a diagram of a polarization selective beam steering device, according to an embodiment of the present disclosure;

FIG. 6G illustrates a spatially varying phase profile provided by the polarization selective beam steering device shown in FIG. 6A, according to an embodiment of the present disclosure;

FIG. 7A schematically illustrates a diagram of a near-eye display (“NED”), according to an embodiment of the present disclosure; and

FIG. 7B illustrates a schematic cross-sectional view of the NED shown in FIG. 7A, according to an embodiment of the present disclosure.

### DETAILED DESCRIPTION

Embodiments consistent with the present disclosure will be described with reference to the accompanying drawings, which are merely examples for illustrative purposes and are not intended to limit the scope of the present disclosure. Wherever possible, the same reference numbers are used throughout the drawings to refer to the same or similar parts, and a detailed description thereof may be omitted.

Further, in the present disclosure, the disclosed embodiments and the features of the disclosed embodiments may be combined. The described embodiments are some but not all of the embodiments of the present disclosure. Based on the disclosed embodiments, persons of ordinary skill in the art may derive other embodiments consistent with the present disclosure. For example, modifications, adaptations, substitutions, additions, or other variations may be made based on the disclosed embodiments. Such variations of the disclosed embodiments are still within the scope of the present disclosure. Accordingly, the present disclosure is not limited to the disclosed embodiments. Instead, the scope of the present disclosure is defined by the appended claims.

As used herein, the terms “couple,” “coupled,” “coupling,” or the like may encompass an optical coupling, a mechanical coupling, an electrical coupling, an electromagnetic coupling, or any combination thereof. An “optical coupling” between two optical elements refers to a configuration in which the two optical elements are arranged in an optical series, and a light output from one optical element may be directly or indirectly received by the other optical element. An optical series refers to optical positioning of a plurality of optical elements in a light path, such that a light output from one optical element may be transmitted, reflected, diffracted, converted, modified, or otherwise processed or manipulated by one or more of other optical elements. In some embodiments, the sequence in which the plurality of optical elements are arranged may or may not affect an overall output of the plurality of optical elements. A coupling may be a direct coupling or an indirect coupling (e.g., coupling through an intermediate element).

The phrase “at least one of A or B” may encompass all combinations of A and B, such as A only, B only, or A and B. Likewise, the phrase “at least one of A, B, or C” may encompass all combinations of A, B, and C, such as A only, B only, C only, A and B, A and C, B and C, or A and B and C. The phrase “A and/or B” may be interpreted in a manner similar to that of the phrase “at least one of A or B.” For example, the phrase “A and/or B” may encompass all combinations of A and B, such as A only, B only, or A and B. Likewise, the phrase “A, B, and/or C” has a meaning similar to that of the phrase “at least one of A, B, or C.” For example, the phrase “A, B, and/or C” may encompass all combinations of A, B, and C, such as A only, B only, C only, A and B, A and C, B and C, or A and B and C.

When a first element is described as “attached,” “provided,” “formed,” “affixed,” “mounted,” “secured,” “connected,” “bonded,” “recorded,” or “disposed,” to, on, at, or at least partially in a second element, the first element may be “attached,” “provided,” “formed,” “affixed,” “mounted,” “secured,” “connected,” “bonded,” “recorded,” or “disposed,” to, on, at, or at least partially in the second element using any suitable mechanical or non-mechanical manner, such as depositing, coating, etching, bonding, gluing, screwing, press-fitting, snap-fitting, clamping, etc. In addition, the first element may be in direct contact with the second element, or there may be an intermediate element between the first element and the second element. The first element may be disposed at any suitable side of the second element, such as left, right, front, back, top, or bottom.

When the first element is shown or described as being disposed or arranged “on” the second element, term “on” is merely used to indicate an example relative orientation between the first element and the second element. The description may be based on a reference coordinate system shown in a figure, or may be based on a current view or example configuration shown in a figure. For example, when a view shown in a figure is described, the first element may be described as being disposed “on” the second element. It is understood that the term “on” may not necessarily imply that the first element is over the second element in the vertical, gravitational direction. For example, when the assembly of the first element and the second element is turned 180 degrees, the first element may be “under” the second element (or the second element may be “on” the first element). Thus, it is understood that when a figure shows that the first element is “on” the second element, the configuration is merely an illustrative example. The first element may be disposed or arranged at any suitable orientation relative to the second element (e.g., over or above the second element, below or under the second element, left to the second element, right to the second element, behind the second element, in front of the second element, etc.).

When the first element is described as being disposed “on” the second element, the first element may be directly or indirectly disposed on the second element. The first element being directly disposed on the second element indicates that no additional element is disposed between the first element and the second element. The first element being indirectly disposed on the second element indicates that one or more additional elements are disposed between the first element and the second element.

The term “processor” used herein may encompass any suitable processor, such as a central processing unit (“CPU”), a graphics processing unit (“GPU”), an application-specific integrated circuit (“ASIC”), a programmable logic device (“PLD”), or any combination thereof. Other processors not listed above may also be used. A processor may be implemented as software, hardware, firmware, or any combination thereof.

The term “controller” may encompass any suitable electrical circuit, software, or processor configured to generate a control signal for controlling a device, a circuit, an optical element, etc. A “controller” may be implemented as software, hardware, firmware, or any combination thereof. For example, a controller may include a processor, or may be included as a part of a processor.

The term “non-transitory computer-readable medium” may encompass any suitable medium for storing, transferring, communicating, broadcasting, or transmitting data, signal, or information. For example, the non-transitory computer-readable medium may include a memory, a hard disk, a magnetic disk, an optical disk, a tape, etc. The memory may include a read-only memory (“ROM”), a random-access memory (“RAM”), a flash memory, etc.

The term “film,” “layer,” “coating,” or “plate” may include rigid or flexible, self-supporting or free-standing film, layer, coating, or plate, which may be disposed on a supporting substrate or between substrates. The terms “film,” “layer,” “coating,” and “plate” may be interchangeable. The term “film plane” refers to a plane in the film, layer, coating, or plate that is perpendicular to the thickness direction or a normal of a surface of the film, layer, coating, or plate. The film plane may be a plane in the volume of the film, layer, coating, or plate, or may be a surface plane of the film, layer, coating, or plate. The term “in-plane” as in, e.g., “in-plane orientation,” “in-plane direction,” “in-plane pitch,” etc., means that the orientation, direction, or pitch is within the film plane. The term “out-of-plane” as in, e.g., “out-of-plane direction,” “out-of-plane orientation,” or “out-of-plane pitch” etc., means that the orientation, direction, or pitch is not within a film plane (i.e., non-parallel with a film plane). For example, the direction, orientation, or pitch may be along a line that is perpendicular to a film plane, or that forms an acute or obtuse angle with respect to the film plane. For example, an “in-plane” direction or orientation may refer to a direction or orientation within a surface plane, an “out-of-plane” direction or orientation may refer to a thickness direction or orientation non-parallel with (e.g., perpendicular to) the surface plane. In some embodiments, an “out-of-plane” direction or orientation may form an acute or right angle with respect to the film plane.

The term “orthogonal” as in “orthogonal polarizations” or the term “orthogonally” as in “orthogonally polarized” means that an inner product of two vectors representing the two polarizations is substantially zero. For example, two lights or beams with orthogonal polarizations (or two orthogonally polarized lights or beams) may be two linearly polarized lights (or beams) with two orthogonal polarization directions (e.g., an x-axis direction and a y-axis direction in a Cartesian coordinate system) or two circularly polarized lights with opposite handednesses (e.g., a left-handed circularly polarized light and a right-handed circularly polarized light).

The wavelength ranges, spectra, or bands mentioned in the present disclosure are for illustrative purposes. The disclosed optical device, system, element, assembly, and method may be applied to a visible wavelength band, as well as other wavelength bands, such as an ultraviolet (“UV”) wavelength band, an infrared (“IR”) wavelength band, or a combination thereof. The term “substantially” or “primarily” used to modify an optical response action, such as transmit, reflect, diffract, block or the like that describes processing of a light means that a major portion, including all, of a light is transmitted, reflected, diffracted, or blocked, etc. The major portion may be a predetermined percentage (greater than 50%) of the entire light, such as 100%, 98%, 90%, 85%, 80%, etc., which may be determined based on specific application needs.

The term “optic axis” may refer to a direction in a crystal. A light propagating in the optic axis direction may not experience birefringence (or double refraction). An optic axis may be a direction rather than a single line: lights that are parallel to that direction may experience no birefringence.

The term “substantially” or “primarily” used to modify an optical response action, such as transmit, reflect, diffract, block or the like that describes processing of a light means that a major portion, including all, of a light is transmitted, reflected, diffracted, or blocked, etc. The major portion may be a predetermined percentage (greater than 50%) of the entire light, such as 100%, 95%, 90%, 85%, 80%, etc., which may be determined based on specific application needs.

An NED may include a light source (e.g., a display element) configured to generate an image light, and a lens assembly configured to direct the image light towards eyes of a user. To achieve a compact size and light weight while maintaining satisfactory optical characteristics, the lens assembly may be designed to fold the optical path from the display element to the eye. Such a lens assembly may include multiple optical elements, e.g., lenses, mirrors, waveplates, reflectors, etc., for focusing the image light to the eyes. Such a lens assembly may be referred to as a path-folding lens assembly. Examples of the path-folding lens assembly may include a pancake lens assembly, a double pancake lens assembly, a lens assembly including one or more reflective holographic elements, etc. The optical performance of the lens assembly (or the image quality of the lens assembly) may depend on alignments of the multiple optical elements included in the lens assembly. When an optical element is misaligned, the optical performance of the lens assembly may be adversely affected. The term “misaligned” or “misalignment” means that an alignment parameter quantifying the alignment of an optical element included in the path-folding lens assembly deviates from a reference alignment parameter (when the optical element is aligned), and the deviation is greater than a predetermined threshold value. The alignment parameter indicates the position and/or orientation of the optical element in the lens assembly. The reference alignment parameter indicates the predetermined, reference position and/or orientation of the optical element when the optical element is aligned.

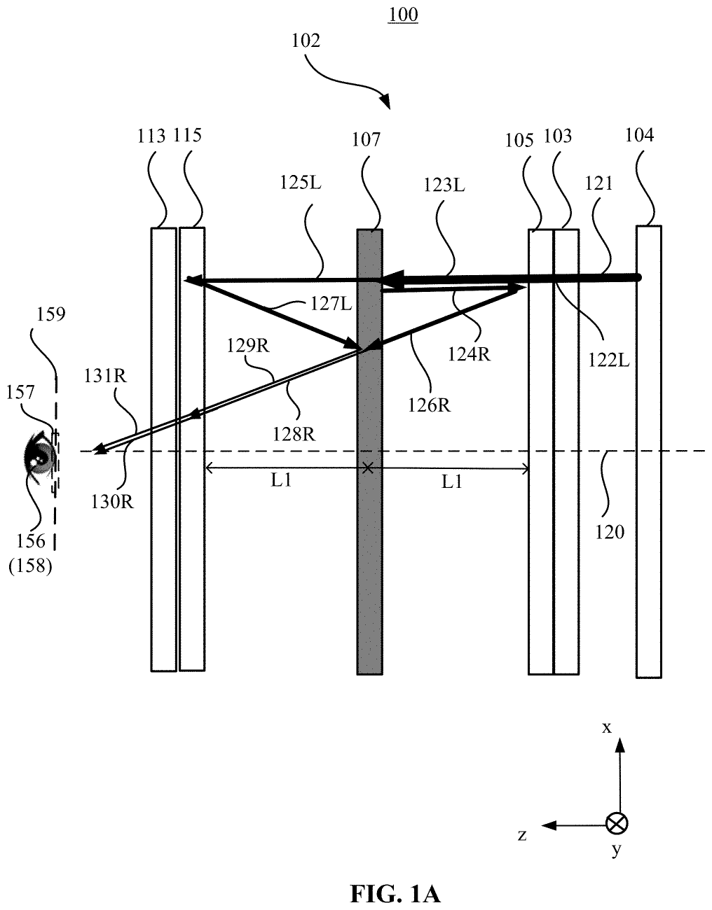

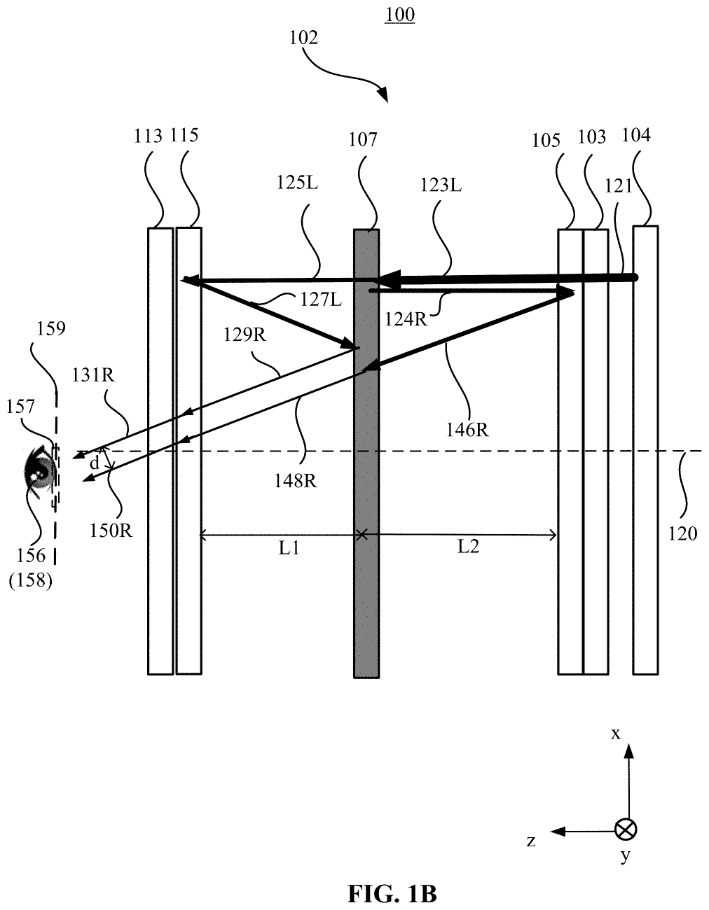

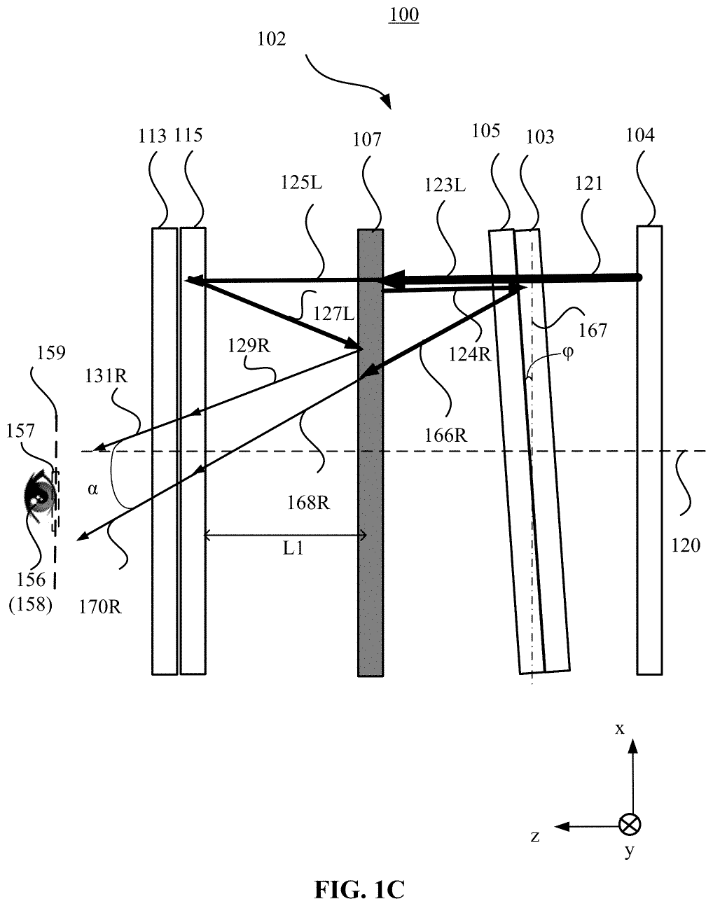

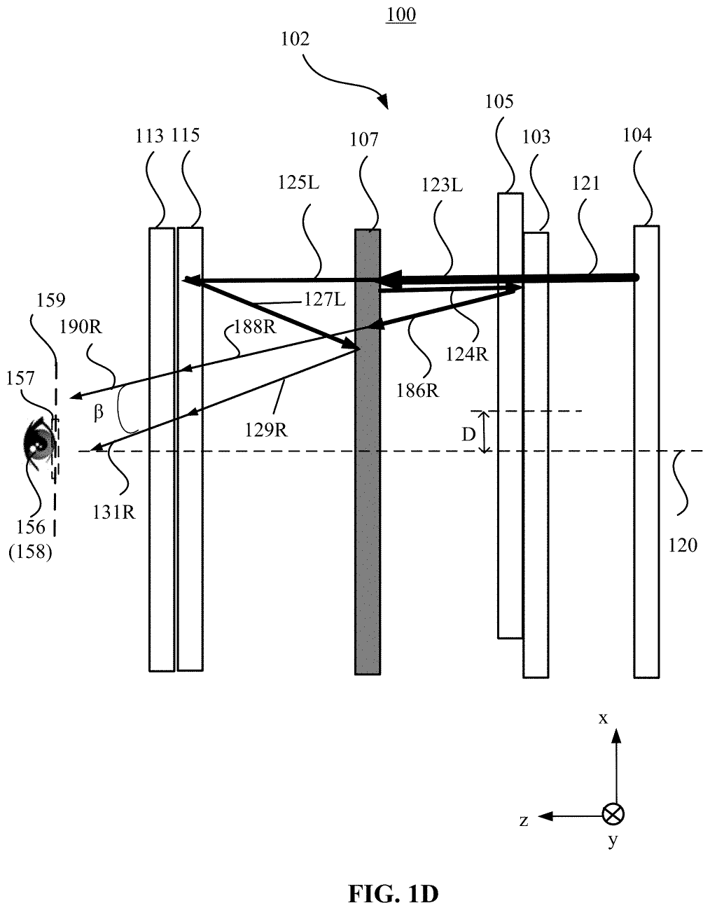

FIG. 1A schematically illustrates an x-z sectional view of a system 100 including a conventional path-folding lens assembly 102 (referred to as a lens assembly 102 hereafter for simplicity). As shown in FIG. 1A, the system 100 may include a light source assembly (e.g., a display element) 104 outputting an image light 121 representing a virtual image. The lens assembly 102 may be disposed between the display element 104 and an eye-box region 159. The lens assembly 102 may focus the image light 121 to one or more exit pupils 157 in the eye-box region 159 of the system 100. The lens assembly 102 may transform the rays (forming a divergent image light) emitted from each light outputting unit of the display element 104 into a bundle of parallel rays or a collimated light that substantially covers one or more exit pupils 157 in the eye-box region 159 of the system 100. For discussion purposes, FIG. 1A shows a single ray of the image light 121 emitted from a light outputting unit (e.g., a pixel) at the upper half of the display element 104. The exit pupil 157 may correspond to a spatial zone where an eye pupil 158 of the eye 156 may be positioned in the eye-box region 169 of the system 100 to perceive the virtual image.

The lens assembly 102 may include a first circular polarizer 103, a first reflective polarization volume hologram (“PVH”) element configured with a first optical power (i.e., functioning as a first PVH lens), a partial reflector 107, a second reflective PVH element configured with a second optical power (i.e., functioning as a second PVH lens), and a second circular polarizer 113 arranged in an optical series. For discussion purposes, the first reflective PVH element configured with the first optical power 105 and the second reflective PVH element configured with the second optical power 115 are referred to as a first PVH element 105 and a second PVH element 115, respectively.

The partial reflector 107 may be configured to partially transmit an input light while maintaining the polarization and propagation direction, and partially reflect the input light while changing the polarization, independent of the polarization of the input light. That is, regardless of the polarization of the input light, the partial reflector may partially transmit the input light and partially reflect the input light. For discussion purposes, the partial reflector 107 is also referred to as a mirror. In some embodiments, the mirror 107 may be configured to transmit about 50% of an input light and reflect about 50% of the input light (referred to as a 50/50 mirror).

FIG. 1A illustrates an optical path or a propagation path of the image light 121 propagating from the display element 104 to the eye-box region 159 through the lens assembly 102. In below figures, the letter “R” appended to a reference number (e.g., “124R”) denotes a right-handed circularly polarized (“RHCP”) light, and the letter “L” appended to a reference number (e.g., “123L”) denotes a left-handed circularly polarized (“LHCP”) light, the letter “s” appended to a reference number denotes an s-polarized light, and the letter “p” appended to a reference number denotes a p-polarized light. Various elements included in the lens assembly 102 are aligned to achieve a predetermined high image quality. It is presumed that there is no misalignment of the various elements, or the misalignment is negligible such that the effects of the misalignment on the optical performance of the lens assembly 102 is negligible. In the aligned configuration, all elements are perpendicular to an optical axis 120 of the lens assembly 102, with optical centers of the first PVH element 105, the mirror 107, and the second PVH element 115 located on an optical axis 120. In addition, a distance (e.g., L1) between the first PVH element 105 and the mirror 107 may be equal to a distance (e.g., L1) between the second PVH element 115 and the mirror 107.

The first PVH element 105 and the second PVH element 115 may have the same optical power and different polarization selectivities (e.g., may reflect lights of orthogonal polarizations). For example, the first PVH element 105 may function as a right-handed PVH lens that reflects and converges, via diffraction, an RHCP light, and transmits an LHCP light with negligible or zero diffraction. The second PVH element 115 may function as a left-handed PVH lens that reflects and converges, via diffraction, an LHCP light, and transmits an RHCP light with negligible or zero diffraction.

As shown in FIG. 1A, the first circular polarizer 103 may convert the image light 121 into an image light 122L. The first PVH element 105 may substantially transmit the image light 122L as an image light 123L toward the mirror 107. The mirror 107 may transmit a first portion of the image light 123L as an image light 125L toward the second PVH element 115, and reflect a second portion of the image light 123L back to the first PVH element 105 as an image light 124R. The second PVH element 115 may substantially reflect and converge, via diffraction, the image light 125L as an image light 127L toward the mirror 107. The mirror 107 may transmit a first portion of the image light 127L toward the first PVH element 105 as an LHCP image light (not shown), and reflect a second portion of the image light 127L back to the second PVH element 115 as an image light 129R. The second PVH element 115 may substantially transmit the image light 129R while maintaining the polarization and propagation direction. The second circular polarizer 113 may transmit the image light 129R as an image light 131R toward the eye-box region 159.

When the image light 123L is normally incident onto the mirror 107, the mage light 124R may propagate in a direction opposite to the propagation direction of the image light 123L. That is, the image light 124R and the image light 123L may substantially coincide with one another and have opposite propagation directions. To better illustrate the optical paths of the image light 124R and the image light 123L, FIG. 1A shows a small gap between the image light 124R and the image light 123L. The first PVH element 105 may reflect and converge, via diffraction, the image light 124R as an image light 126R toward the mirror 107. The mirror 107 may transmit a first portion of the image light 126R toward the second PVH element 105 as an image light 128R, and reflect a second portion of the image light 126R back to the first PVH element 105 as an LHCP image light (not shown). The second PVH element 115 may substantially transmit the image light 128R, while maintaining the propagation direction and the polarization. The second circular polarizer 113 may transmit the image light 128R as an image light 130R toward the eye-box region 159. As the first PVH element 105 and the second PVH element 115 have the same optical power, and the various elements (e.g., the first PVH element 105, the mirror 107, and the second PVH element 115) in the lens assembly 102 are aligned, the image light 130R and the image light 131R may substantially coincide or overlap with one another, forming a single image with a high image quality within the exit pupil 158.

For discussion purposes, the optical path of the image light from the display element 104 to the mirror 107 may be referred to as a common optical path of the image light output from the display element 104. The common optical path is formed by the optical paths of the image lights 121, 122L, and 123L. The optical paths of the image lights 124R, 126R, 128R, and 130R may be collectively referred to as a first folding optical path or first optical path. The optical paths of the image lights 125L, 127L, 129R, and 131R may be collectively referred to as a second folding optical path or second optical path.

The overall optical path shown in FIG. 1A is a target (or reference) optical path of the image light emitted from the display element 104 when various elements in the lens assembly 102 are aligned. When one or more of the various elements (e.g., the first PVH element 105, the mirror 107, and/or the second PVH element 115) included in the lens assembly 102 are misaligned from respective reference alignment positions and/or orientations, the misalignment may cause the actual optical path to deviate from the target optical path, degrading the quality of the image formed at the exit pupil 158. For example, a burry image, an image distortion, and/or a ghost image may be perceived by the eye 156.

FIGS. 1B-1D illustrate optical paths of the image light 121 from the display element 104 when the first PVH element 105 is misaligned in various aspects (e.g., positions or orientations). In FIGS. 1B-1D, the common optical path and the second folding optical path of the image light 121 may not be affected by the misalignment of the first PVH element 105, and may be the same as those shown in FIG. 1A. The first folding optical path of the image light 121 may be affected by the misalignment of the first PVH element 105, and may deviate from a target first optical path shown in FIG. 1A. Similarly, although not shown, if the second PVH element 115 is misaligned, the common path and the first folding optical path may not be affected by the misalignment of the second PVH element 115, and the second folding optical path may be affected by the misalignment of the second PVH element 115.

In FIG. 1B, the misalignment is caused by the axial distance change (a change in the position along the optical axis 120) of the first PVH element 105. Instead of being disposed at a target distance L1 from the mirror 107, the first PVH element 105 may be disposed at a distance L2 (deviated from L1) from the mirror 107, where L2 is greater than L1. It is noted that the axial distance misalignment may also be caused by shift of the position of the mirror 107 and/or the second PVH element 115.

As shown in FIG. 1B, the first PVH element 105 may reflect and converge, via diffraction, the image light 124R as an image light 146R toward the mirror 107. The mirror 107 may transmit a first portion of the image light 146R toward the second PVH element 105 as an image light 148R while maintaining the propagation direction, and reflect a second portion of the image light 146R back to the first PVH element 105 as an LHCP image light (not shown). The second PVH element 115 may substantially transmit the image light 148R while maintaining the propagation direction and polarization. The second circular polarizer 113 may transmit the image light 148R as an image light 150R toward the eye-box region 159 while maintaining the polarization and propagation direction. As the distance (e.g., L2) between the first PVH element 105 and the mirror 107 is greater than the target distance (e.g., L1), the image light 150R may be shifted from the image light 131R by a distance d at the eye-box region 159, resulting in an image distortion, a burry image, or double images at the eye-box region 159.

In FIG. 1C, the misalignment is caused by the tilt (i.e., a change in the orientation) of the first PVH element 105. A tilt misalignment occurs when the optical element rotates from a predetermined orientation. For example, the predetermined orientation may be an orientation in which the optical element is perpendicular to the optical axis 120, when the optical element is at an aligned state. The predetermined orientation may be represented by a vertical plane that is perpendicular to the optical axis 120. A tilt misalignment occurs when the optical element rotates from the vertical plane that is perpendicular to the optical axis 120. For example, the first PVH element 105 may tilt from a vertical plane 167 by an acute angle (p. The vertical plane 167 is perpendicular to the optical axis 120, and represents a predetermined orientation of the first PVH element 105 when the first PVH element 105 is at an aligned state. The acute angle φ is presumed to be greater than a predetermined threshold angle. The predetermined threshold angle may be 0.05°, 0.1°, 0.2°, 0.3°, 0.5°, 1°, etc., which may be determined based on specific applications. It is noted that the tilt misalignment may also occur to the mirror 107 and/or the second PVH element 115. The tilt may be one dimensional or two dimensional. That is, the first PVH element 105, the mirror 107, or the second PVH element 115 may rotate from respective aligned orientations around the y-axis, or around both the x-axis and y-axis.

As shown in FIG. 1C, the first PVH element 105 may reflect and converge, via diffraction, the image light 124R as an image light 166R toward the mirror 107. The mirror 107 may transmit a first portion of the image light 166R toward the second PVH element 105 as an image light 168R, and reflect a second portion of the image light 166R back to the first PVH element 105 as an LHCP image light (not shown). The second PVH element 115 may substantially transmit the image light 168R while maintaining the polarization and propagation direction. The second circular polarizer 113 may transmit the image light 168R as an image light 170R toward the eye-box region 159 while maintaining the polarization and propagation direction. As the first PVH element 105 is titled with respective to the vertical plane 167 by an acute angle φ, the image light 170R may be rotated away from the image light 131R, resulting in an angular separation of a.

The angular separation of a may cause a distance separation of the respective images formed by the image light 170R and the image light 131R at the eye-box region 159. That is, the image formed by the image light 170R may be shifted away from a predetermined position at the eye-box region 259 where an image formed by the image light 131R is located. The image shift may result in an image distortion, a burry image, or double images at the exit pupil 158. For example, for the system 100 having an eye relief distance of 15 mm and the target distance L1 of 10 mm, when the first PVH element 105 is tilted with respective to the vertical plane 167 by 0.1°, the respective images formed by the image light 170R and the image light 131R may be separated from one another by a distance of about 150 μm at the eye-box region 159. The separation of about 150 μm may be larger than the pixel size (e.g., about 20 μm) of the display element 104, causing a severe image distortion at the eye-box region 159.

In FIG. 1D, the misalignment is caused by the deviation of the optical center from the optical axis 120 (i.e., a change in the position relative to the optical axis). The optical center of the first PVH element 105 may deviate from an aligned position at the optical axis 120 by a distance D. As shown in FIG. 1D, the first PVH element 105 may reflect and converge, via diffraction, the image light 124R as an image light 186R toward the mirror 107. The mirror 107 may transmit a first portion of the image light 186R toward the second PVH element 115 as an image light 188R, and reflect a second portion of the image light 186R back to the first PVH element 105 as an LHCP image light (not shown). The second PVH element 115 may substantially transmit the image light 188R while maintaining the polarization and propagation direction. The second circular polarizer 113 may transmit the image light 188R as an image light 190R toward the eye-box region 159. As the optical center of the first PVH element 105 is shifted from the optical axis 120 by the distance D, the image light 190R and the image light 131R may have an angular separation of β. As a result, the image formed by the image light 190R at the eye-box region 159 may be shifted by a distance from the image formed by the image light 131R at the eye-box region 159. This may cause an image distortion, a burry image, or double images may be perceived by the eye 156 at the eye-box region 159.

As shown in FIGS. 1A-1D, misalignments of the various optical elements in the path-folding lens assembly 102 may degrade the image quality of images rendered at the eye-box region 159. Similar misalignments may occur in path-folding lens assemblies having other configurations. In conventional technologies, expensive equipment is used to correct the deviation of the optical path of an image light from a target optical path caused by a misalignment when the optical elements are assembled to form a path-folding lens assembly, which results in a high manufacturing cost. The output quality control cost may be high due to the high failure rate of the fabricated lens assemblies. A high percentage of the fabricated lens assemblies may be wasted due to the failure to meet a predetermined alignment specification. The cycle time for manufacturing the lens assembly may be long in conventional technologies due to the time-consuming optical path correction. In addition, when the user operates the NED including the path-folding lens assembly 102, the alignments of the various optical elements in the path-folding lens assembly 102 may be changed (i.e., misalignment may occur) after the NED experiences a shock or impact. It may be challenging for the user to realign the various optical elements in the path-folding lens assembly 102.

In view of the limitations in the conventional technologies, the present disclosure provides a path-folding lens assembly including one or more path correction devices to correct (or reduce, or mitigate) a deviation in an actual optical path from a target optical path, in which the deviation is caused by a misalignment in the position and/or the orientation of an optical element included in the path-folding lens assembly. The disclosed path-folding lens assembly may be implemented into an artificial reality system in the form of eyeglasses, goggles, a helmet, a visor, or some other type of eyewear to improve the image quality and the optical performance of the artificial reality system.

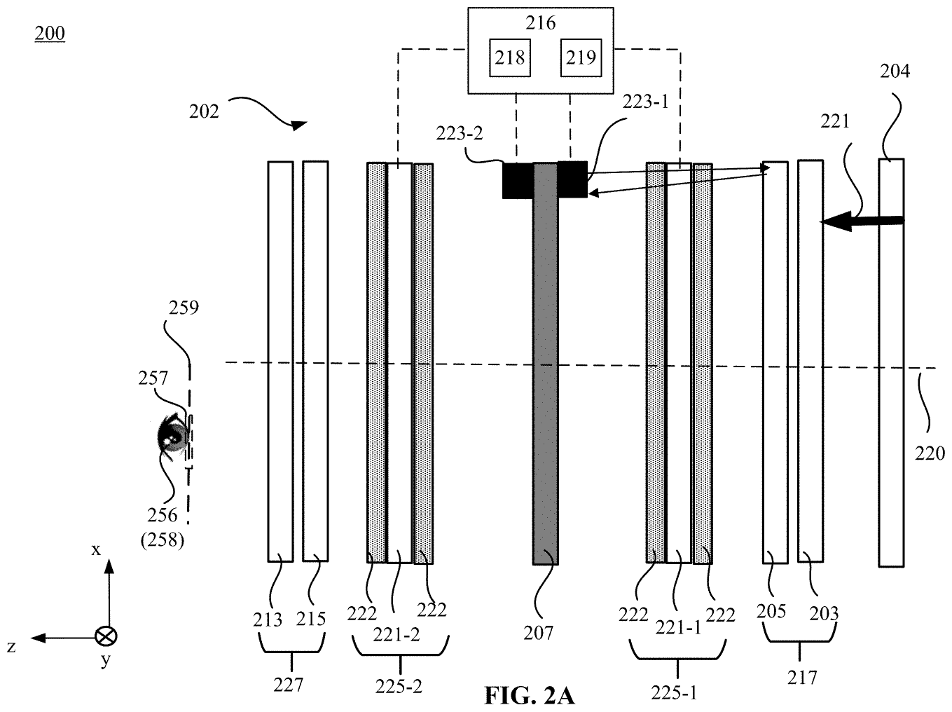

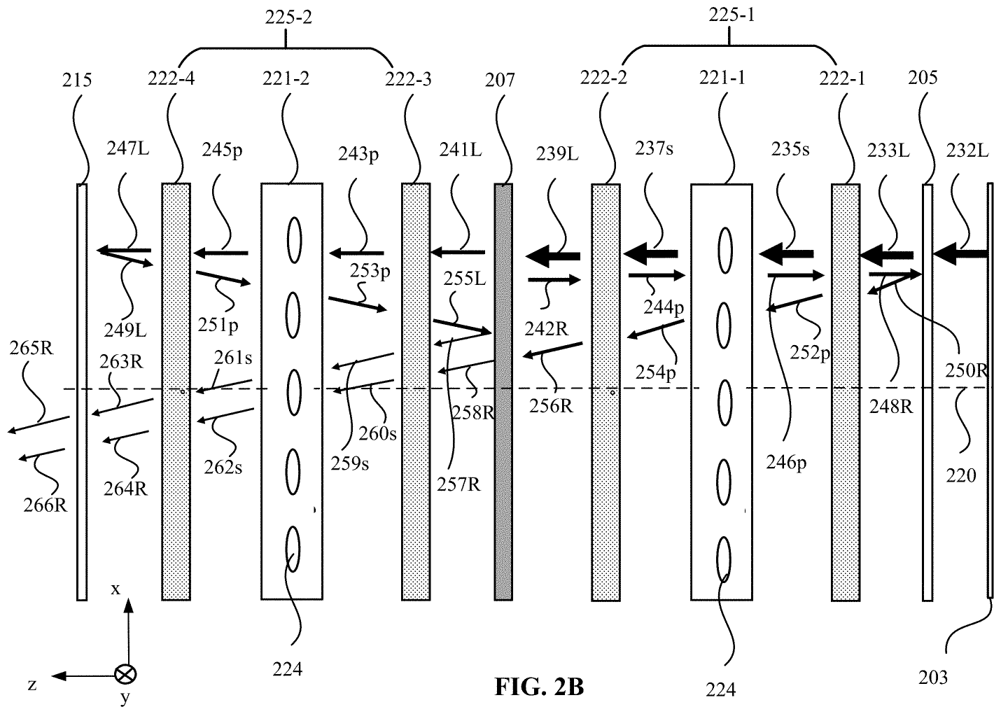

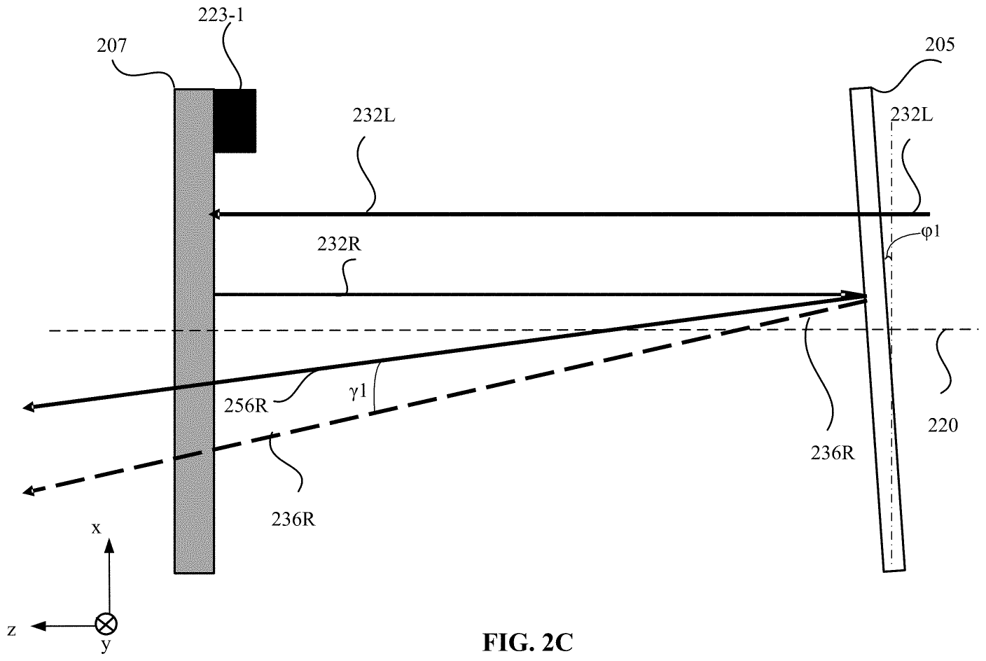

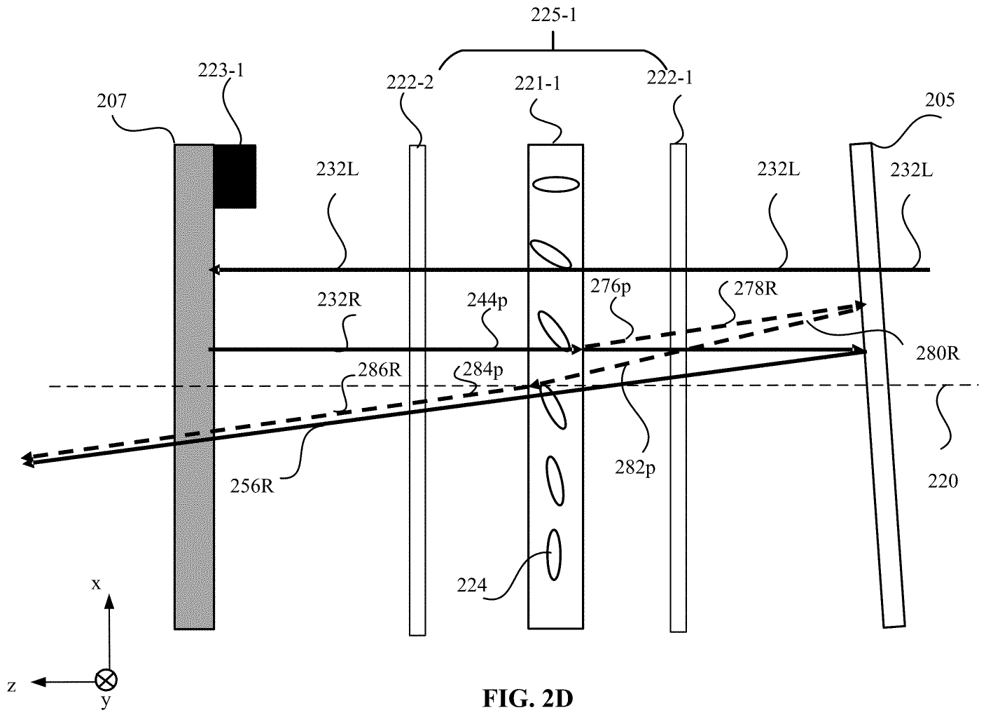

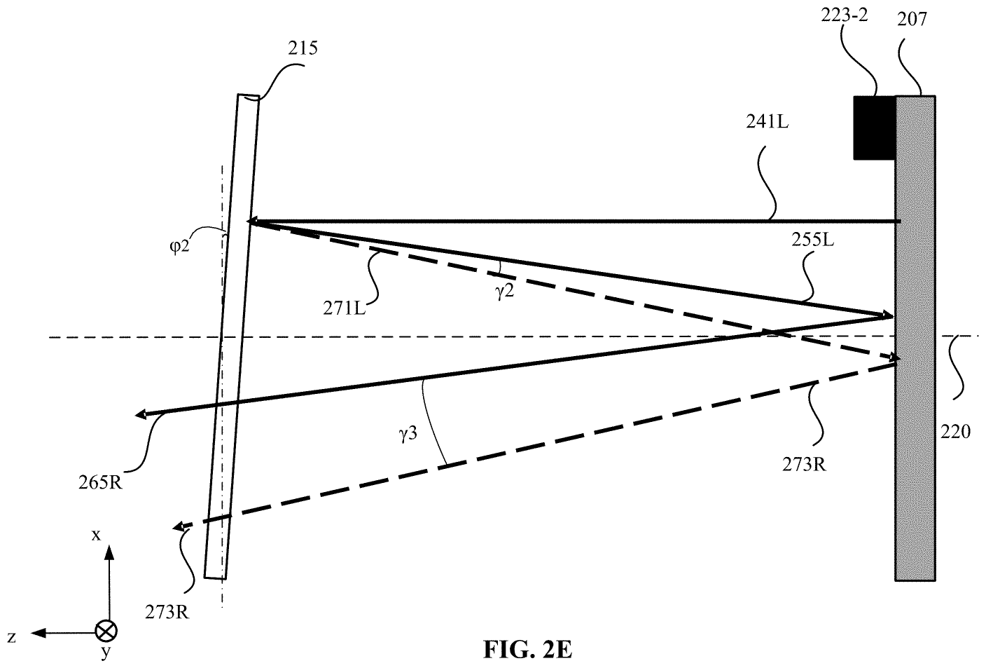

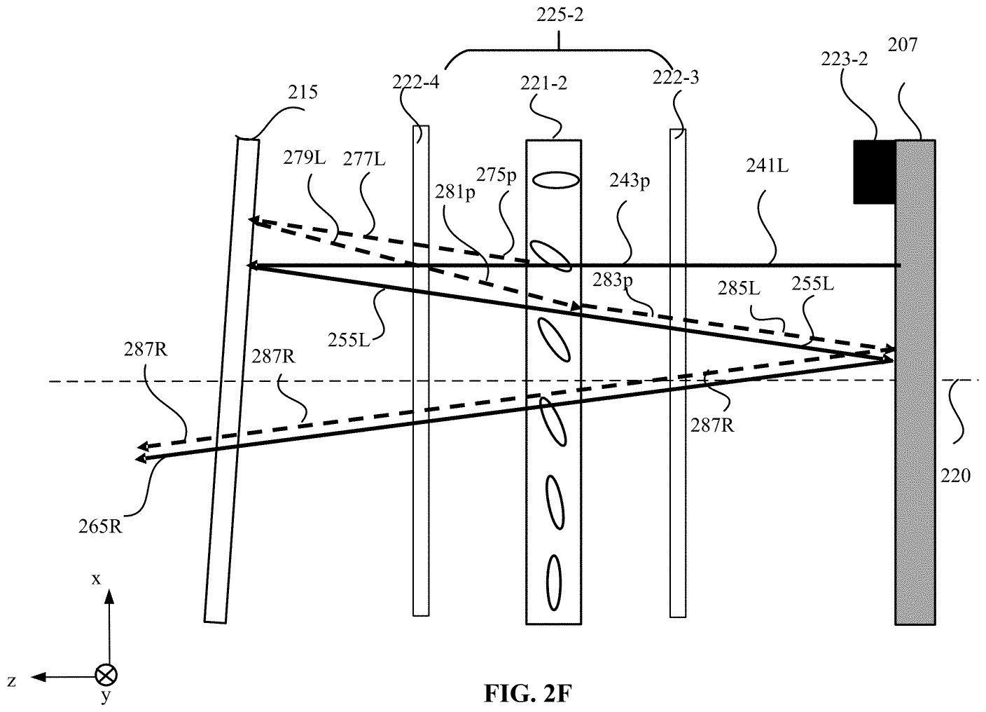

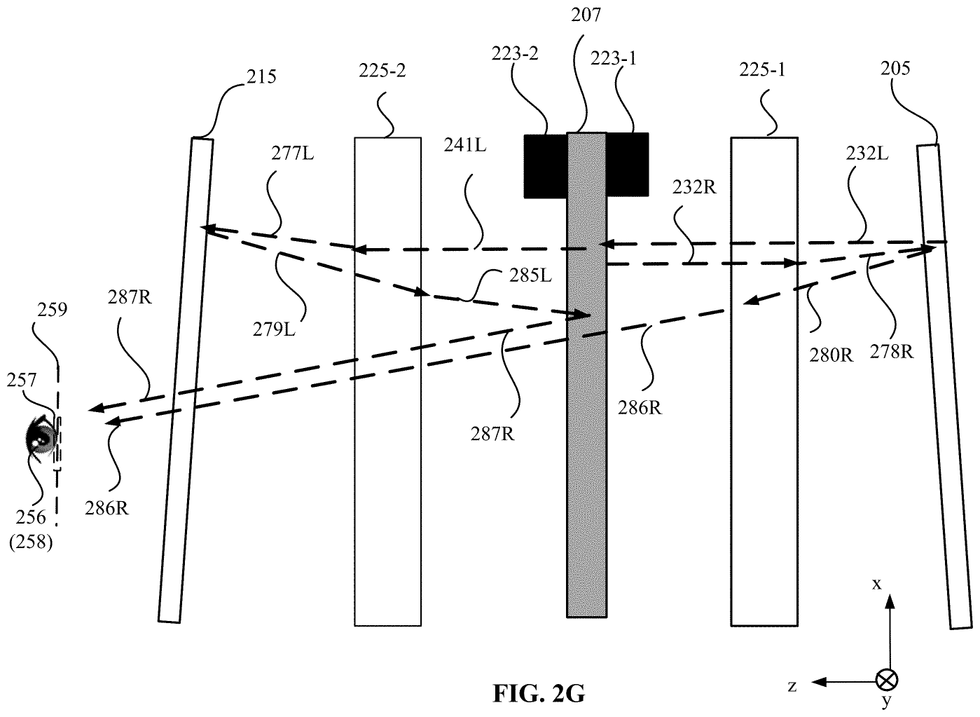

FIG. 2A schematically illustrates a diagram of a system 200, according to an embodiment of the present disclosure. In some embodiments, the system 200 may be a part of an NED. As shown in FIG. 2A, the system 200 may include a light source 204. The light source 204 may be a light outputting device, such as a display element. For discussion purposes, the light source 204 is also referred to as the display element 204. The system 200 may also include a lens assembly 202 disposed between the display element 204 and an eye-box region 259 where an eye 256 of a user may be located. The lens assembly 202 may be configured to fold an optical path of an image light emitted by the display element 204 and propagating to the eye-box region 259 via the lens assembly 202. The system 200 may also include a controller 216 configured to control the operations of the lens assembly 202.

The display element 204 may be configured to output an image light 221 representing a virtual image (or a portion of the virtual image) toward the lens assembly 202. The lens assembly 102 may focus the image light 121 to one or more exit pupils 257 in an eye-box region 259 of the system 200. In some embodiments, the lens assembly 202 may transform the rays emitted from each light outputting unit of the display element 204 into a bundle of parallel rays or a collimated image light that substantially covers one or more exit pupils 257 in the eye-box region 259 or that covers the entire eye-box region 259. For illustrative purposes, FIG. 2A shows a single ray of the image light 221 output from a light outputting unit at an upper portion of the display element 204. The exit pupil 257 may be a spatial zone where an eye pupil 258 of the eye 256 may be positioned in the eye-box region 259 to perceive the virtual image (or a portion of the virtual image).

For illustrative purposes, FIG. 2A shows a single display element 204 for a single eye of the user. In some embodiments, the system 200 may include multiple display elements 204, such as two display elements 204 for both eyes of the user. The display element 204 may include a display panel, such as a liquid crystal display (“LCD”) panel, a liquid-crystal-on-silicon (“LCoS”) display panel, an organic light-emitting diode (“OLED”) display panel, a micro light-emitting diode (“micro-LED”) display panel, a digital light processing (“DLP”) display panel, a laser scanning display panel, or a combination thereof. In some embodiments, the display element 204 may include a self-emissive panel, such as an OLED display panel or a micro-LED display panel. In some embodiments, the display element 204 may include a display panel that is illuminated by an external source, such as an LCD panel, an LCoS display panel, or a DLP display panel. Examples of an external source may include a laser, an LED, an OLED, or a combination thereof.

The lens assembly 202 may be a path-folding lens assembly configured to increase the length of an optical path of the image light 221 from the display element 204 to the exit pupil 257, by folding the optical path of the image light 221 from the display element 204 to the exit pupil 257. Due to the path folding, the lens assembly 202 may increase a field of view (“FOV”) of the system 200 without increasing the physical distance between the display element 204 and the eye-box region 259, and without compromising the image quality. The lens assembly 202 may include a first optical component 217, a second optical component 227, and a third optical component 207 arranged in an optical series, with the third optical component 207 disposed between the first optical element 217 and the second optical element 227. At least one (e.g., each) of the first optical component 217 or the second optical component 227 may be configured as a reflective and polarization selective optical component with a lens function (i.e., configured with an optical power). For example, at least one (e.g., each) of the first optical components 217 and 227 may include a single reflective and polarization selective optical element with a lens function (e.g., a single reflective and polarization selective lens), or may include two optical elements respectively configured with a polarization selective lens function and a polarization selective reflection function.

In some embodiments, at least one (e.g., each) of the first optical component 217, the second optical component 227, or the third optical component 207 may include a reflector. A reflector may be polarization selective or polarization non-selective (i.e., polarization independent). In some embodiments, at least one (e.g., each) of the first optical component 217 and the second optical component 227 may include a polarization selective reflector, and the third optical component 207 may include a polarization non-selective reflector. A polarization selective reflector may be configured to reflect an input light having a first polarization (e.g., a circular polarization, or linear polarization), and transmit an input light having a second polarization (e.g., an orthogonal circular polarization, or an orthogonal linear polarization) different from (e.g., orthogonal to) the first polarization. Examples of the polarization selective reflector may include a linear reflective polarizer, a circular reflective polarizer (e.g., a cholesteric liquid crystal reflective polarizer), a reflective polarization volume hologram (“PVH”) element, etc. The polarization selective reflector may or may not be configured with an optical power. When configured with an optical power, the polarization selective reflector may also function as a lens to diverge or converge the input light having a predetermined polarization (e.g., the first polarization). This type of polarization selective reflector may also be referred to as a reflective polarization selective lens.

A polarization non-selective reflector may reflect an input light independent of the polarization of the input light. An example of the polarization non-selective reflector is a polarization non-selective partial reflector. The polarization non-selective partial reflector may partially transmit a portion of an input light and partially reflect a portion of the input light, independent of the polarization of the input light. The polarization non-selective reflector may also be simply referred to as a “partial reflector” in the following descriptions. Examples of polarization non-selective partial reflectors may include a volume Bragg grating (“VBG”), a 50:50 mirror (transmitting 50% and reflecting 50%), etc. The polarization non-selective partial reflector may be configured with or without an optical power. In a partial reflector, the percentages of the input light for the transmitted portion and the reflected portion may be any suitable percentages, such as 10%/90%, 20%/80%, 30%/70%, 40%/60%, 50%/50%, etc.

For illustrative and discussion purposes, in the embodiment shown in FIG. 2A, the third optical component 207 is presumed to include a polarization non-selective (i.e., independent) partial reflector, e.g., a 50:50 mirror. Thus, the third optical component 207 is also referred to as a mirror 207. Each of the first optical component 217 and the second optical component 227 may include a polarization selective reflector 205 or 215. The polarization selective reflectors 205 and 215 may be configured with opposite polarization selectivities. For example, the polarization selective reflector 205 may be configured to reflect an input light having a first polarization (e.g., an RHCP light) and transmit an input light having a second polarization (e.g., an LHCP light), which may be orthogonal to the first polarization. The polarization selective reflector 215 may be configured reflect an input light having the second polarization (e.g., an LHCP light) and transmit an input light having the first polarization (e.g., an RHCP light).

An image light from the display element 204 may be transmitted and reflected multiple times between the third optical component 207 and the first optical component 217, and between the third optical component 207 and the second optical component 227, before the image light is output to the eye-box region 259. That is, the optical path of the image light from the display element 204 may be folded two or more times before the image light arrives at the eye-box region 259. The portion of the lens assembly 202 between the third optical component 207 and the first optical component 217 may be referred to as a first path folding segment of the lens assembly 202, and the portion of the lens assembly 202 between the third optical component 207 and the second optical component 227 may be referred to as a second path folding segment of the lens assembly 202.

A first portion of the image light output from the display 204 may propagate in the first path folding segment between the mirror 207 and the first polarization selective reflector 205 before entering the second path folding segment (between the mirror 207 and the second polarization selective reflector 215) and reaching the eye-box region 259. The first portion of the image light entering the second path folding segment from the first path folding segment may not be affected by the second path folding segment in terms of the propagation direction. A second portion of the image light from the display 204 may be transmitted through the mirror 207 to enter the second path folding segment, and may propagate in the second path folding segment between the mirror 207 and the second polarization selective reflector 215 before arriving at the eye-box region 259. In each of the first path folding segment and the second path folding segment, the image light may be folded at least two times to increase the length of the optical path.

In some embodiments, the polarization selective reflector 205 or 215 may be configured as a reflective PVH element with an optical power, i.e., a reflective PVH lens. For discussion purposes, the polarization selective reflector 205 and the polarization selective reflector 215 are also referred to as a first PVH element 205 and a second PVH element 215, respectively. The PVH element described herein may be fabricated based on various methods, such as holographic interference, laser direct writing, ink-jet printing, and various other forms of lithography. Thus, a “hologram” described herein is not limited to creation by holographic interference, or “holography.”

The optical power of the PVH element 205 or 215 may be fixed or adjustable. In some embodiments, the first PVH element 205 and the second PVH element 215 may be configured with the same optical power and different polarization selectivities. In some embodiments, the first PVH element 205 and the second PVH element 215 may be configured with different optical powers and different polarization selectivities. For example, the first PVH element 205 may be configured to reflect and converge, via diffraction, an input light having the first polarization, and transmit without converging an input light having the second polarization with negligible or zero diffraction. That is, the first PVH element 205 may maintain the propagation direction of the input light having the second polarization while transmitting the input light having the second polarization. The second PVH element 215 may be configured to reflect and converge, via diffraction, an input light having the second polarization, and transmit without converging an input light having the first polarization with negligible or zero diffraction. That is, the second PVH element 215 may maintain the propagation direction of the input light having the first polarization while transmitting the input light having the first polarization. In some embodiments, the first polarization may be a circular polarization having a first handedness (e.g., left-handedness), and the second polarization may be a circular polarization having a second handedness (e.g., right-handedness) that is opposite to the first handedness.

In some embodiments, the first optical component 217 may also include a first polarizer 203 coupled with the first PVH element 205. The first polarizer 203 may be disposed between the first PVH element 205 and the display element 204, or disposed at a side of the first PVH element 205 opposite to a side that faces the mirror 207. In some embodiments, the first polarizer 203 may be an absorptive circular polarizer configured to transmit a circularly polarized light having the second handedness, and block, via absorption, a circularly polarized light having the first handedness. In some embodiments, the display element 204 may be configured to output the image light 221 that is an unpolarized or linearly polarized image light. The first polarizer 203 may be configured to convert the image light 221 into a circularly polarized image light having the second handedness propagating toward the first PVH element 205. In some embodiments, when the display element 204 is configured to output the image light 221 that is a circularly polarized image light having the second handedness, the first polarizer 203 may be omitted. In some embodiments, when the display element 204 is configured to output the image light 221 that is a linearly polarized image light, the first optical component 217 may not include the first polarizer 203. Instead, the first optical component 217 may include a waveplate (e.g., a quarter-wave plate) in place of the first polarizer 203. The waveplate may be configured to convert the image light 221 into a circularly polarized image light having the second handedness propagating toward the first PVH element 205.

In some embodiments, the second optical component 227 may also include a second polarizer 213 coupled with the second PVH element 215. The second polarizer 213 may be disposed between the second PVH element 215 and the eye-box region 259, or disposed at a side of the second PVH element 215 opposite to a side that faces the mirror 207. In some embodiments, the second polarizer 213 may be an absorptive circular polarizer configured to transmit a circularly polarized image light having the first handedness, and block, via absorption, a circularly polarized image light having the second handedness. The second polarizer 213 may be configured to block, via absorption, an image light having a predetermined undesirable polarization (e.g., a circularly polarized image light having the second handedness), thereby enhancing the image quality at the eye-box region 259. In other words, the second polarizer 213 may function as a “clean up” polarizer that removes, via absorption, an image light having the predetermined undesirable polarization. In some embodiments, the second polarizer 213 may be omitted.

In some embodiments, the lens assembly 202 may include a first path correction device 225-1 disposed between the first optical component 217 and the mirror 207, and a second path correction device 225-2 disposed between the second optical component 227 and the mirror 207. In some embodiments, one of the first path correction device 225-1 and the second path correction device 225-2 may be omitted. The path correction devices disclosed herein may also be referred to as beam steering devices, beam deflectors, or phase correction devices. In some embodiments, the lens assembly 202 may include at least one sensor configured to measure an alignment parameter of the first PVH element 205, the second PVH element 215, or the mirror 207. For example, the lens assembly 202 may include a first sensor (or detector) 223-1 and a second sensor (or detector) 223-2 disposed at opposite sides (e.g., surfaces) of the mirror 207. The locations of the sensors 223-1 and 223-2 shown in FIG. 2A are for illustrative purposes. The location, size, number, and shape of the sensors may be configured based on specific applications. In some embodiments, instead of being disposed at the mirror 207, the first sensor 223-1 and the second sensor 223-2 may be at the first optical component 217 and the second optical component 227, respectively. In some embodiments, one of the first sensor 223-1 and the second sensor 223-2 may be omitted.

The sensors 223-1 and 223-2 may be any suitable sensors that can measure one or more alignment parameters of at least one of the mirror 207, the first optical component 217 (including the first PVH element 205), or the second optical component 227 (including the second PVH element 215). FIG. 2A schematically illustrates one example of detecting a misalignment of the first PVH element 205. The same principle may apply to detecting the misalignment of the second PVH element 215, or the mirror 207. As shown in FIG. 2A, the first sensor 223-1 may emit a light (e.g., an infrared light) toward the first PVH element 205. The light may be reflected back to the sensor by the first PVH element 205 (or the second PVH element 215). Based on a difference between the emitted light and the received light, the sensor may detect a misalignment, such as a tilt of the first PVH element 205 from a vertical plane (similar to the vertical plane 167) that is perpendicular to the optical axis 220. In some embodiments, the sensors 223-1 and 223-2 may provide signals to the controller 216, which may analyze the signals and detect a misalignment of at least one of the first PVH element 205 or the second PVH element 215.

The controller 216 may be communicatively coupled with the path correction devices 225-1 and 225-2, and the sensors 223-1 and 223-2. Based on a detection of a misalignment of at least one of the first PVH element 205 or the second PVH element 215, the controller 216 may control operations of at least one of the first path correction device 225-1 or the second path correction device 225-2 to correct the optical path that has deviated from a target optical path due to the misalignment. The controller 216 may include a processor or processing unit 219. The processor 219 may by any suitable processor, such as a central processing unit (“CPU”), a graphic processing unit (“GPU”), etc. The controller 216 may include a storage device 218. The storage device 218 may be a non-transitory computer-readable medium, such as a memory, a hard disk, etc. The storage device 218 may be configured to store data or information, including computer-executable program instructions or codes, which may be executed by the processor 219 to perform various controls or functions described in the methods or processes disclosed herein.

The first sensor 223-1 and the second sensor 223-2 may be configured to monitor one or more alignment parameters of one or more optical elements in the lens assembly 202. In some embodiments, signals from the first sensor 223-1 and 223-2 may be analyzed by the controller 216 in real time to detect a misalignment of one or more optical elements. A misalignment as used herein means that a deviation of a measured alignment parameter from a predetermined reference alignment parameter value is greater than a predetermined threshold. A small deviation that does not noticeably affect the optical performance may not be detected as a misalignment. The predetermined reference alignment parameter value may be a value of the alignment parameter when the optical elements are aligned. The alignment parameter, the predetermined reference alignment parameter values, and the predetermined threshold may be determined based on specific applications. The alignment parameter may relate to the tilt, the axial distance, or the optical center relative to the optical axis, etc. When the controller 216 detects a misalignment, the controller 216 may control the first path correction device 225-1 and/or the second path correction device 225-2 to reduce or mitigate the deviation in the actual optical path caused by the misalignment from a target optical path (i.e., to correct the actual optical path).

In some embodiments, the first sensor 223-1 may be configured to monitor and/or detect an optical center of the first PVH element 205 relative to the optical axis 220, a tilt of the first PVH element 205 with respective to a vertical plane that is perpendicular to the optical axis 220, and/or an axial distance from the first PVH element 205 to the mirror 207, etc. The second sensor 223-2 may be configured to monitor and/or detect an optical center of the second PVH element 215 relative to the optical axis 220, a tilt of the second PVH element 215 with respective to the vertical plane that is perpendicular to the optical axis 220, and/or an axial distance from the second PVH element 215 to the mirror 207, etc. In some embodiments, at least one of the first sensor 223-1 or the second sensor 223-2 may be configured to monitor and/or detect an optical center of the mirror 207 relative to the optical axis 220, a tilt of the mirror 207 with respective to the vertical plane that is perpendicular to the optical axis 220, and/or an axial distance from the mirror 207 to the first PVH element 205 (or the second PVH element 215), etc. The sensor 223-1 or 223-2 may include any suitable sensor, such as a camera, a light source, and/or a photodiode. In some embodiments, the sensor 223-1 or 223-2 may include an imaging device, such as a charge-coupled device (“CCD”) camera, a complementary metal-oxide-semiconductor (“CMOS”) sensor, an N-type metal-oxide-semiconductor (“NMOS”) sensor, or a pixelated polarized camera. The sensor 223-1 or 223-2 may include any other suitable optical sensors.

In some embodiments, the alignment parameters measured by the sensor 223-1 and/or 223-2 may be compared with predetermined reference alignment parameter values corresponding to an aligned configuration of the lens assembly 202 (i.e., when optical elements are aligned). The controller 216 may determine or detect a misalignment of at least one of the first PVH element 205, the mirror 207, or the second PVH element 215 based on at least one signal received from at least one of the sensor 223-1 or the sensor 223-2. The misalignment may be indicated by any of the above-mentioned measured alignment parameters, such as the optical center, the tilt, or the axial distance.

In some embodiments, at least one (e.g., each) of the path correction devices 225-1 or 225-2 may include two waveplates 222 and a liquid crystal (“LC”) device 221-1 (or 221-2) disposed between the two waveplates 222. In some embodiments, the waveplate 222 may be a quarter-wave plate (“QWP”) operating at least for a visible spectrum. The QWP may be configured to convert a linearly polarized light into a circularly polarized light, or convert a circularly polarized light into a linearly polarized light, for at least the visible spectrum. In some embodiments, for an achromatic design over the visible spectrum, the QWP may include a multilayer birefringent material (e.g., polymer or liquid crystals) configured to produce a quarter-wave birefringence across a wide spectral range, e.g., the entire visible spectrum. In some embodiments, one or both of the waveplates 222 in the path correction device 225-1 or 225-2 may be omitted.

In some embodiments, at least one (e.g., each) of the LC device 221-1 or 221-2 may function as a beam deflector (or beam steering device) based on a suitable mechanism. The LC device 221-1 or 221-2 may be configured as a one-dimensional (“1D”) or two-dimensional (“2D”) beam deflector. When a misalignment occurs, the LC device 221-1 or 221-2 may correct an optical path of the image light propagating within the lens assembly 202 by steering the image light when the image light passes through the LC device 221-1 or 221-2.

The LC device 221-1 or 221-2 may be polarization selective for input lights having linear polarizations. For example, the LC device 221-1 or 221-2 may change a propagation direction of an input light (i.e., forwardly steer the input light) when the input light has a predetermined linear polarization while transmitting the input light, and may not change (i.e., may maintain) the propagation direction of an input light when the input light has a linear polarization that is orthogonal to the predetermined linear polarization.

In some embodiments, the LC device 221-1 or 221-2 may include a single LC layer or two or more LC layers stacked together. In some embodiments, at least one (e.g., each) LC layer may include LC molecules configured with a 1D or 2D orientation variations in the directors of the LC molecules (or LC directors) within a film plane of the LC layer, resulting in a 1D or 2D refractive index variation within the film plane. Accordingly, when the input light having the predetermined linear polarization propagates through the LC device 221-1 or 221-2, phase shifts experienced by different rays of the input light may be different. That is, the LC device 221-1 or 221-2 may provide a 1D or 2D spatially varying phase shift (or change) to the input light having the predetermined linear polarization. The spatially varying phase shift may follow a spatially varying phase profile, which may be a curve, a straight line, a zig-zag shape, etc. As a result of the spatially varying phase shift, the LC device 221-1 or 221-2 may change or steer the propagation direction of the input light having the predetermined linear polarization while transmitting the input light.

The 1D or 2D spatially varying phase shift (or change) may also be referred to as a 1D or 2D phase shift variation. The spatially varying phase shift may result from LC orientations that vary along the x-axis or along both the x-axis and y-axis. The spatially varying phase shift means that the amount of phase shift varies along the x-axis or along both the x-axis and y-axis. That is, the phase shift may vary in one or more directions in a film plane of the LC material included in the LC device 221-1 or 221-2. For the convenience of discussion, when the LC device 221-1 or 221-2 provides a phase shift to an input light based on a spatially varying (or constant) phase profile, it is also referred to as the LC device 221-1 or 221-2 providing a spatially varying (or constant) phase profile to the input light. The phase profile may be 1D or 2D.

When the LC device 221-1 or 221-2 forwardly steers an input light propagating therethrough, the propagation direction of the input light may be changed. That is, the steering may change an angle of the propagation direction relative to the optical axis 220 shown in FIG. 2B. A 1D phase shift provided by the LC device 221-1 or 221-2 may cause the propagation direction of an input light to rotate around one axis in the x-y plane (e.g., x-axis or y-axis), and a 2D phase shift may cause the propagation direction of the input light to rotate around both the x-axis and the y-axis. In other words, a 1D phase shift may result in a steering of the propagation direction of the input light within the z-x plane or the z-y plane, and a 2D phase shift may result in a steering of the propagation direction within both the z-x plane and the z-y plane.

Referring back to FIG. 2A, when the input light having a linear polarization that is orthogonal to predetermined linear polarization propagates through the LC device 221-1 or 221-2, phase shifts experienced by different rays of the input light may be the same. That is, the LC device 221-1 or 221-2 may provide a spatially constant phase shift to the input light having the linear polarization that is orthogonal to predetermined linear polarization. As a result of the spatially constant phase shift, the LC device 221-1 or 221-2 may maintain the propagation direction of the input light having the linear polarization that is orthogonal to the predetermined linear polarization while transmitting the input light.

In some embodiments, while transmitting the linearly polarized input light therethrough or forwardly steering the linearly polarized input light, the LC device 221-1 or 221-2 may be configured to substantially maintain the polarization of the linearly polarized input light. In some embodiments, the LC device 221-1 and the LC device 221-2 may be configured with the same polarization selectivity (e.g., same linear polarization). For example, the LC devices 221-1 and 221-2 may change the propagation directions of the respective input lights when the input lights have a same first linear polarization, and may maintain the propagation directions of the respective input lights when the input lights have a same second linear polarization that may be orthogonal to the first linear polarization. For example, each of the LC devices 221-1 and 221-2 may be configured to provide a spatially varying phase profile to an input light having a first linear polarization (e.g., a p-polarization) to forwardly steer the input light, and provide a spatially constant phase profiles to an input light having a second linear polarization (e.g., s-polarization) orthogonal to the first linear polarization.

In some embodiments, the LC devices 221-1 and 221-2 may be configured with different polarization selectivities (e.g., different linear polarizations). For example, in some embodiments, the LC device 221-1 may be configured to forwardly steer an input light having the first linear polarization, and maintain the propagation direction of an input light having the second linear polarization, which may be orthogonal to the first polarization. The LC device 221-2 may be configured to forwardly steer an input light having the second linear polarization, and maintain the propagation direction of an input light having the first linear polarization. For example, the LC device 221-1 may be configured to provide a spatially varying phase profile to an input light having the first linear polarization to forwardly steer the input light, and provide a spatially constant phase profile to an input light having the second linear polarization to maintain the propagation direction of the input light. The LC device 221-2 may be configured to provide a spatially varying phase profile to an input light having the second polarization linear direction to forwardly steer the input light, and provide a spatially constant phase profile to an input light having the first polarization to maintain the propagation direction of the input light.

The LC device 221-1 or 221-2 may be configured as a passive device or an active device. As a passive device, the LC molecules orientations in the LC device 221-1 or 221-2 are fixed and may not be changed by an external field, e.g., an electric field. Accordingly, the phase shift provided by the LC device 221-1 or 221-2 may be fixed. The fixed phase shift may follow a spatially varying phase profile (with the profile being fixed), or a spatially constant phase profile (with the profile being fixed). For example, when a misalignment occurs, a specific spatially varying phase profile may be determined based on the measured misalignment data. The LC device 221-1 or 221-2 may be configured with the specific spatially varying phase profile to correct or reduce the deviation of the actual optical path from the target optical path caused by the misalignment, by steering the propagation direction of an input light.

For increased flexibility, the LC device 221-1 or 221-2 may be configured as an active device. The active device may allow for dynamic changes of the LC molecule orientations, as well as other parameters of the LC device 221-1 or 221-2, thereby dynamically changing the phase profile provided by the LC device 221-1 or 221-2. The LC device 221-1 or 221-2 may be switched between an activation state, in which the device provides a spatially varying phase profile to correct the optical path of the input light (by steering the propagation direction of the input light) having a predetermined linear polarization, and a non-activation state in which the device provides a spatially constant phase profile such that the input light having the predetermined linear polarization is transmitted therethrough without experiencing a change in the optical path (i.e., the propagation direction is maintained). In addition, in some embodiments, the active LC device 221-1 or 221-2 may be tuned to change the spatially varying phase profile, thereby forwardly steering the input light by different angles. For example, a misalignment may change over time. Based on the measured misalignment at different time incidences, different spatially varying phase profiles may be configured by tuning the active LC devise 221-1 or 221-2, to provide different steering angles to the input light.

When the LC device 221-1 or 221-2 is an active steering element, the controller 216 may control the operation of the LC device 221-1 or 221-2 via controlling the orientations of the LC directors. In some embodiments, the LC device 221-1 or 221-2 may include electrodes electrically coupled to a power source. Through the electrodes, the power source may apply an electric field to the LC molecules included in the LC device 221-1 or 221-2. The controller 216 may control the orientations of the LC directors via controlling the electric field provided by the power source to the LC device 221-1 or 221-2. The controller 216 may control the LC device 221-1 or 221-2 to operate in the activation state, in which the LC device 221-1 or 221-2 may steer the propagation direction of an input light having the predetermined linear polarization, or operate in the non-activation state, in which the LC device 221-1 or 221-2 may maintain the propagation direction of the input light having the predetermined linear polarization.

For example, the controller 216 may control the power source to align the LC molecules, such that the LC directors have spatially uniform orientations within a film plane of the LC device 221-1 or 221-2, thereby rendering the LC device 221-1 or 221-2 operable in the non-activation state. The controller 216 may control the power source to align the LC molecules, such that the LC directors have 1D or 2D spatially varying orientations within the film plane of the LC device 221-1 or 221-2, thereby rendering the LC device 221-1 or 221-2 operable in the activation state. In addition, through controlling the electric field applied to the LC device 221-1 or 221-2 by the power source, the 1D or 2D spatially varying phase profile provided by the LC device 221-1 or 221-2 to an input light having the predetermined linear polarization may be varied between different phase profiles, such that the LC device 221-1 or 221-2 may provide different steering angles to the input light having the predetermined linear polarization.

In some embodiments, the controller 216 may control the operation of the LC device 221-1 and/or 221-2 based on a signal received from the sensor 223-1 and/or 223-2. The signal relates to at least one alignment parameter of at least one of the first PVH element 205, the mirror 207, or the second PVH element 215. The controller 216 may compare the at least one alignment parameter with a predetermined, reference alignment parameter value, thereby determining whether there is a misalignment occurring to at least one of the first PVH element 205, the mirror 207, or the second PVH element 215. When no misalignment is detected, the controller 216 may control the path correction devices 225-1 and 225-2 to operate in a non-activation state to transmit an input light without affecting the propagation direction of the input light. When a misalignment is detected, the controller 216 may control the LC device 221-1 (and/or 221-2) to operate in the activation state to change the propagation direction of an input light having a predetermined linear polarization. Steering the input light may provide a correction to the actual optical path of the input light that is deviated from a target optical path (when there is no misalignment) due to the misalignment. The deviation of the actual optical path from the target optical path may degrade the image quality at the eye-box region 259, if not corrected.

Based on the signal received from the first sensor 223-1 (and/or the second sensor 223-2), the controller 216 may determine a steering angle (or a propagation direction adjustment) to be applied by the LC device 221-1 or 221-2 to an input light (e.g., an image light) having a predetermined linear polarization, thereby reducing the deviation of the actual optical path of the input light from the target optical path. That is, the actual optical path of the input light may be steered toward the target optical path. After the steering angle is determined, the controller 216 may determine a 1D or 2D spatially varying phase profile for the LC device 221-1/or 221-2 to achieve the steering angle. The controller 216 may further determine an electric field (e.g., the voltages) to be applied to the LC device 221-1 or 221-2 for align the LC molecules to achieve the 1D or 2D spatially varying phase profile.

In some embodiments, after an image light having a predetermined linear polarization has been transmitted through the LC device 221-1 (or 221-2) twice, the deviation of the actual optical path of the image light from the target optical path may have been reduced to be smaller than a predetermined threshold deviation. Thus, the image quality degradation caused by the misalignment may be reduced or mitigated at the eye-box region 259. Various methods may be used for determining whether the deviation of the actual optical path of the image light from the target optical path has been reduced to be smaller than the predetermined threshold deviation. For example, in some embodiments, an optical sensor may be disposed at the eye-box region 259 to capture images formed by the image light. The images may be analyzed by the controller 216 to extract a parameter (e.g., a shift in the images from a reference image or a reference position in the eye-box region 259) indicating the amount of deviation. The controller 216 may determine that the deviation is smaller than the predetermined threshold deviation when the extracted parameter is smaller than a predetermined value. When the controller 216 determines that the deviation is smaller than the predetermined threshold deviation, the controller 216 may fix the output of the power source, such that the LC device 221-1 or 221-2 is maintained in a specific state to provide a specific spatially varying phase profile to correct the actual optical path of the image light.

In some embodiments, the adjustment or correction of the actual optical path of the image light may not be performed in real time. For example, the adjustment may be performed when the system 200 is not in use by a user. When the controller 216 determines that the misalignment has changed based on the signals from the sensors 223-1 and/or 223-2, the controller 216 may control the output of the power source to adjust the spatially varying phase profile(s) provided by the LC device 221-1 and/or 221-2, thereby providing different steering angles to the input lights.

In some embodiments, the adjustment of the actual optical path may be performed in real time. For example, the controller 216 may monitor the state of the misalignment through the sensors 223-1 and/or 223-2 in real time. The controller 216 may adjust the spatially varying phase profile of the LC device 221-1 (and/or 221-2) in real time, to adaptively or dynamically correct the propagation direction (and hence the optical path) of the input light as the misalignment changes in real time. A suitable control algorithm, such as a closed-loop feedback control algorithm may be encoded in the controller 216 for controlling the LC device 221-1 or 221-2 included in the path correction device 225-1 or 225-2.

In some embodiments, when the LC device 221-1 or 221-2 is controlled to operate in the non-activation state, the path correction device 225-1 or 225-2 is referred to as being operating in the non-activation state. When the LC device 221-1 or 221-2 is controlled to operate in the activation state, the path correction device 225-1 or 225-2 is referred to as being operating in the activation state. The path correction device 225-1 or 225-2 may be configured to substantially maintain the polarization of the image light (e.g., a circularly polarized image light) transmitted therethrough. In some embodiments, the path correction device 225-1 or 225-2 operating in the non-activation state may provide a spatially constant phase profile to a circularly polarized light while transmitting the circularly polarized light, independent of the polarization of the circularly polarized light (e.g., regardless of whether the light is an RHCP light or an LHCP light). The path correction device 225-1 or 225-2 operating in the activation state may provide a 1D or 2D spatially varying phase profile to a circularly polarized light having a predetermined handedness, and provide a spatially constant phase profile to a circularly polarized light having a handedness that is opposite to the predetermined handedness. Thus, the path correction device 225-1 or 225-2 operating in the activation state may change the propagation direction of the circularly polarized light having the predetermined handedness, and substantially maintain the propagation direction of the circularly polarized light having the handedness that is opposite to the predetermined handedness.

In some embodiments, the path correction devices 225-1 and 225-2 operating in the activation state may be configured with different polarization selectivities. For example, the first path correction device 225-1 operating in the activation state may be configured to provide a spatially varying phase profile to a circular polarized light having a first handedness (e.g., an RHCP light), and provide a spatially constant phase profile to a circular polarized light having a second handedness (e.g., an LHCP light) that is opposite to the first handedness. The second path correction device 225-2 operating in the activation state may be configured to provide a spatially varying phase profile to a circular polarized light having the second handedness (e.g., an LHCP light), and provide a spatially constant phase profile to a circular polarized light having the first handedness (e.g., an RHCP light).

For discussion purposes, FIG. 2A shows that the path correction device 225-1 or 225-2 includes a single LC device 221-1 or 221-2 and two waveplates 222, with the single LC device 221-1 or 221-2 disposed between the two waveplates 222. In some embodiments, the path correction device 225-1 or 225-2 may include more than one LC device 221-1 or 221-2. For example, in some embodiments, the path correction device 225-1 (or 225-2) may include two LC devices 221-1 (or two LC devices 221-2) and two waveplates 222, and the two LC devices 221-1 (or the two LC devices 221-2) may be disposed between the two waveplates 222. In some embodiments, the path correction device 225-1 (or 225-2) may include two LC devices 221-1 (or two LC devices 221-2) and four waveplates 222, and each LC device 221-1 (or 221-2) may be disposed between two waveplates 222.

In the embodiment shown in FIG. 2A, the first path correction device 225-1 and the first optical component 217 are shown as being spaced apart from one another by a gap, and the second path correction device 225-2 and the second optical component 227 are shown as being spaced apart from one another by a gap. In some embodiments, the first path correction device 225-1 and the first optical component 217 may be stacked without a gap (e.g., through direct contact), and/or the second path correction device 225-2 and the second optical component 227 may be stacked without a gap (e.g., through direct contact). FIG. 2A shows the various elements included in the system 200 as having flat surfaces for illustrative purposes. In some embodiments, one or more elements included in the system 200 may have a curved surface.

In some embodiments, the lens assembly 202 may include additional elements that are not shown in FIG. 2A. For example, in some embodiments, the lens assembly 202 may also include one or more Pancharatnam-Berry Phase (“PBP”) lenses disposed between the eye-box region 259 and the second polarizer 213. In some embodiments, the lens assembly 202 may also include one or more waveplates disposed between two neighboring PBP lenses.

FIG. 2B illustrates an optical path and a polarization conversion of the image light 221 from the display element 204 to the eye-box region 259 via the lens assembly 202. The waveplates 222 included in the first path correction device 225-1 have reference numbers of 222-1 and 222-2, and the waveplates 222 included in the second path correction device 225-2 have reference numbers of 222-3 and 222-4. For discussion purposes, the LC devices 221-1 and 221-2 are configured as active LC devices, which may be controlled by the controller 216 to operate in the activation state or the non-activation state. The LC devices 221-1 and 221-2 operating in the activation state may provide a 1D spatially varying phase profile (e.g., spatially varying in the x-axis direction) to a p-polarized light to change the propagation direction of the p-polarized light, and provide a spatially constant phase profile to an s-polarized light to maintain the propagation direction of the s-polarized light. The LC devices 221-1 and 221-2 operating in the non-activation state may provide a spatially constant phase profile to an input light (whether the input light is an s-polarized light or a p-polarized light), thereby maintaining the propagation direction of the input light. For discussion purposes, in the embodiment shown in FIG. 2B, the first PVH element 205 may function as a right-handed PVH lens that reflects and converges an RHCP light via backward diffraction, and transmits an LHCP light with negligible or zero diffraction. The second PVH element 215 may function as a left-handed PVH lens that reflects and converges an LHCP light via backward diffraction, and transmits an RHCP light with negligible or zero diffraction.

For discussion purposes, in the embodiment shown in FIG. 2B, the first PVH element 205 and the second PVH element 215 are configured with the same optical power, e.g., the first PVH element 205 has an optical power of +2D for an RHCP light and the second PVH element 215 may has optical power of +2D for an LHCP light. When the optical elements are aligned, the designed (or predetermined) axial distance between the first PVH element 205 and the mirror 207 may be equal to the designed (or predetermined) axial distance between the second PVH element 215 and the mirror 207. For example, in some embodiments, when the optical elements are aligned, the designed (or predetermined) axial distance between the first PVH element 205 and the mirror 207 may be L01, and the designed (or predetermined) axial distance between the second PVH element 215 and the mirror 207 may be L02. When the distance from the first PVH element 205 to the mirror 207 deviates from L01, it may be deemed that a misalignment occurs to the axial distance alignment parameter related to the first PVH element 205. When the axial distance between the second PVH element 215 and the mirror 207 deviates from L02, it may be deemed that a misalignment occurs to the axial distance alignment parameter related to the second PVH element 215. The path correction principle described herein also applies to the situation where the design axial distances for the first PVH element 205 and the second PVH element 215 are not the same.

When the controller 216 determines, based on the signal received from the first sensor 223-1 (not shown in FIG. 2B for simplicity of illustration), that no misalignment has been detected, the controller 216 may control the LC device 221-1 to operate in the non-activation state, such that the LC device 221-1 may maintain a propagation direction of an input light. When the controller 216 determines, based on the signal received from the first sensor 223-1, a misalignment has been detected (e.g., the first PVH element 205 or the first optical component 217 is tilted relative to a vertical plane perpendicular to the optical axis 220 for an angle greater than a predetermined threshold angle), the controller 216 may control the LC device 221-1 to operate in the activation state to forwardly steer a p-polarized input light shown in FIG. 2B. When the controller 216 determines, based on the signal received from the second sensor 223-2 (not shown in FIG. 2B for simplicity of illustration), that no misalignment has been detected, the controller 216 may control the LC device 221-2 to operate in the non-activation state. When the controller 216 determines, based on the signal received from the second sensor 223-2, that a misalignment has been detected (e.g., the second PVH element 215 or the second optical component 227 is tilted relative to a vertical plane perpendicular to the optical axis 220 for an angle greater than a predetermined threshold angle), the controller 216 may control the LC device 221-2 to operate in the activation state to forwardly steer a p-polarized input light shown in FIG. 2B. For discussion purposes, FIG. 2B shows that the LC device 221-1 and the LC device 221-2 are controlled to operate in the non-activation state. That is, FIG. 2B shows the optical paths when no misalignment is detected in the system 200.

As shown in FIG. 2B, the first polarizer 203 may convert the image light 221 (not shown) emitted from the display element 204 into an image light 232L. The first PVH element 205 may substantially transmit, within negligible diffraction, the image light 232L as an image light 233L toward the first path correction device 225-1. The waveplate 222-1 may be configured to convert the image light 233L into an image light 235s propagating toward the LC device 221-1. The LC device 221-1 may maintain the propagation direction of the image light 235s, while transmitting the image light 235s. The LC device 221-1 may transmit the image light 235s as an image light 237s toward the waveplate 222-2. The waveplate 222-2 may convert the image light 237s into an image light 239L propagating toward the mirror 207.

The mirror 207 may transmit a first portion of the image light 239L as an image light 241L propagating toward the second path correction device 225-2, and reflect a second portion of the image light 239L as an image light 242R back to the first path correction device 225-1. The waveplate 222-2 may convert the image light 242R into an image light 244p propagating toward the LC device 221-1. The LC device 221-1 may transmit the image light 244p as an image light 246p propagating toward the waveplate 222-1. The LC device 221-1 operating in the non-activation state may substantially maintain the propagation direction of the image light 244p while transmitting the image light 244p. The image light 244p and the image light 246p may have the same propagation direction. The waveplate 222-1 may convert the image light 246p into an image light 248R propagating toward the first PVH element 205.

The first PVH element 205 may reflect and converge, via diffraction, the image light 248R as an image light 250R propagating toward the first path correction device 225-1. In some embodiments, the image light 248R may be a divergent image light, and the image light 250R may be a collimate image light after being converged by the first PVH element 205. The waveplate 222-1 may be configured to convert the image light 250R into an image light 252p propagating toward the LC device 221-1. The LC device 221-1 may transmit the image light 252p as an image light 254p propagating toward the waveplate 222-2. The LC device 221-1 operating in the non-activation state may substantially maintain the propagation direction of the image light 252p while transmitting the image light 252p. The image light 252p and the image light 254p may have the same propagation direction. The waveplate 222-2 may convert the image light 254p into an image light 256R propagating toward the mirror 207.

The mirror 207 may transmit a first portion of the image light 256R as an image light 258R toward the second path correction device 225-2, and reflect a second portion of the image light 256R back to the first path correction device 225-1 as an LHCP light. The reflected portion is not shown in FIG. 2B. The waveplate 222-3 may convert the image light 258R to an s image light 260s. The LC device 221-2 may maintain the propagation direction of the image light 260s, while transmitting the image light 260s. The LC device 221-2 may transmit the image light 260s as an image light 262s toward the waveplate 222-4. The waveplate 222-4 may convert the image light 262s into an image light 264R propagating toward the second PVH element 215. The second PVH element 215 may substantially transmit the image light 264R as an image light 266R toward the second polarizer 213 (not shown), with negligible diffraction. The second polarizer 213 may transmit the image light 266R as an RHCP light (not shown) propagating toward the eye-box region 259 (not shown).

Returning to the optical path of the image light 241L output from the mirror 207, the waveplate 223-3 may convert the image light 241L into an image light 243p propagating toward the LC device 221-2. The LC device 221-2 may transmit the image light 243p as an image light 245p propagating toward the waveplate 222-4. The LC device 221-2 operating in the non-activation state may substantially maintain the propagation direction of the image light 243p while transmitting the image light 243p. The image light 243p and the image light 245p may have the same propagation direction. The waveplate 222-4 may convert the image light 245p into an image light 247L propagating toward the second PVH element 215.

The second PVH element 215 may reflect and converge, via diffraction, the image light 247L as an image light 249L toward the second path correction device 225-2. In some embodiments, the image light 247L may be a divergent image light, and the image light 249L may be a collimated image light. The waveplate 222-4 may be configured to convert the image light 249L into an image light 251p propagating toward the LC device 221-2. The LC device 221-2 may transmit the image light 251p as an image light 253p toward the waveplate 222-3. The LC device 221-2 operating in the non-activation state may substantially maintain the propagation direction of the image light 251p while transmitting the image light 251p. The image light 251p and the image light 253p may have the same propagation direction. The waveplate 222-3 may convert the image light 253p into an image light 255L propagating toward the mirror 207.

The mirror 207 may transmit a first portion of the image light 255L as an LHCP light (not shown) toward the first path correction device 225-1, and reflect a second portion of the image light 255L back to the second path correction device 225-2 as an image light 257R. The waveplate 222-3 may convert the image light 257R to an image light 259s. The LC device 221-2 may maintain the propagation direction of the image light 259s while transmitting the image light 259s. The LC device 221-2 may transmit the image light 259s as an image light 261s toward the waveplate 222-4. The waveplate 222-4 may convert the image light 261s into an image light 263R propagating toward the second PVH element 215. The second PVH element 215 may substantially transmit the image light 263R as an image light 265R toward the second polarizer 213 (not shown), with negligible diffraction. The second polarizer 213 may transmit the image light 265R as an RHCP light (not shown) toward the eye-box region 259 (not shown).

For discussion purposes, the optical path of the image light from the display element 204 to the mirror 207 may be referred to as a common optical path of the image light 221 output from the display element 204. The common optical path is formed by the image lights 221, 232L, 233L, 235s, 237s, and 239L. The optical path from the image light 242R (reflected by the mirror 207) to the image light 266R may be referred to as a first folding optical path. The optical path from the image light 241L to the image light 265R may be referred to as a second folding optical path. Because the elements in the lens assembly 202 are presumed to be aligned, the first folding optical path and the second folding optical path shown in FIG. 2B are also referred to as the first target folding optical path and the second target folding optical path. The common optical path, the first target folding optical path, and the second target folding optical path form the target optical path of the image light 221 from the display element 204 to the eye-box region 259.

Because the image light 239L is substantially normally incident onto the mirror 207, the reflected image light 242R may substantially coincide with the image light 239L, with an opposite propagating direction. To better illustrate the optical paths of the image light 239L and the image light 242R, FIG. 2B shows the image light 239L and the image light 242R as being parallel with one another with a small gap. The image light 265R and the image light 266R may substantially coincide with one another, and substantially coincide with the target optical path of the image light propagating toward the eye-box region 259 (not shown) of the system 200.

In some embodiments, when the controller 216 detects a misalignment of the first optical component 217 (e.g., when the first PVH element 205 is tilted relative to a vertical plane perpendicular to the optical axis 220 for an angle greater than a predetermined threshold angle), the controller 216 may control the first path correction device 225-1 to adjust (or correct) the first folding optical path by providing a phase correction (e.g., via providing a spatially varying phase profile) to the image light having a first predetermined polarization (e.g., an RHCP image light) while transmitting the image light. Thus, the deviation of the first actual folding optical path from a predetermined first target folding optical path (when elements in the lens assembly 202 are aligned) of the image light may be reduced. When the controller 216 detects a misalignment of the second optical component 227 (e.g., the second PVH element 215 is tilted relative to a vertical plane perpendicular to the optical axis 220 for an angle greater than a predetermined threshold angle), the controller 216 may control the second path correction device 225-2 to adjust (or correct) the second folding optical path by providing a phase correction (e.g., via a spatially varying phase profile) to the image light having a second predetermined polarization (e.g., an LHCP image light) while transmitting the image light. Thus, the deviation of the second actual folding optical path from a predetermined second target folding optical path of the image light may be reduced. The first predetermined polarization may be orthogonal to the second predetermined polarization. The first path correction device 225-1 may not affect or change the common optical path of the image light 221 output from the display element 204, independent of the operation state of the first path correction device 225-1. Although the tilt of the PVH elements 205 or 215 is used as an example of the misalignment, the tilt may occur to the mirror 207. When the mirror 207 is tilted (i.e., having a misalignment), the controller 216 may control the first path correction device 225-1 and/or the second path correction device 225-2 to correct the first actual folding optical path and/or the second actual folding optical path.

FIG. 2C illustrates deviation of an actual optical path of the image light 221 (not shown) emitted by the display device 204 from a target optical path when propagating through the first folding optical path (i.e., the right half of the lens assembly 202) shown in FIG. 2B, with a misalignment (e.g., tilt) occurring to the first PVH element 205. The optical path (formed by image lights 232L, 232R, and 256R) shown in solid arrows is the target optical path of the image light 232L when the first PVH element 205 is aligned. The optical path formed by the image light 232L is the common optical path, a portion of the target optical path. The optical path formed by the image lights 232R and 256R is the first target optical path, which is a portion of the target optical path. The target optical path when elements are aligned is a reference or hypothetical optical path, which is shown for illustrative and comparative purposes. The optical path (formed by image lights 232L, 232R, and 236R) shown in dashed arrows is the actual optical path when the first PVH element 205 is misaligned. The actual optical path shown in FIG. 2C may represent a situation where no path correction device is provided between the first PVH element 205 and the mirror 207, as in a conventional technology, or a situation where the first path correction device 225-1 is in a non-activation state, and hence does not affect the optical path. In the situation where the first path correction device 225-1 is provided, and is in the non-activation state, the first path correction device 225-1 is not shown in FIG. 2C for the simplicity of illustration.

FIG. 2C shows that the target optical path and the actual optical path share a same portion formed by the image lights 232L and 232R. The optical path formed by the image light 232L is the common optical path. The optical path formed by the image light 232R is a portion of the first folding optical path. The deviation of the actual optical path from the target optical path (specifically the first folding optical path) occurs when the image light is reflected by the tilted first PVH element 205. The deviation of the actual optical path from the target optical path (specifically the first folding optical path) is reflected in the angular separation between the image lights 256R and 236R.

As shown in FIG. 2C, the image light 232L from the display element 204 may propagate through the first PVH element 205 without being diffracted, as the first PVH element 205 may be configured to diffract an RHCP light and transmit (without diffraction) an LHCP light. The image light 232L may be normally incident onto the mirror 207. The mirror 207 may reflect a portion of the image light 232L as the image light 232R back toward the first PVH element 205 (i.e., propagating in an opposite direction). This portion of the optical path (formed by the image lights 232L and 232R) may not be affected by the misalignment of the first PVH element 205. When there is no misalignment (e.g., when the first PVH element 205 is aligned), the first PVH element 205 may reflect the image light 232R via diffraction as the image light 256R (which reflects a portion of the target optical path). When the first PVH element 205 is misaligned, such as tilted by an angle φ1 from a vertical plane perpendicular to the optical axis 220, the image light 232R may be reflected by the first PVH element 205 as the image light 236R (which reflects a portion of the actual optical path). The image light 236R may be rotated counter-clockwise from the target optical path represented by the image light 256R. Thus, there is a deviation in the actual optical path relative to the target optical path, as shown by the angular separation between the image lights 256R and 236R.

The deviation or angular separation is represented by an angle γ1 formed by the image light 256R and the image light 236R. Thus, at the eye-box region 259, an image formed by the image light 236R (when the image light 236R transmits to the second path folding segment of the lens assembly 202 and arrives at the eye-box region 259) may be shifted from an image formed by the image light 256R (when the image light 256R transmits to the second path folding segment of the lens assembly 202 and arrives at the eye-box region 259). Assuming that the location where an image is formed by the image light 256R is referred to as a predetermined target location in the eye-box region 259, the location of the image formed by the image light 236R may be shifted from the predetermined target location. The image shifting, when combined with the image formed by the image light output from the second path folding segment (i.e., the left half) of the lens assembly 202, may cause the overall image to become blurry, or may cause a ghost image.

In some embodiments, when the first path folding segment (i.e., the right half) of the lens assembly 202 is used alone, the image shifting may still cause issues, such as, the image falling out of the eye-box region 259, or the image quality at the eye-box region 259 being reduced. It is understood that although the tilt of the first PVH element 205 or the second PVH element 215 (in FIG. 2E) is shown as a one-dimensional tilt, the tilt may be a two-dimensional tilt. The tilt (a form of misalignment) may be an acute angle, such as, e.g., an acute angle greater than 0.1°, 0.3°, 0.5°, 1°, etc. The tilt of the first PVH element 205 (or the second PVH element 215) may be in any direction, such as the counter-clockwise direction or the clockwise direction. Likewise, the mirror 207 may be tilted, and the path correction principle described above may be applied to the situation where the mirror 207 is tilted.

FIG. 2D illustrates an optical path correction performed by the LC device 221-1 operating at the activation state to reduce a deviation of the actual optical path from the target optical path caused by the tilt of the first PVH element 205. Similar to FIG. 2C, FIG. 2D shows the first path folding segment (i.e., the right half) of the lens assembly 202 only. The LC device 221-1 included in the first path correction device 225-1 is shown as operating in the activation state to provide a phase correction (via providing a spatially varying phase profile) to a p-polarized image light, thereby steering the propagation direction of the p-polarized image light. When an input light has an s-polarization, the LC device 221-1 may transmit the input light without changing the propagation direction of the input light. That is, the propagation direction of the s-polarized light may be maintained.

Similar to FIG. 2C, FIG. 2D also shows the target optical path (solid arrows) for comparison and illustrative purposes only. The actual optical path when the LC device 221-1 operates in the activation state is shown in dashed arrows. As described above in connection with FIG. 2C, a portion of the actual optical path coincides with a portion of the target optical path, starting from image light 232L to image light 244p. The detailed actual optical path is explained below.

The first PVH element 205 may be configured to transmit an LHCP light with negligible or zero diffraction, and backwardly reflect (via diffraction) an RHCP light. Thus, the image light 232L from the display element 204 may transmit through the first PVH element 205 with the polarization and propagation direction maintained. The waveplates 222-1 and 222-2 may be configured to convert an RHCP light into a p-polarized light, and vice versa. The waveplate 222-1 and 222-2 may be configured to convert an LHCP light into an s-polarized light, and vice versa. The LC device 221-1 may be configured to forwardly steer a p-polarized light and maintain the propagation direction of an s-polarized light. Thus, the image light 232L may transmit through the first path correction device 225-1 (including the waveplates 222-1 and 222-2, and the LC device 221-1) with the propagation and polarization maintained.

The mirror 207 may reflect a portion of the image light 232L as an image light 232R. The portion of the image light 232L transmitted through the mirror 207 to the second path folding segment (i.e., the left half) of the lens assembly 202 is not shown in FIG. 2D, but in FIG. 2E. The image light 232R may be converted by the waveplate 222-2 into an image light 244p. The LC device 221-1 operating in the activation state may forwardly steer the image light 244p counter-clockwise as an image light 276p by a first steering angle, e.g., (½)*γ1, where γ1 is the angular deviation of the actual optical path when the first element 205 is misaligned (without path correction) and the target optical path, as shown in FIG. 2C.

Referring back to FIG. 2D, the waveplate 222-1 may convert the image light 276p into an image light 278R. The first PVH element 205 may reflect and converge, via diffraction, the image light 278R as an image light 280R. The waveplate 221-1 may convert the image light 280R into an image light 282p. The LC device 221-1 may forwardly steer the image light 282p clockwise as an image light 284p by a second steering angle, e.g., (½)*γ1. Because the first steering angle and the second steering angle are in opposite directions, the total steering angle provided by the LC device 221-1 to the optical path of the image light 221 (when no correction is provided) within the first path folding segment is γ1. Therefore, the actual optical path starting from the image light 284p may substantially coincide with the target optical path (the solid arrow indicated by the image light 256R).

The waveplate 222-2 may convert the image light 284p as an image light 286R while maintaining the propagating direction. The image light 286R may propagate through the second path folding segment (i.e., the left half) of the lens assembly 202 toward the eye-box region 259 with the propagation direction and polarization maintained. It is noted that in some embodiments, the portion of the actual optical path represented by the image lights 284p and 286R may not coincide with the portion of the target optical path represented by the image light 256R, but may be substantially parallel with and close to the portion of the target optical path represented by the image light 256R. For example, the portion of the actual optical path represented by the image lights 284p and 286R and the portion of the target optical path represented by the image light 256R may form only a small angle (e.g., 0.1°, 0.2°, etc., which may be smaller than γ1 shown in FIG. 2C where no phase correction is provided) that is smaller than a predetermined threshold angle (which may be set based on specific application, e.g., 1°, 2°, 3°, 5°, etc.). The small angle may only cause negligible degradation in the quality of the image formed at the eye-box region 259. That is, with the phase correcting LC device 221-1, the deviation of the actual optical path of the image light output from the display element 204 relative to the target optical path may be reduced or mitigated. The image light 286R may propagate through the second path folding segment (i.e., the left half) of the lens assembly 202 (not shown in FIG. 2D) while maintaining the propagation direction and polarization, and may form an image at the eye-box region 259 at a position substantially coinciding with the position where the image light 256R in the target optical path would form an image in the eye-box region 259 (i.e., a target location in the eye-box region 259).

FIG. 2D also schematically shows that to provide a spatially varying phase profile, the LC molecules in the LC device 221-1 may be controlled by the controller 216 have varying orientations along the x-axis direction, i.e., within a film plane perpendicular to the thickness direction. For example, by controlling different voltages applied to different portions of the LC device 221-1, the controller 216 may control the LC molecules to align from an orientation substantially parallel with the optical axis 220 (or perpendicular to a surface of the LC device 221-1) at the upper side (or first side) of the LC device 221-1 to an orientation substantially perpendicular to the optical axis 220 (or parallel with the surface of the LC device 221-1) at the lower side (or second side) of the LC device 221-1. The change in the orientations of the LC molecules may be gradual from the upper side to the lower side in the x-axis direction. Thus, from the first side to the second side of the LC device 221-1 along the x-axis direction, the local phase shift provided by the LC device 221-1 to a p-polarized light may gradually increase. As shown in FIG. 2D, for the p-polarized light 244p propagating through the LC device 221-1 from the left surface to the right surface of the LC device 221-1, the LC device 221-1 may forwardly steer the p-polarized light 244p in a counter-clockwise direction by the first steering angle away from the original optical path of the p-polarized light 244p, as seen in the angular deviation (or separation) between the image lights 244p and 276p. The first steering angle of the p-polarized light 244p may be defined as a positive steering angle. For the p-polarized light 282p propagating through the LC device 221-1 from the right surface to the left surface of the LC device 221-1, the LC device 221-1 may forwardly steer the p-polarized light 282p in a clockwise direction by the second steering angle away from the original optical path of the p-polarized light, as seen in the image lights 282p and 284p. The second steering angle of the p-polarized light may be defined as a negative steering angle. The sum of the absolute value of the first steering angle and the absolute value of the second steering angle may be substantially equal to γ1 shown in FIG. 2C, i.e., the angular deviation of the actual optical path from the target optical path when no path correction is provided.

As shown in FIG. 2D, after the p-polarized image light 244p is transmitted through the LC device 221-1 and forwardly steered by the LC device 221-1 two times, the deviation of the actual optical path from the target optical path caused by the tilt of the first PVH element 205 may be reduced to be smaller than a predetermined threshold deviation. Once this condition is satisfied, the controller 216 may maintain the voltage output from the power source, such that the spatially varying phase profile provided by the LC device 221-1 is maintained to correct the optical path. When a new misalignment is detected (or a change in the misalignment is detected), the controller 216 may again control the LC device 221-1 to change the spatially varying phase profile based on the newly detected misalignment to correct the optical path until the deviation in the optical path is smaller than the predetermined threshold deviation. This process may be performed in real time. Thus, with the phase correction provided by the LC device 221-1, even when the first PVH element 205 is tilted (i.e., misaligned), degradation of the image quality that may be caused by the tilt can be suppressed or mitigated.

Referring to FIG. 2C, the tilt of the first PVH element 205 may result in a deviation of the actual optical path from the target optical path by the angle γ1. Referring to FIG. 2D, when the image light propagates through the LC device 221-1 from opposite surfaces (e.g., the left surface and the right surface) of the LC device 221-1, the LC device 221-1 may forwardly steer the image light (e.g., the p-polarized image light) two times, one time in a counter-clockwise direction, as shown in the image lights 244p and 276p, and another time in the clockwise direction, as shown in the image lights 282p and 284p. Each time, the LC device 221-1 may forwardly steer the image light by a steering angle (½)*γ1. Thus, the total steering angle provided by the LC device 221-1 may be γ1, which cancels the angular deviation in the actual optical path caused by the tilt of the first PVH element 205 when no path correction is provided. As shown in FIG. 2D, the image light 286R in the actual optical path substantially coincides with the image light 256R in the target optical path, or may only deviate from the target optical path for a small angle. The small angle may be smaller than γ1, and may be smaller than a predetermined angle that does not cause noticeable degradation in the image quality at the eye-box region 259. Thus, as compared to the situation where the optical path due to the misalignment is not corrected (as shown in FIG. 2C), the path correction provided by the LC device 221-1 may significantly improve the image quality.

FIG. 2E illustrates deviation of an actual optical path of an image light 241L from a target optical path when propagating in the second path folding segment (i.e., the left half) of the lens assembly 202, with a misalignment (e.g., a tilt) presumed to exist in the second PVH element 215. The tilt of the second PVH element 215 is represented by the angle φ2 in the clockwise direction, relative to a vertical plane (represented by the dash-dotted line) perpendicular to the optical axis 220. Similar to FIG. 2C, the solid arrows represent a second target optical path (formed by image lights 241L, 255L, 265R), which is a portion of the target optical path in the entire lens system 202, and the dashed arrows represent the actual optical path (formed by image lights 241L, 271L, 273R) when the second PVH element 215 is tilted. The second target optical path is shown for comparative and illustrative purpose only. The actual optical path may represent the situation where there is no path correction device, or may represent the situation where the second path correction device 225-2 is in the non-activation state. In the situation where the second path correction device 225-2 is in the non-activation state, the second path correction device 225-2 is not shown for the simplicity of illustration since the second path correction device 225-2 in the non-activation state may not affect the propagation direction of the image light.

FIG. 2E shows that the actual optical path and the target optical path coincide with one another at the portion represented by the image light 241L. The image light 241L may be a portion of the image light 232L (shown in FIGS. 2B and 2C) transmitted through the mirror 207. The second PVH element 215 may be configured to reflect and converge an LHCP light while maintaining the polarization, and transmit an RHCP light while maintaining the polarization. Thus, referring to the solid, second target optical path, when there is no misalignment (e.g., when the second PVH element 215 is aligned), the second PVH element 215 may reflect and converge, via diffraction, the image light 241L as an image light 255L. The mirror 207 may reflect the image light 255L as an image light 265R. The second PVH element 215 may transmit the image light 265R while maintaining the propagation direction.

When there is misalignment as shown in FIG. 2E, referring to the dashed actual optical path, the second PVH element 215 may reflect and converge, via diffraction, the image light 241L as an image light 271L. The image light 271L may be rotated clockwise from the image light 255L. Thus, the actual optical path starts to deviate from the second target optical path, as shown in the angular separation of the image light 271L from the image light 255L. The angular deviation of the image light 271L from the image light 255L is represented by an acute angle γ2. The mirror 207 may reflect the image light 271L as an image light 273R. The second PVH element 215 may transmit the image light 273R while maintaining the propagation direction.

The image light 265R propagating along the target optical path may form an image at a predetermined target location in the eye-box region 259 (not shown in FIG. 2E). The image may be referred to as a reference image. The image light 273R propagating in the actual optical path may form an image at a location in the eye-box region 259 that is shifted from the predetermined target location. That is, the image formed by the image light 273R may be shifted from the reference image. The image shifting may result in degradation in the image quality, such as causing blurriness or ghost images. The image light 265R (part of second target optical path) and the image light 273R (part of the actual optical path) reflected from the mirror 207 may form an acute angle γ3, as shown in FIG. 2E.

FIG. 2F illustrates the optical path correction performed by the LC device 221-2 operating in the activation state to correct the optical path deviation caused by the tilt of the second PVH element 215. Similar to FIG. 2E, the solid arrows (formed by image lights 241L, 255L, and 265R) indicate the target optical path that the image light 241L would follow when there is no tilt of the second PVH element 215 and when the LC device 221-2 operates in the non-activate state. The target optical path is shown for comparative and illustrative purposes only.

The waveplates 222-3 and 222-4 may be configured to convert an LHCP light into a p-polarized light, and vice versa. The waveplates 222-3 and 222-4 may be configured to convert an RHCP light into an s-polarized light. The LC device 221-2 operating in the activation state may be configured to forwardly steer a p-polarized light, and maintain the propagation direction of an s-polarized light. The image light 241L may be converted into an image light 243p by the waveplate 222-3. The LC device 221-2 may forwardly steer the image light 243p clockwise as an image light 275p by a third steering angle (½)*γ3. The waveplate 222-4 may convert the image light 275p into an image light 277L while maintaining the propagation direction. The second PVH element 215 may reflect and converge, via diffraction, the image light 277L as an image light 279L. The waveplate 222-4 may convert the image light 279L into an image light 281p while maintaining the propagation direction. The LC device 221-2 may forwardly steer the image light 281p counter-clockwise as an image light 283p by a fourth steering angle (½)*γ3. The waveplate 223-3 may convert the image light 283p into an image light 285L while maintaining the propagation direction. The mirror 207 may reflect the image light 285L as an image light 287R. The image light 287R may propagate through the second path correction device 225-2 and the second PVH element 215 while maintaining the polarization and the propagation direction.

With the phase correction provided by the LC device 221-2, the total steering angle provided by the LC device 221-2 to the image light 241L may be γ3, which may cancel the angular deviation of the actual optical path from the target optical path shown in FIG. 2E. As a result, the portion of the actual optical path represented by the image light 287R may substantially coincide with a portion of the target optical path represented by the image light 265R. Thus, the image light 287R may form an image at a position in the eye-box region 259 that is substantially the same position the image light 265R would form an image. Alternatively, the portion of the actual optical path represented by the image light 287R may form a small angle with the portion of the target optical path represented by the image light 265R. The small angle may be smaller than a predetermined angle, similar to above descriptions relating to FIG. 2D, which may not cause a degradation in the image quality at the eye-box region 259. The small angle may be smaller than the γ3. As compared to the configuration in FIG. 2E where the deviation of the actual optical path from the target optical path due to the misalignment is not corrected, path correction provided by the LC device 221-2 may significantly improve the image quality at the eye-box region 259.

As shown in FIG. 2E, the tilt of the second PVH element 215 may result in a deviation of the actual optical path from the target optical path by the angle γ3. Referring to FIG. 2F, when the image light (e.g., the p-polarized image light) propagates through the LC device 221-2 two times from opposite surfaces of the LC device 221-2, the LC device 221-2 may forwardly steer the image light (e.g., the p-polarized image light) two times, one time in the clockwise direction, as shown in image lights 243p and 2′75p, another time in the counter-clockwise direction, as shown in image lights 281p and 283p. Each time the LC device 221-2 may forwardly steer the image light (e.g., the p-polarized image light) by an angle of (½)*γ3. As a result, the deviation in the actual optical path caused by the tilt of the second PVH element 215 may be corrected, or mitigated, as shown in FIG. 2F, where the image light 287R in the actual optical path substantially coincides with the image light 256R in the target optical path.

FIG. 2G schematically shows the overall actual optical paths with the first and second path correction devices 225-1 and 225-2 both operating in the activation state, and with tilts in both the first PVH element 205 and the second PVH element 215. FIG. 2G is a combination of FIG. 2D and FIG. 2F, showing less details. As shown in FIG. 2G, the image light 287R is a result of the image light 241L being folded twice, with the optical path being corrected twice by the LC device 221-2 included in the second path correction device 225-2. The image light 286R is a result of the image light 232L being folded twice, with the optical path being corrected twice by the LC device 221-1. The image lights 286R and 287R may coincide or substantially overlap with one another to form an overall image light covering the eye-box region 259 or a portion thereof. The optical path represented by the image lights 286R and 287R may coincide with, or be parallel with and close to (e.g., forming a small angle with) the target optical path (not shown in FIG. 2G). Thus, with the path correction devices 225-1 and 225-2, deviation in the actual optical paths caused by the misalignments of the first PVH element 205 and the second PVH element 215 may be reduced or mitigated.

It is understood that when the misalignment is only in the tilt of the first PVH element 205, the second path correction device 225-2 may be controlled by the controller 216 to operate in the non-activation state, and may not affect the optical path of the image light transmitted from the first path folding segment of the lens assembly 202 into the second path folding segment of the lens assembly 202. The first path correction device 225-1 may be controlled to operate in the activation state to provide the path correction, as shown in FIG. 2D. When the misalignment is only in the tilt of the second PVH element 215, the first path correction device 225-1 may be controlled to operate in the non-activation state, and may not affect the optical path of the image light transmitted in the first path folding segment of the lens assembly 202. The second path correction device 225-2 may be controlled to operate in the activation state to provide the path correction to the image light transmitted in the second path folding segment of the lens assembly 202, as shown in FIG. 2F. Although tilts are shown as an example of the misalignment, the misalignment may be in other forms described above. In addition, although FIGS. 2D, 2F, and 2G show the misalignments of the first PVH element 205 and the second PVH element 215 as examples, in some embodiments, the misalignment may occur to the mirror 207.

For illustrative purposes, FIGS. 2D, 2F, and 2G show a 1D beam steering provided by the path correction devices 225-1 and/or 225-2 (associated with a 1D spatially varying phase profile provided by the LC devices 222-1 and/or 221-2) to reduce the deviation of the actual optical path from the target optical path caused by a misalignment in the lens assembly 202. In some embodiments, depending on the misalignment (e.g., when the misalignment is in two dimensions), the path correction device 225-1 or 225-2 may be configured to provide a 2D beam steering (associated with a 2D spatially varying phase profile provided by the LC device 221-1 and/or 221-2) to reduce the deviation of the actual optical path from the target optical path. When providing a 2D beam steering, an image light incident onto the LC device 221-1 or 221-2 may be forwardly steered along two axes, e.g., both the x-axis direction and the y-axis direction.

For illustrative purposes, FIGS. 2A, 2B, 2D, 2F, and 2G show that the respective elements included in the lens assembly 200 have uniform thicknesses along at least the longitudinal direction (e.g., x-axis direction), as shown in the first PVH element 205, the second PVH element 215, the mirror 207, etc. For illustrative purposes, FIGS. 2D, 2F, and 2G show that different portions of each of the path correction device 225-1 or 225-2 along the longitudinal direction (i.e., x-axis direction) provide the same steering angle to linearly polarized lights (e.g., p-polarized lights with the same incidence angle) incident onto the different portions. That is, the path correction device 225-1 or 225-2 may steer linearly polarized lights (e.g., p-polarized lights with the same incidence angle) incident onto different portions of the path correction device 225-1 or 225-2 by the same angle.

In some embodiments, the element included in the lens assembly 200 (e.g., the first PVH element 205, the second PVH element 215, and/or the mirror 207) may have a nonuniform thickness along the longitudinal direction (e.g., the x-axis direction and/or the y-axis direction), which may be caused by, e.g., the fabrication error of respective elements and/or integration of the elements to form the lens assembly. In some embodiments, the element included in the lens assembly 200 (e.g., the first PVH element 205, the second PVH element 215, and/or the mirror 207) may be bent or deformed during the fabrication or integration process. The nonuniform thickness and/or deformation may cause a misalignment. To reduce the deviation of the actual optical path from the target optical path caused by the misalignment in the lens assembly 202, the path correction device 225-1 or 225-2 may be configured to provide different steering angles to linearly polarized lights (e.g., p-polarized lights with the same incidence angle) incident onto different portions of the path correction device 225-1 or 225-2. That is, the path correction device 225-1 or 225-2 may steer linearly polarized lights (e.g., p-polarized lights with the same incidence angle) incident onto different portions of the path correction device 225-1 or 225-2 by different angles.

The path correction device 225-1 (or 225-2) may be a suitable polarization selective steering device, e.g., an LC beam deflector, a PBP beam deflector, a PVH beam deflector, a metasurface beam deflector, etc. For example, in some embodiments, the path correction device 225-1 (or 225-2) may be a phase type spatial light modulator. In some embodiments, the path correction device 225-1 (or 225-2) may include a birefringent medium configured to provide a desirable spatially varying phase profile to a circularly polarized light having a predetermined handedness, and provide a spatially constant phase profile to a circularly polarized light having a handedness that is opposite to the predetermined handedness. In some embodiments, the birefringent medium may include liquid crystal polymer (“LCP”) layer that includes polymerized (or cross-linked) liquid crystals (“LCs”), polymer-stabilized LCs, a photosensitive LC polymer, or any combination thereof. In some embodiments, the birefringent medium may include nematic LCs, twist-bend LCs, chiral nematic LCs, smectic LCs, ferroelectric LCs, or any combination thereof. In some embodiments, the birefringent medium may include a birefringent photo-refractive material other than LCs, such as an amorphous polymer.

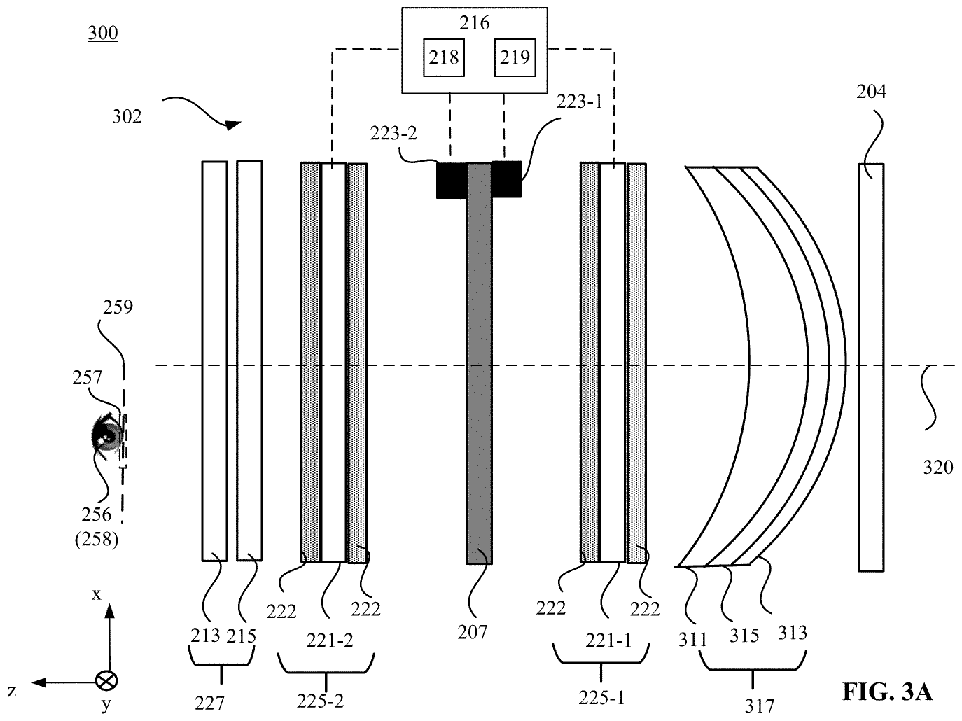

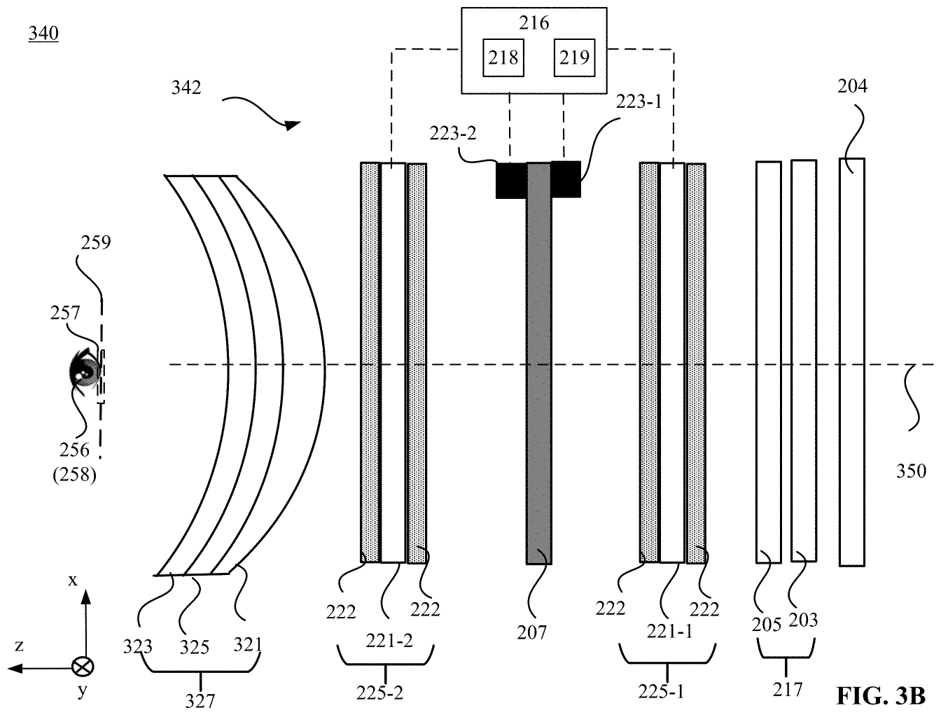

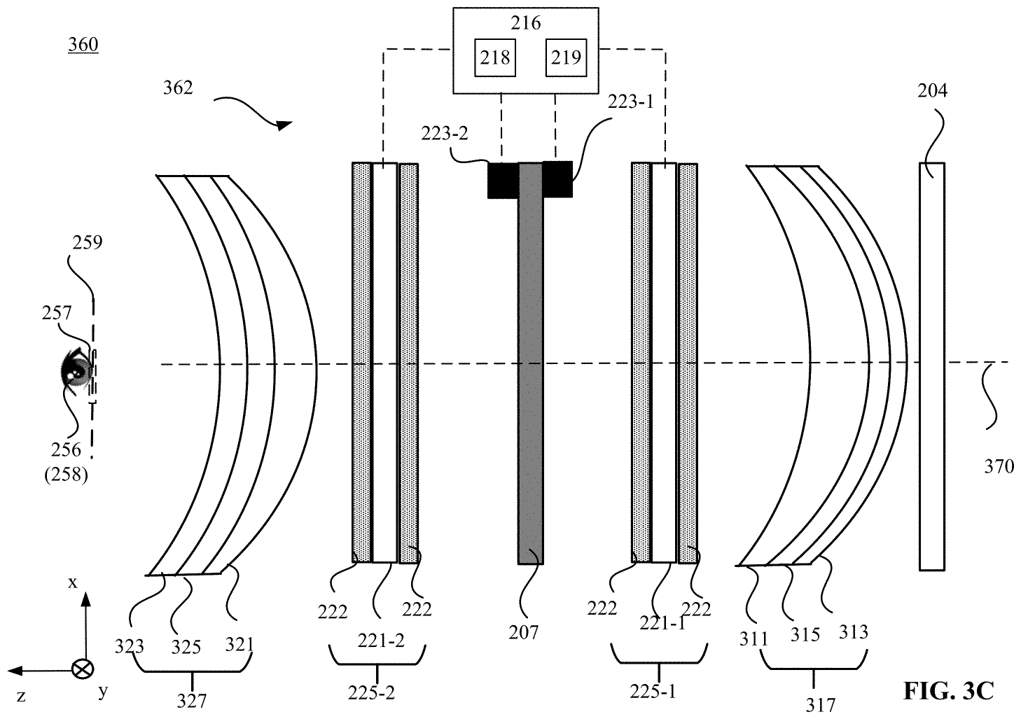

FIG. 3A schematically illustrates a diagram of a system 300, according to an embodiment of the present disclosure. The system 300 may include elements, structures, and/or functions that are the same as or similar to those included in the system 200 shown in FIGS. 2A-2G. Descriptions of the same or similar elements, structures, and/or functions can refer to the above descriptions rendered in connection with FIGS. 2A-2G. As shown in FIG. 3A, the system 300 may include the light emission device (e.g., the display element) 204, a lens assembly 302 disposed between the display element 204 and the eye-box region 259, and the controller 216. The display element 204 may output an image light (not shown for simplicity of illustration) representing a virtual image toward the lens assembly 202. The lens assembly 302 may transform an image light (e.g., a divergent image light) emitted from each point on the display element 204 to a bundle of parallel rays or a collimated image light that substantially covers the exit pupil 257 in the eye-box region 259 of the system 300 (or the entire eye-box region 259 of the system 300).

The lens assembly 302 may be implemented into an NED to fold the optical path. The lens assembly 302 may be a path-folding lens assembly that is configured to increase the length of an optical path of the image light projected from the display element 204 toward the exit pupil 257. The lens assembly 302 may include a first optical component 317, the first path correction device 225-1, the mirror 207, the second path correction device 225-2, and the second optical component 227 arranged in an optical series. The first optical component 317 may be disposed between the first path correction device 225-1 and the display element 204. The first path correction device 225-1 may be disposed between the first optical component 317 and the mirror 207. The second path correction device 225-2 may be disposed between the mirror 207 and the second optical component 227. The second optical component 227 may be disposed between the second path correction device 225-2 and the eye-box region 259. The lens assembly 302 may also include the first sensor 223-1 and the second sensor 223-2.

The first optical component 317 may include an optical lens 311 (which is referred to as a first optical lens 311 for discussion purposes) and a first polarization selective reflector 315 arranged in an optical series. The first polarization selective reflector 315 may be disposed between the display element 204 and the first optical lens 311, and the first optical lens 311 may be disposed between the first polarization selective reflector 315 and the first path correction device 225-1. In some embodiments, one or more surfaces of the first optical lens 311 may be configured with a suitable shape to correct a field curvature. For example, one or more surfaces of the first optical lens 311 may be configured with a spherically concave shape (e.g., a portion of a sphere), a spherically convex shape, a rotationally symmetric asphere shape, a freeform shape, or other shapes that may mitigate a field curvature. In some embodiments, the shape of one or more surfaces of the first optical lens 311 may be configured to additionally correct other forms of optical aberrations. The first optical lens 311 may be made of a suitable optical material that is substantially transparent in the visible spectrum, e.g., glass, polymer, or resin, etc.

In some embodiments, the first polarization selective reflector 315 may be a layer or coating disposed at (e.g., bonded to or formed on) a first surface of the first optical lens 311 facing the display element 204. In some embodiments, the first polarization selective reflector 315 may be a circular reflective polarizer (which is referred to as a first circular reflective polarizer 315 for discussion purposes). The first circular reflective polarizer 315 may have a zero optical power. The first circular reflective polarizer 315 may be configured to substantially reflect a circularly polarized light having a predetermined handedness, and substantially transmit a circularly polarized light having a handedness that is opposite to the predetermined handedness.

The combination of the first optical lens 311 and the first circular reflective polarizer 315 may function similarly to the first PVH element 205 shown in FIGS. 2A-2G, which has both a lens function and a polarization selective reflection function, as described above. Thus, above descriptions relating to the first PVH element 205 may be applicable to the combination of the first optical lens 311 and the first circular reflective polarizer 315. The first circular reflective polarizer 315 and the second PVH element 215 may be configured with different polarization selectivities. For example, the first circular reflective polarizer 315 may be configured to substantially reflect a circularly polarized light having a first handedness, and substantially transmit a circularly polarized light having a second handedness that is opposite to the first handedness. The second PVH element 215 may be configured to substantially reflect a circularly polarized light having the second handedness, and substantially transmit a circularly polarized light having the first handedness.

In some embodiments, the first optical component 317 may also include a polarizer 313 (which is referred to as a first polarizer 313) disposed between the first circular reflective polarizer 315 and the display element 204. In some embodiments, the first polarizer 313 may be a layer or coating disposed at (e.g., bonded to or formed on) a surface of the first circular reflective polarizer 315. The first polarizer 313 may be an absorptive circular polarizer that functions similarly to the first polarizer 203 shown in FIG. 2A. For example, the first polarizer 313 may be configured to transmit a circularly polarized light having the second handedness, and block a circularly polarized light having the first handedness via absorption. The combination of the first optical lens 311, the first circular reflective polarizer 315, and the first polarizer 313 (i.e., the first optical component 317) may function similarly to the first optical component 217 shown in FIG. 2A.

The first sensor 223-1 may be configured to measure an alignment parameter of the first circular reflective polarizer 315, the first optical lens 311, and/or the mirror 207. For discussion purposes, the first circular reflective polarizer 315 is presumed to be disposed at (e.g., bonded to or formed on) the surface of the first optical lens 311. Thus, the alignment (or misalignment) of the first circular reflective polarizer 315 is substantially the same as the alignment (or misalignment) of the first optical lens 311. The first sensor 223-1 may measure an alignment parameter of the first optical lens 311 or the mirror 207.

The controller 216 may detect a misalignment in the first optical lens 311 or the mirror 207 based on the signal received from the first sensor 223-1. Likewise, the second sensor 223-2 may measure an alignment parameter of the mirror 207 or the second optical component 227, and the controller 216 may detect a misalignment in the second optical component 227 and/or the mirror 207 based on the signal received from the second sensor 223-2.

Based on a detection of a misalignment in the first optical lens 311 (or the first optical component 317), the mirror 207, and/or the second optical component 227, the controller 216 may control the LC device 221-1 and/or 221-2 to operate in the activation state to provide an optical path correction, similar to the correction described above in connection with FIGS. 2A-2G. Thus, the deviation in the optical path caused by the misalignment may be reduce or mitigated. The image quality degradation caused by the misalignment may be significantly reduced or mitigated at the eye-box region 259. Detailed descriptions of the optical path correction can refer to descriptions of FIGS. 2A-2G.

For discussion purposes, FIG. 3A shows that the first circular reflective polarizer 315 and the first polarizer 313 have curved surfaces. In some embodiments, the first circular reflective polarizer 315 and the first polarizer 313 may have at least one flat surface. For discussion purposes, FIG. 3A shows that the first circular reflective polarizer 315 and the first polarizer 313 are disposed at the surface of the first optical lens 311. In some embodiments, at least one of the first circular reflective polarizer 315 or the first polarizer 313 may be spaced apart from the first optical lens 311 by a gap as a separate element.

For discussion purposes, FIG. 3A shows that the first path correction device 225-1 is spaced apart from the first optical component 317 and the mirror 207 by a gap. In some embodiments, the first path correction device 225-1 may be stacked with one of the first optical component 317 and the mirror 207 without a gap (e.g., through direct contact). For discussion purposes, FIG. 3A shows that the first path correction device 225-1 has flat surfaces. In some embodiments, the first path correction device 225-1 may have at least one curved surface.

FIG. 3B schematically illustrates a diagram of a system 340, according to an embodiment of the present disclosure. The system 340 may include elements, structures, and/or functions that are the same as or similar to those included in the system 200 shown in FIGS. 2A-2G, or the system 300 shown in FIG. 3A. Descriptions of the same or similar elements, structures, and/or functions can refer to the above descriptions rendered in connection with FIGS. 2A-2G, or FIG. 3A. As shown in FIG. 3B, the system 340 may include a lens assembly 342 disposed between the display element 204 and the eye-box region 259. The display element 204 may output an image light (not shown for simplicity of illustration) representing a virtual image toward the lens assembly 202. The lens assembly 342 may transform the image light (e.g., a divergent image light) emitted from each point on the display element 204 to a bundle of parallel rays or a collimated image light that substantially covers the exit pupil 257 in the eye-box region 259 of the system 340 (or the entire eye-box region 259 of the system 340).

The lens assembly 342 may be implemented into an NED to fold the optical path. The lens assembly 342 may be a path-folding lens assembly that is configured to increase the length of an optical path of the image light projected from the display element 204 toward the exit pupil 257. The lens assembly 342 may include the first optical component 217, the first path correction device 225-1, the mirror 207, the second path correction device 225-2, and a second optical component 327 arranged in an optical series. The first path correction device 225-1 may be disposed between the first optical component 217 and the mirror 207. The first optical component 217 may be disposed between the display element 204 and the first path correction device 225-1. The second optical component 327 may be disposed between the eye-box region 259 and the second path correction device 225-2. The second path correction device 225-2 may be disposed between the second optical component 327 and the mirror 207. The mirror 207 may be disposed between the first path correction device 225-1 and the second path correction device 225-2.

The second optical component 327 may include an optical lens 321 (which is referred to as a second optical lens 321 for discussion purposes) and a second polarization selective reflector 325 arranged in an optical series. The second polarization selective reflector 325 may be disposed between the second optical lens 321 and the eye-box region 259, and the second optical lens 321 may be disposed between the second polarization selective reflector 325 and the second path correction device 225-2. In some embodiments, one or more surfaces of the second optical lens 321 may be configured with a suitable shape to correct a field curvature. For example, one or more surfaces of the second optical lens 321 may be configured with a spherically concave shape (e.g., a portion of a sphere), a spherically convex shape, a rotationally symmetric asphere shape, a freeform shape, or other shapes that may mitigate a field curvature. In some embodiments, the shape of one or more surfaces of the second optical lens 321 may be configured to additionally correct other forms of optical aberrations. The second optical lens 321 may be made of a suitable optical material that is substantially transparent in the visible spectrum, e.g., glass, polymer, or resin, etc.

In some embodiments, the second polarization selective reflector 325 may be a layer or coating disposed at (e.g., bonded to or formed on) a first surface of the second optical lens 321 facing the eye-box region 259. The second polarization selective reflector 325 may be similar to the first polarization selective reflector 315 described above in connection with FIG. 3A. In some embodiments, the second polarization selective reflector 325 may be a circular reflective polarizer (which is referred to as a second circular reflective polarizer 325 for discussion purposes). The second circular reflective polarizer 325 may have a zero optical power. The second circular reflective polarizer 325 may be configured to substantially reflect a circularly polarized light having a predetermined handedness, and substantially transmit a circularly polarized light having a handedness that is opposite to the predetermined handedness. The second circular reflective polarizer 325 and the first PVH element 205 may be configured with different polarization selectivities. For example, the first PVH element 205 may be configured to substantially reflect a circularly polarized light having a first handedness (e.g., left-handedness), and substantially transmit a circularly polarized light having a second handedness (e.g., right-handedness) that is opposite to the first handedness. The second circular reflective polarizer 325 may be configured to substantially reflect a circularly polarized light having the second handedness, and substantially transmit a circularly polarized light having the first handedness. The combination of the second optical lens 321 and the second circular reflective polarizer 325 may function similarly to the second PVH element 215 shown in FIG. 2A. Above descriptions relating to the second PVH element 215 may be applicable to the combination of the second optical lens 321 and the second circular reflective polarizer 325.

In some embodiments, the second optical component 327 may also include a polarizer 323 (which is referred to as a second polarizer 323) disposed between the second circular reflective polarizer 325 and the eye-box region 259. The second circular reflective polarizer 325 may be disposed between the second polarizer 323 and the second optical lens 321. In some embodiments, the second polarizer 323 may be a layer or coating disposed at (e.g., bonded to or formed on) a surface of the second circular reflective polarizer 325. The second polarizer 323 may be an absorptive circular polarizer that functions similarly to the second polarizer 213 shown in FIG. 2A. For example, the second polarizer 323 may function as a “clean up” polarizer that removes an image light having an undesirable polarization (e.g., a circularly polarized light having the second handedness) via absorption. In some embodiments, the second polarizer 323 may be omitted. The combination of the second optical lens 321, the second circular reflective polarizer 325, and the second polarizer 323 (i.e., the second optical component 327) may function similarly to the second optical component 227 shown in FIG. 2A.

Descriptions of the first sensor 223-1 included in the embodiment shown in FIG. 3B for detecting a misalignment in the first optical component 217 may refer to the above descriptions rendered in connection with FIG. 2A and FIG. 2D. The second sensor 223-2 may measure an alignment parameter of the second circular reflective polarizer 325, the second optical lens 321, and/or the mirror 207. For discussion purposes, the second circular reflective polarizer 325 is presumed to be disposed at (e.g., bonded to or formed on) the surface of the second optical lens 321. Thus, the alignment of the second circular reflective polarizer 325 is substantially to the same as the alignment of the second optical lens 321. The second sensor may measure an alignment parameter of the second optical lens 321 and/or the mirror 207. The controller 216 may detect a misalignment in the second optical lens 321 and/or the mirror 207 based on signals received from the second sensor 223-2. Based on a detection of a misalignment, the controller 216 may control the LC device 221-1 and/or 221-2 to operate in the activation state to provide optical path correction to an optical path of an image light from the display element 204, as described above in connection with FIGS. 2A-2G.

For discussion purposes, FIG. 3B shows that the second circular reflective polarizer 325 and the second polarizer 323 have curved surfaces. In some embodiments, the second circular reflective polarizer 325 and the second polarizer 323 may have at least one flat surface. For discussion purposes, FIG. 3B shows that the second circular reflective polarizer 325 and the second polarizer 323 are disposed at the surface of the second optical lens 321. In some embodiments, at least one of the second circular reflective polarizer 325 or the second polarizer 323 may be spaced apart from the second optical lens 321 by a gap as a separate element.

For discussion purposes, FIG. 3B shows that the second path correction device 225-2 is spaced apart from the second optical component 327 and the mirror 207 by a gap. In some embodiments, the second path correction device 225-2 may be stacked with one of the second optical component 327 and the mirror 207 without a gap (e.g., through direct contact). For discussion purposes, FIG. 3B shows that the second path correction device 225-2 has flat surfaces. In some embodiments, the second path correction device 225-2 may have at least one curved surface.

FIG. 3C schematically illustrates a diagram of a system 360, according to an embodiment of the present disclosure. The system 360 may include elements, structures, and/or functions that are the same as or similar to those included in the system 200 shown in FIGS. 2A-2G, the system 300 shown in FIG. 3A, or the system 340 shown in FIG. 3B. Descriptions of the same or similar elements, structures, and/or functions can refer to the above descriptions rendered in connection with FIGS. 2A-2G, FIG. 3A, or FIG. 3B. As shown in FIG. 3C, the system 360 may include a lens assembly 362 disposed between the display element 204 and the eye-box region 2596. The display element 204 may output an image light (not shown for simplicity of illustration) representing a virtual image toward the lens assembly 362. The lens assembly 362 may transform the image light (e.g., a divergent image light) emitted from each point on the display element 204 to a bundle of parallel rays or a collimated image light that substantially covers the exit pupil 257 in the eye-box region 259 of the system 360 (or the entire eye-box region 259 of the system 360).

The lens assembly 362 may be implemented into an NED to fold the optical path. The lens assembly 362 may be a path-folding lens assembly that is configured to increase the length of an optical path of the image light projected from the display element 204 toward the exit pupil 257. The lens assembly 362 may include the first optical component 317, the first path correction device 225-1, the mirror 207, the second path correction device 225-2, and the second optical component 327 arranged in an optical series. The first path correction device 225-1 may be disposed between the first optical component 317 and the mirror 207. The first optical component 317 may be disposed between the first path correction device 225-1 and the display element 204. The second path correction device 225-2 may be disposed between the second optical component 327 and the mirror 207. The second optical component 327 may be disposed between the eye-box region 259 and the second path correction device 225-2. The lens assembly 362 may also include the first sensor 223-1 and the second sensor 223-2.

The first optical component 317 may include the first polarizer 313, the circular reflective polarizer 315, and the first optical lens 311 arranged in an optical series. The second optical component 327 may include the second optical lens 321, the circular reflective polarizer 325, and the second polarizer 323 arranged in an optical series. Descriptions of the same or similar elements, structures, and/or functions of the first optical component 317 and the second optical lens 321 can refer to the above descriptions rendered in connection with FIGS. 3A and 3B.

The first path correction device 225-1 may not affect or change the common optical path of the image light output from the display element 204 (the common optical path being formed by an image light propagating from the display element 204 to the mirror 207), independent of the operation state of the first path correction device 225-1. When the controller 216 determines that a misalignment exists in at least one of the first circular reflective polarizer 315 (or the first optical lens 311) or the mirror 207, the controller 216 may control the first path correction device 225-1 to provide a correction to the optical path of the image light propagating between the first circular reflective polarizer 315 (or the first optical lens 311) and the mirror 207, to reduce or mitigate the deviation of the optical path from a first target optical path. When the controller 216 determines that a misalignment exists in at least one of the second circular reflective polarizer 325 (or the second optical lens 321) or the mirror 207, the controller 216 may control the second path correction device 225-2 may provide a correction to the optical path of the image light propagating between the mirror 207 and the second circular reflective polarizer 325 (or the second optical lens 321), to reduce or mitigate the deviation of the optical path from a second target optical path. Detailed descriptions of the correction of the optical path may be similar to those described above in connection with FIGS. 2A-2G.

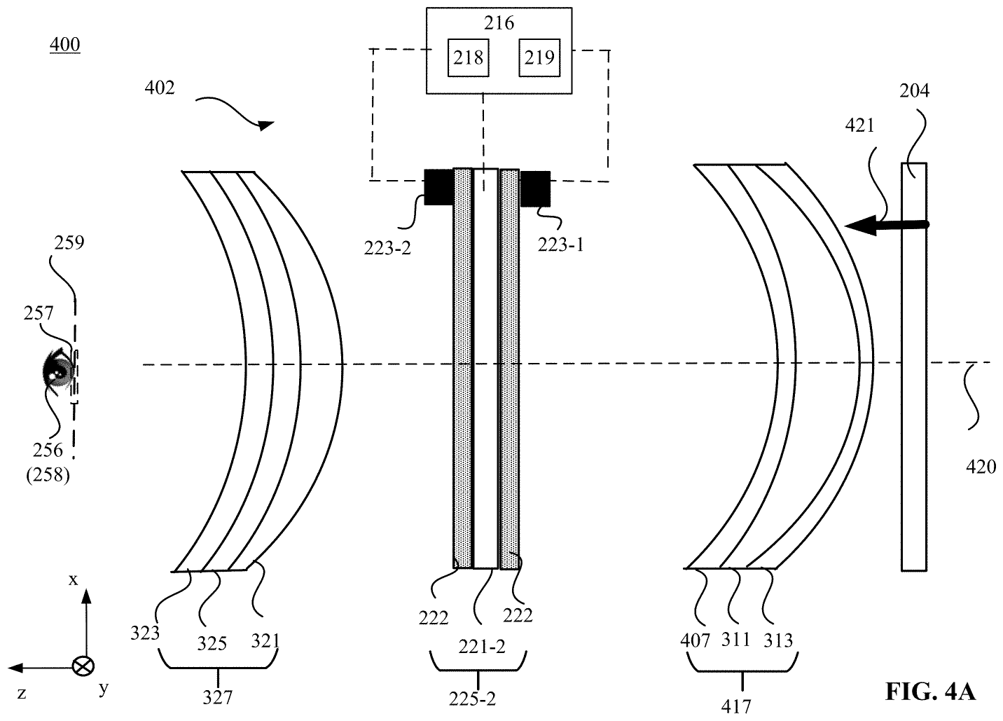

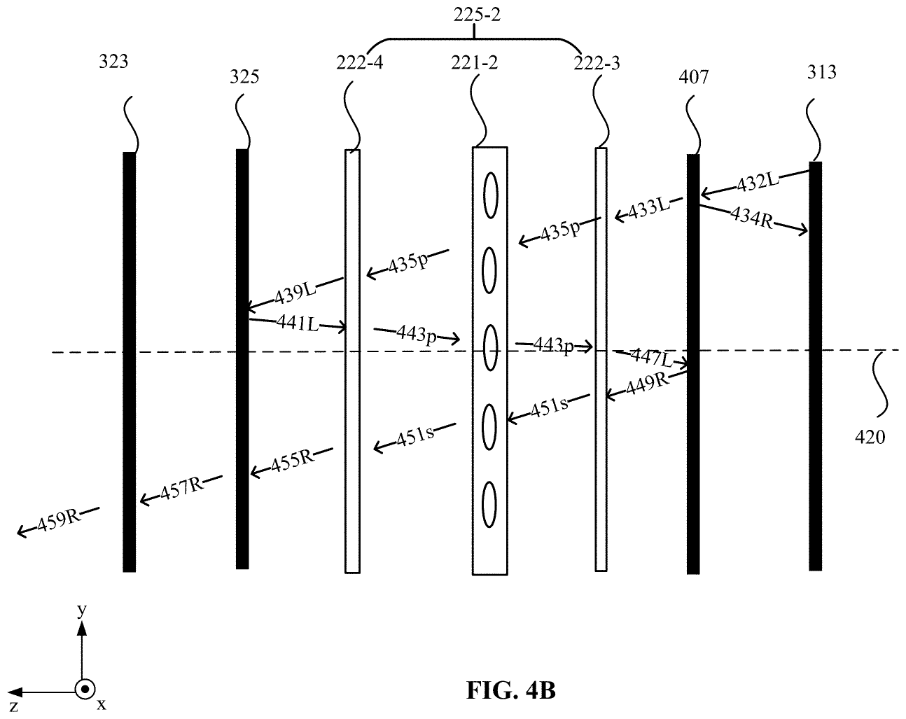

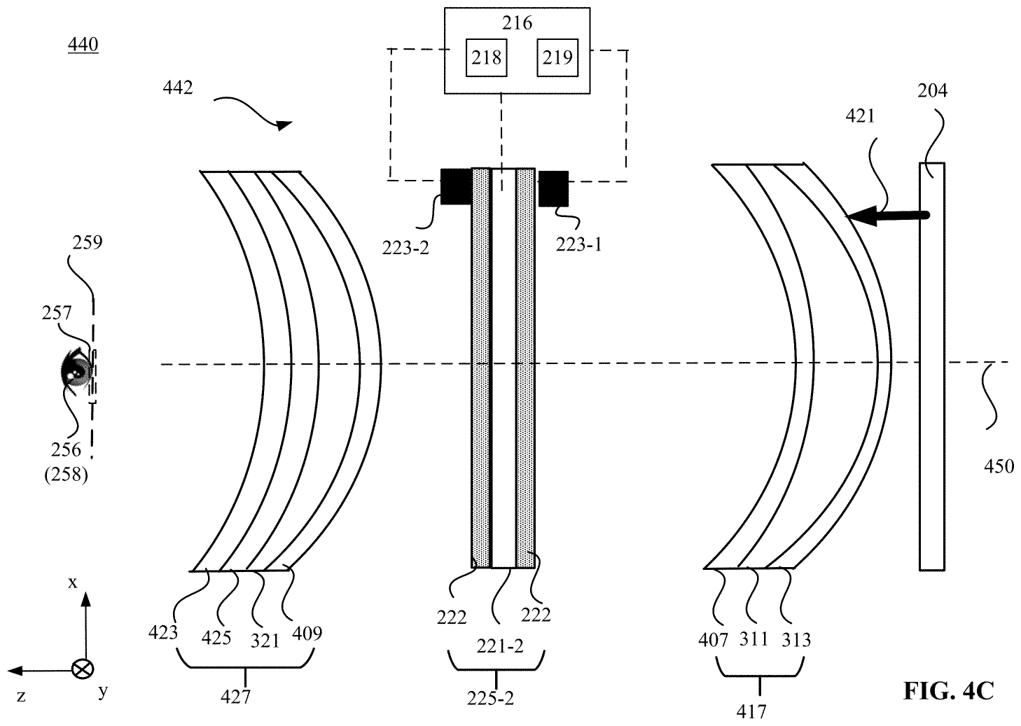

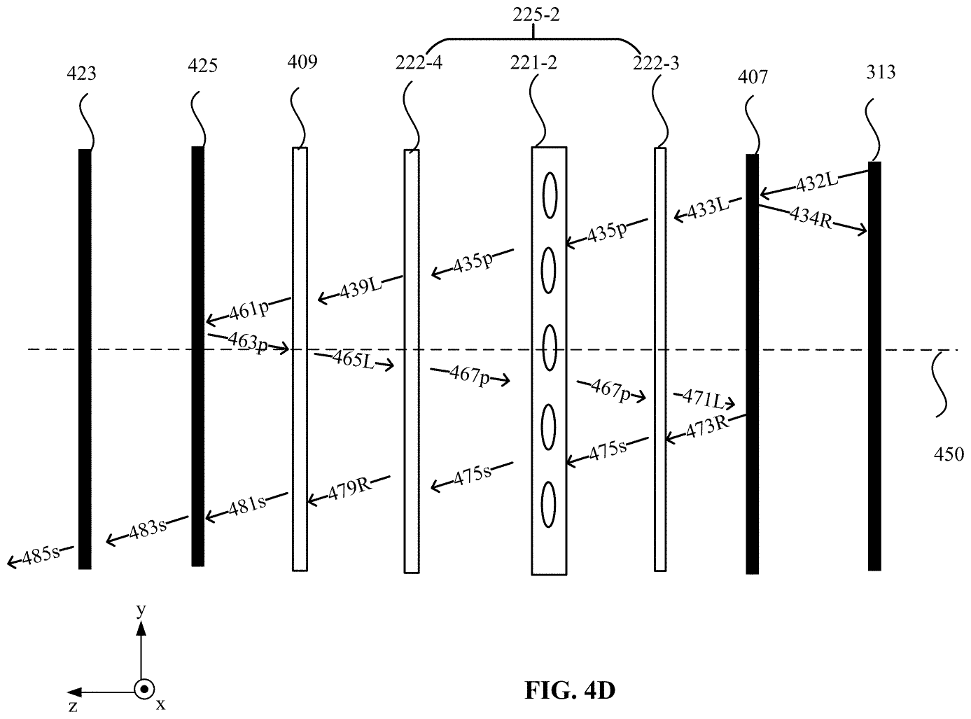

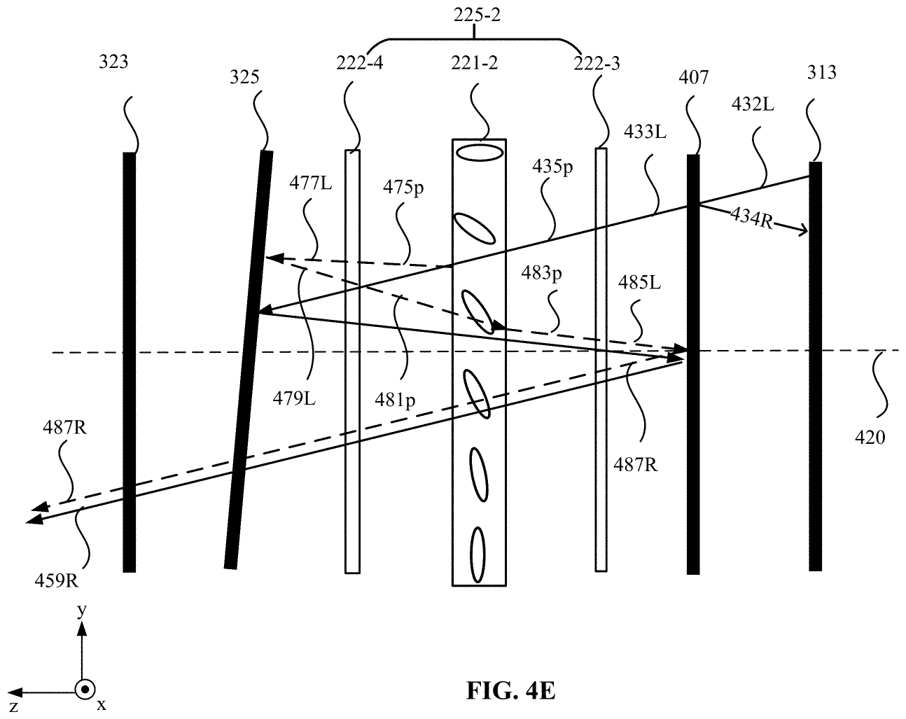

FIG. 4A schematically illustrates a diagram of a system 400, according to an embodiment of the present disclosure. The system 400 may include elements, structures, and/or functions that are the same as or similar to those included in the system 200 shown in FIGS. 2A-2G, the system 300 shown in FIG. 3A, the system 340 shown in FIG. 3B, or the system 360 shown in FIG. 3C. Descriptions of the same or similar elements, structures, and/or functions can refer to the above descriptions rendered in connection with FIGS. 2A-2G, FIG. 3A, FIG. 3B, or FIG. 3C. As shown in FIG. 4A, the system 400 may include a lens assembly 402 disposed between the display element 204 and the eye-box region 259. The display element 204 may output an image light 421 representing a virtual image toward the lens assembly 402. The lens assembly 402 may transform the image light 421 (e.g., a divergent image light) emitted from each point on the display element 204 to a bundle of parallel rays or a collimated image light that substantially covers the exit pupil 257 in the eye-box region 259 of the system 400 (or the entire eye-box region 259 of the system 400). For discussion purpose, FIG. 4A merely shows one ray in the image light 421 emitted from a point at the upper half of the display panel of the display element 204.

The lens assembly 402 may be implemented into an NED to fold the optical path. The lens assembly 402 may be a path-folding lens assembly that is configured to increase the length of an optical path of the image light 421 emitted from the display element 204 toward the exit pupil 257. The lens assembly 402 may include a first optical component 417, the path correction device 225-2, and the second optical component 327 arranged in an optical series. The first optical component 417 may be disposed between the path correction device 225-2 and the display element 204. The path correction device 225-2 may be disposed between the first optical component 417 and the second optical component 327. The second optical component 327 may be disposed between the path correction device 225-2 and the eye-box region 259. The lens assembly 402 may also include at least one sensor for detecting a misalignment in at least one of the first optical component 417 or the second optical component 327. For illustrative purposes, FIG. 4A shows both first and second sensors 223-1 and 223-2. In some embodiments, one of the sensors 223-1 and 223-2 may be omitted.

The first optical component 417 may include the first polarizer 313, the first optical lens 311, and a partial reflector 407 arranged in an optical series. The first optical lens 311 may be disposed between the partial reflector 407 and the first polarizer 313. The first polarizer 313 may be disposed at a side of the first optical lens 311 facing the display element 204, and the partial reflector 407 may be disposed at the other side of the first optical lens 311 facing the path correction device 225-2. In some embodiments, the first polarizer 313 may be omitted. In some embodiments, the first polarizer 313 may be a layer or coating disposed at (e.g., bonded to or formed on) a surface of the first optical lens 311 facing the display element 204. In some embodiments, the partial reflector 407 may be a layer or coating disposed at (e.g., bonded to or formed on) a surface of the first optical lens 311 facing the path correction device 225-2. In some embodiments, the partial reflector 407 may be a polarization independent partial reflector, e.g., a 50:50 mirror, similar to the partial reflector 207. The partial reflector 407 may also be referred to as a mirror 407 for discussion purposes.

The second optical component 327 may include the second circular reflective polarizer 325, the second optical lens 321, the second polarizer 323. The second circular reflective polarizer 325 may be disposed between the second optical lens 321 and the second polarizer 323. The second optical lens 321 may be disposed between the second circular reflective polarizer 325 and the path correction device 225-2. The second polarizer 323 may be disposed between the second circular reflective polarizer 325 and the eye-box region 259. The second circular reflective polarizer 325 and the second polarizer 323 may be elements separate from the second optical lens 321, or may be attached to a same side of the second optical lens 321.

Although the mirror 407 and the first polarizer 313 may be elements separate from the first optical lens 311, for discussion purposes, the mirror 407 and the first polarizer 313 are presumed to be films disposed at opposite surfaces of the first optical lens 311. Thus, the alignment (or misalignment) in the mirror 407 and the first polarizer 313 may be the same as the alignment (or misalignment) in the first optical lens 311. Similarly, for discussion purposes, the second polarizer 323 and the second circular reflective polarizer 325 are presumed to be attached to a same surface of the second optical lens 321. Thus, the alignment (or misalignment) in the second polarizer 323 and the second circular reflective polarizer 325 may be the same as the alignment (or misalignment) in the second optical lens 321. The sensors 223-1 and 223-2 may measure an alignment parameter of the first optical lens 311 and the second optical lens 321, respectively. The controller 216 may detect a misalignment in the first optical lens 311 or the second optical lens 321 based on the signal received from the sensor 223-1 or 223-2. Based on detection of the misalignment, the controller 216 may control the LC device 221-2 included in the path correction device 225-2 to provide a correction to the optical path of an image light propagating between the first optical component 417 and the second optical component 327.

In the embodiment shown in FIG. 4A, the path correction device 225-2 is shown as being spaced apart from each of the first optical component 417 and the second optical component 327 by a gap. In some embodiments, the path correction device 225-2 may be stacked with one of the first optical component 417 and the second optical component 327 without a gap (e.g., through direct contact), and the path correction device 225-2 may be spaced apart from the other of the first optical component 417 and the second optical component 327 by a gap. In some embodiments, the path correction device 225-2 may be stacked with both of the first optical component 417 and the second optical component 327 without a gap (e.g., through direct contact). In the embodiment shown in FIG. 4A, the path correction device 225-2 is shown to have flat surfaces. In some embodiments, the path correction device 225-2 may have at least one curved surface.

FIG. 4B illustrates an optical path and a polarization conversion of an image light from the display element 204 to the eye-box region 259 via the lens assembly 402. For the simplicity of illustration, the first optical lens 311 and the second optical lens 321 are omitted in FIG. 4B as these elements do not affect the polarization. For the simplicity of illustration, the first polarizer 313, the mirror 407, the second circular reflective polarizer 325, and the second polarizer 323 are shown as having flat surfaces. In some embodiments, one or more of the first polarizer 313, the mirror 407, the second circular reflective polarizer 325, and the second polarizer 323 may have at least one curved surface. The waveplates 222 included in the path correction device 225-2 have reference numbers of 222-3 and 222-4. For discussion purposes, the second circular reflective polarizer 325 is presumed to function as a left-handed circular reflective polarizer that substantially reflects an LHCP light, and substantially transmits an RHCP light.

For discussion purposes, the LC devices 221-2 is presumed to be an active LC device, which may be switchable, when controlled by the controller 216, between operating in an activation state and operating in a non-activation state. The LC devices 221-2 operating in the activation state may change the propagation direction of the p-polarized light, and maintain the propagation direction of the s-polarized light. The LC devices 221-2 operating in the non-activation state may maintain the propagation direction of either the s-polarized light or the p-polarized light. For discussion purposes, in the embodiment shown in FIG. 4B, the LC devices 221-2 is controlled by the controller 216 to operate in the non-activation state.

As shown in FIG. 4B, the first polarizer 313 may convert the image light emitted from the display element 204 (not shown) into an image light 432L propagating through the first optical lens 311 (not shown) toward the mirror 407. The mirror 407 may transmit a first portion of the image light 432L as an image light 433L toward the path correction device 225-2, and reflect a second portion of the image light 432L back to the first polarizer 313 as an image light 434R. The first polarizer 313 may block the image light 434R via absorption.

The waveplate 222-3 may be configured to convert the image light 433L into an image light 435p propagating toward the LC device 221-2. The LC device 221-2 operating in the non-activation state may transmit the image light 435p toward the waveplate 222-4 without affecting the propagation direction and polarization The waveplate 222-4 may convert the image light 435p into an image light 439L toward the second circular reflective polarizer 325.

The second circular reflective polarizer 325 may reflect the image light 439L back to the path correction device 225-2 as an image light 441L. The waveplate 222-4 may be configured to convert the image light 441L into an image light 443p propagating toward the LC device 221-2. The LC device 221-2 may transmit the image light 443p toward the waveplate 222-3 without affecting the propagation direction and polarization. The waveplate 222-3 may convert the image light 443p into an image light 447L propagating toward the mirror 407.

The mirror 407 may transmit a first portion of the image light 447L as an LHCP light (not shown) toward the first polarizer 313, and reflect a second portion of the image light 447L back to the second path correction device 225-2 as an image light 449R. The waveplate 222-3 may convert the image light 449R to an image light 451s. The LC device 221-2 operating at the non-activation state may maintain the propagation direction and polarization of the image light 451s. The LC device 221-2 may transmit the image light 451s toward the waveplate 222-4. The waveplate 222-4 may convert the image light 451s into an image light 455R propagating toward the second circular reflective polarizer 325. The second circular reflective polarizer 325 may substantially transmit the image light 455R as an image light 457R toward the second polarizer 323. The second circular polarizer 323 may transmit the image light 457R as an image light 459R toward the eye-box region 259 (not shown).

FIG. 4E illustrates an optical path correction performed by the LC device 221-2 operating at the activation state to reduce a deviation of the actual optical path from the target optical path caused by the tilt of the second circular reflective reflector 325. As shown in FIG. 4E, the LC device 221-2 included in the second path correction device 225-2 is shown as operating in the activation state to provide a phase correction (via providing a spatially varying phase profile) to a p-polarized image light, thereby steering the propagation direction of the p-polarized image light. When an input light has an s-polarization, the LC device 221-2 may transmit the input light without changing the propagation direction of the input light. That is, the propagation direction of the s-polarized light may be maintained.

FIG. 4E shows an optical path of the image light when the second circular reflective reflector 325 is misaligned due to tilting from a vertical plane perpendicular to the optical axis 420. FIG. 4E shows an example path correction performed by the LC device 221-2, and is based on the aligned situation shown in FIG. 4B. The target optical path (solid arrows) is also shown for comparison and illustrative purposes only. The actual optical path when the LC device 221-2 operates in the activation state is shown in dashed arrows. A portion of the actual optical path coincides with a portion of the target optical path, starting from image light 432L to the image light 435p. The LC device 221-2 operating in the activation state may forwardly steer the image light 435p clockwise as an image light 475p by a steering angle (½)*γ4, where γ4 is an angular deviation of the actual optical path when the second polarization selective reflector 325 is misaligned (without path correction) and the target optical path 459R. For the simplicity of illustration, the angular deviation is not shown in the figures. The waveplate 222-4 may convert the image light 475p into an image light 477L while maintaining the propagation direction. The second circular reflective reflector 325 may reflect the image light 477L as an image light 479L. The waveplate 222-4 may convert the image light 479L into an image light 481p while maintaining the propagation direction. The LC device 221-4 may forwardly steer the image light 481p counter-clockwise as an image light 483p by a steering angle (½)*γ4. The waveplate 223-3 may convert the image light 483p into an image light 485L while maintaining the propagation direction. The mirror 207 may reflect the image light 485L as an image light 487R. The image light 487R may propagate through the path correction device 225-2 and the second circular reflective reflector 325 while maintaining the polarization and the propagation direction.

With the phase correction provided by the LC device 221-2, the total steering angle provided by the LC device 221-2 to the image light 433L may be γ4, which may cancel the angular deviation of the actual optical path from the target optical path shown. As a result, the portion of the actual optical path represented by the image light 487R may substantially coincide with a portion of the target optical path represented by the image light 459R. Thus, the image light 487R may form an image at a position in the eye-box region 259 that is substantially the same as the position where the image light 459 would form an image. Alternatively, the portion of the actual optical path represented by the image light 487R may form a small angle with the portion of the target optical path represented by the image light 459R. The small angle may be smaller than a predetermined angle, which may not cause a degradation in the image quality at the eye-box region 259. The small angle may be smaller than the γ4. As compared to the case where the deviation of the actual optical path from the target optical path due to the misalignment is not corrected, the path correction provided by the LC device 221-2 may significantly improve the image quality at the eye-box region 259. Although tilt of the second circular reflective reflector 325 is shown as an example of the misalignment in FIG. 4E, the misalignment may be in other forms described above. In addition, in some embodiments, the misalignment may be in the mirror 407.

FIG. 4C schematically illustrates an x-z sectional view of a system 440, according to an embodiment of the present disclosure. The system 440 may include elements, structures, and/or functions that are the same as or similar to those included in the system 200 shown in FIGS. 2A-2G, the system 300 shown in FIG. 3A, the system 340 shown in FIG. 3B, the system 360 shown in FIG. 3C, or the system 400 shown in FIG. 4A. Descriptions of the same or similar elements, structures, and/or functions can refer to the above descriptions rendered in connection with FIGS. 2A-2G, FIG. 3A, FIG. 3B, FIG. 3C, or FIG. 4A. As shown in FIG. 4C, the system 440 may include a lens assembly 442 disposed between the display element 204 and the eye-box region 259. The display element 204 may output the image light 421 representing a virtual image toward the lens assembly 442. The lens assembly 442 may transform the image light (e.g., a divergent image light) 421 emitted from each point on the display element 204 to a bundle of parallel rays or a collimated image light that substantially covers the exit pupil 257 in the eye-box region 259 of the system 440 (or the entire eye-box region 259 of the system 440).

In the embodiment shown in FIG. 4C, the lens assembly 442 may be a path-folding lens assembly that is configured to increase the length of an optical path of the image light 421 projected from the display element 204 toward the exit pupil 257. The lens assembly 442 may include elements that are the same as or similar to those shown in FIG. 4A. Descriptions of the similar or same elements are not repeated. The lens assembly 442 may include a second optical component 427 in place of the second optical component 327 shown in FIG. 4A.

In the embodiment shown in FIG. 4C, the second optical component 427 may include a waveplate 409, the second optical lens 321, a polarization selective reflector 425, and a second polarizer 423 arranged in an optical series. The second optical lens 321 may be disposed between the partial reflector 425 and the waveplate 409. The polarization selective reflector 425 may be disposed between the second optical lens 321 and the second polarizer 423. The waveplate 409 may be disposed between the second optical lens 321 and the path correction device 225-2. The second polarizer 423 may be disposed between the eye-box region 259 and the polarization selective reflector 425. In some embodiments, the second polarizer 423 may be omitted. In some embodiments, the polarization selective reflector 425 may be a layer or coating disposed at (e.g., bonded to or formed on) a surface of the second optical lens 321 facing the eye-box region 259. In some embodiments, the polarization selective reflector 425 may be a linear reflective polarizer configured to substantially reflect a linearly polarized light having a predetermined polarization (e.g., p-polarization), and substantially transmit a linearly polarized light having a polarization (e.g., s-polarization) that is orthogonal to the predetermined polarization. For discussion purposes, the polarization selective reflector 425 may also be referred to as a linear reflective polarizer 425.

In the embodiment shown in FIG. 4C, the second polarizer 423 may be a layer or coating disposed at (e.g., bonded to or formed on) the surface of the second optical lens 321 facing the eye-box region 259. The second polarizer 423 may be an absorptive linear polarizer configured to block the linearly polarized light having the predetermined polarization via absorption, and transmit the linearly polarized light having the polarization that is orthogonal to the predetermined polarization. The waveplate 409 may be a layer or coating disposed at (e.g., bonded to or formed on) the surface of the second optical lens 321 facing the path correction device 225-2. The waveplate 409 may be similar to the waveplate 222. The waveplate 409 may be a QWP operating at least for the visible spectrum.

In the embodiment shown in FIG. 4C, the sensors 223-1 and 223-2 may be configured to measure an alignment parameter of at least one of the linear reflective polarizer 425, the waveplate 409, the second optical lens 321, the second polarizer 423, the mirror 407, the first optical lens 311, or the first polarizer 313. When the linear reflective polarizer 425, the waveplate 409, and the second polarizer 423 are disposed at surfaces of the optical lens 321, the alignment (or misalignment) of the linear reflective polarizer 425, the waveplate 409, and the second polarizer 423 may be the same as the alignment (or misalignment) of the optical lens 321. When the first polarizer 313 and the mirror 407 are disposed at the surfaces of the first lens 311, the alignment (or misalignment) of the first polarizer 313 and the mirror 407 may be the same as the alignment (or misalignment) of the first lens 311. Thus, the sensors 223-1 and 223-2 may measure at least one alignment parameter associated with the first lens 311 and/or the second lens 321. Based on the signal received from the sensors 223-1 and/or 223-2, the controller 216 may detect a misalignment in at least one of the first lens 311 or the second lens 321. The alignment (or misalignment) of the first lens 311 may also be referred to as the alignment (or misalignment) of the first optical component 417, and the alignment (or misalignment) of the second lens 321 may also be referred to as the alignment (or misalignment) of the second optical component 427. Based on detection of a misalignment in at least one of the first lens 311 or the second lens 321, the controller 216 may control the LC device 221-2 to operate in the activation state to provide correction to the optical path to reduce the deviation of the optical path from the target optical path.

In the embodiment shown in FIG. 4C, the path correction device 225-2 is shown as being spaced apart from each of the first optical component 417 and the second optical component 427 by a gap. In some embodiments, the path correction device 225-2 may be stacked with one of the first optical component 417 and the second optical component 427 without a gap (e.g., through direct contact), and the path correction device 225-2 may be spaced apart from the other of the first optical component 417 and the second optical component 427 by a gap. In some embodiments, the path correction device 225-2 may be stacked with both of the first optical component 417 and the second optical component 427 without a gap (e.g., through direct contact). In the embodiment shown in FIG. 4C, the path correction device 225-2 is shown as having flat surfaces. In some embodiments, the path correction device 225-2 may have at least one curved surface.

FIG. 4D illustrates an optical path and a polarization conversion of an image light from the display element 204 (not shown in FIG. 4D) to the eye-box region 259 via the lens assembly 442, according to an embodiment of the present disclosure. For the simplicity of illustration, the first optical lens 311 and the second optical lens 321 are omitted in FIG. 4D as they do not affect the polarization of the image light. For the simplicity of illustration, the first polarizer 313, the mirror 407, the waveplate 409, the linear reflective polarizer 425, and the second polarizer 423 are shown as having flat surfaces. In some embodiments, one or more of the first polarizer 313, the mirror 407, the waveplate 409, the linear reflective polarizer 425, and the second polarizer 423 may have at least one curved surface. The waveplates 222 included in the path correction device 225-2 have reference numbers of 222-3 and 222-4. For discussion purposes, in the embodiment shown in FIG. 4D, the linear reflective polarizer 425 is configured to substantially reflect a p-polarized light, and substantially transmit an s-polarized light. For discussion purposes, the second polarizer 423 is configured to substantially absorb a p-polarized light, and substantially transmit an s-polarized light.

For discussion purposes, the LC devices 221-2 is presumed to be an active LC device, which may be controlled by the controller 216 to operate in the activation state and the non-activation state. The LC devices 221-2 operating in the activation state may change the propagation direction of the p-polarized light while maintaining the polarization, and maintain the propagation direction of the s-polarized light while maintaining the polarization. The LC devices 221-2 operating in the non-activation state may maintain the propagation directions of either the s-polarized light and the p-polarized light. That is, the LC devices 221-2 operating in the non-activation state may not affect the polarization or propagation direction of an image light. For illustrative purposes, in the embodiment shown in FIG. 4D, the LC devices 221-2 is shown as being in the non-activation state.

As shown in FIG. 4D, the optical path of the image light emitted from a light outputting unit at the upper half of the display panel of the display element 204, from the image light 432L to the image light 439L may be similar to that shown in FIG. 4B. The image light 439L output from the waveplate 222-4 may propagate toward the waveplate 409. The waveplate 409 may convert the image light 439L into an image light 461p propagating toward the linear reflective polarizer 425. The linear reflective polarizer 425 may reflect the image light 461p back to the waveplate 409 as an image light 463p. The waveplate 409 may convert the image light 463p into an image light 465L. The waveplate 222-4 may convert the LHCP image light 465L into an image light 467p propagating toward the LC device 221-2. The LC device 221-2 may transmit the image light 467p toward the waveplate 222-3 while maintaining the polarization and propagation direction. The waveplate 222-3 may convert the image light 467p into an image light 471L propagating toward the mirror 407.

The mirror 407 may transmit a first portion of the image light 471L as an LHCP light (not shown) toward the first polarizer 313, and reflect a second portion of the image light 471L back to the second path correction device 225-2 as an image light 473R. The waveplate 222-3 may convert the image light 473R into an image light 475s. The LC device 221-2 may transmit the image light 475s while maintaining the polarization and propagation direction. The waveplate 222-4 may convert the image light 475s into an image light 479R propagating toward the waveplate 409. The waveplate 409 may convert the image light 479R into an image light 481s propagating toward the linear reflective polarizer 425. The linear reflective polarizer 425 may substantially transmit the image light 481s as an image light 483s toward the second polarizer 423. The second polarizer 423 may transmit the image light 483s as an image light 485s toward the eye-box region 259 (not shown). For the simplicity of illustration, a path correction performed by the LC device 221-2 when a misalignment occurs to an optical element included in the lens assembly 442 is not shown, but one can derive based on the optical path shown in FIG. 4D and the steering provided by the LC device 221-2 described above.

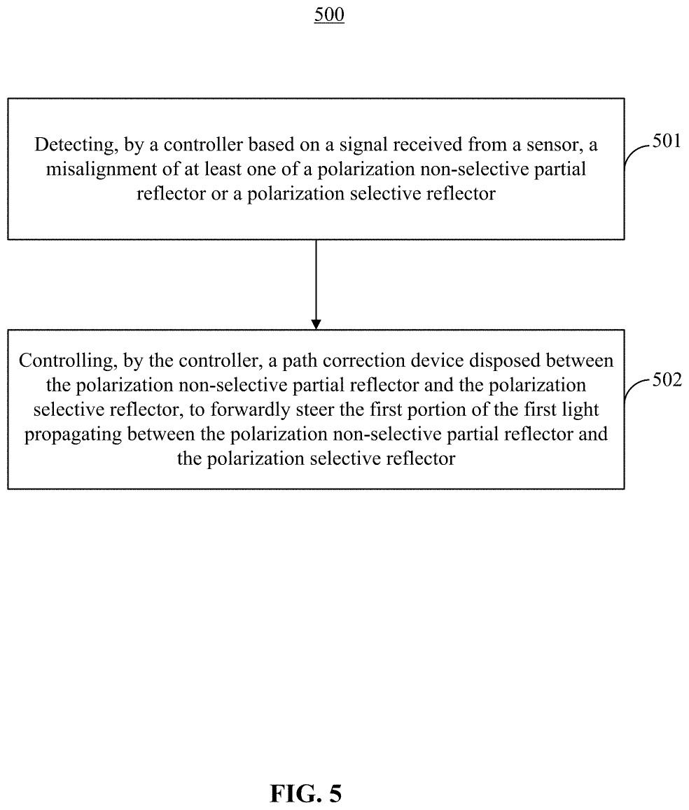

FIG. 5 is a flowchart illustrating a method 500 for correcting an optical path of an image light propagation in a path-folding lens assembly, according to an embodiment of the present disclosure. The method 500 may include detecting, by a controller based on a signal received from a sensor, a misalignment of at least one of a polarization non-selective partial reflector or a polarization selective reflector (step 501). In some embodiments, the polarization non-selective partial reflector may be configured to transmit a first portion of a first light and reflect a second portion of the first light. The polarization selective reflector may be configured to reflect the first portion of the first light received from the polarization non-selective reflector back to the polarization non-selective reflector. Detailed descriptions and examples of the polarization non-selective partial reflector and the polarization selective reflector can refer to the above descriptions rendered in connection with FIGS. 2A-4E.

The method 500 may also include controlling, by the controller, a path correction device disposed between the polarization non-selective partial reflector and the polarization selective reflector, to forwardly steer the first portion of the first light propagating between the polarization non-selective partial reflector and the polarization selective reflector (step 502). In some embodiments, the controller may control the path correction device to provide a spatially varying phase profile for shifting the phase of the first portion of the first light.

The method 500 may include other steps or processes that are explicitly or implicitly described above in the descriptions of the devices or systems. For example, the method 500 may include converging, by an optical lens disposed between the polarization non-selective partial reflector and the polarization selective reflector, the first portion of the first light while the first portion of the first light propagates between the polarization non-selective partial reflector and the polarization selective reflector.

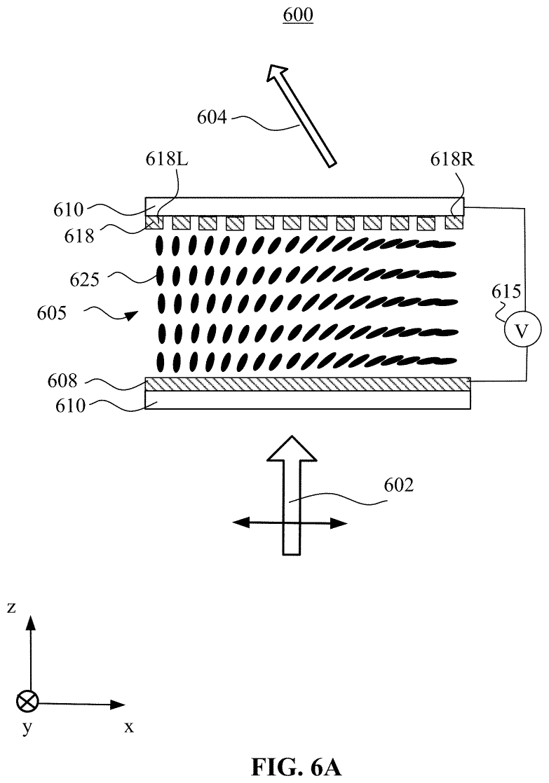

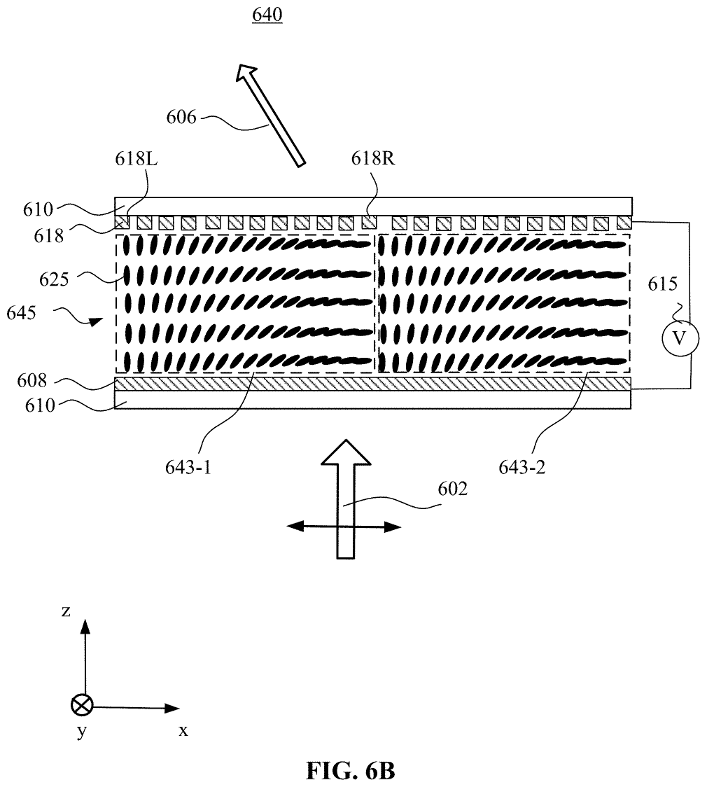

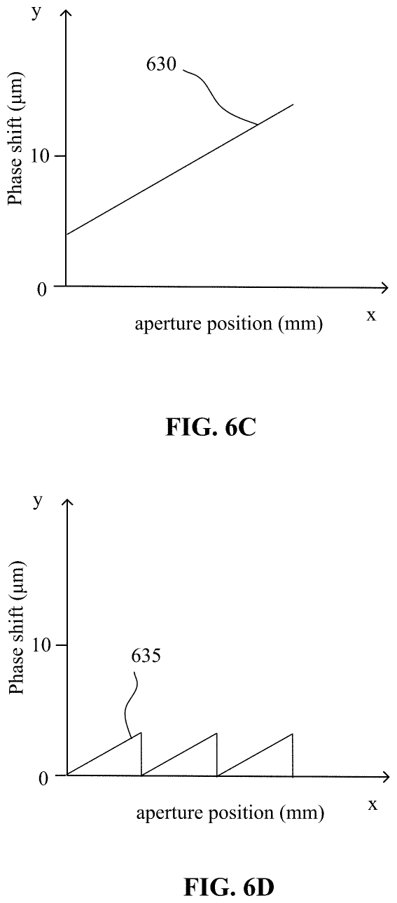

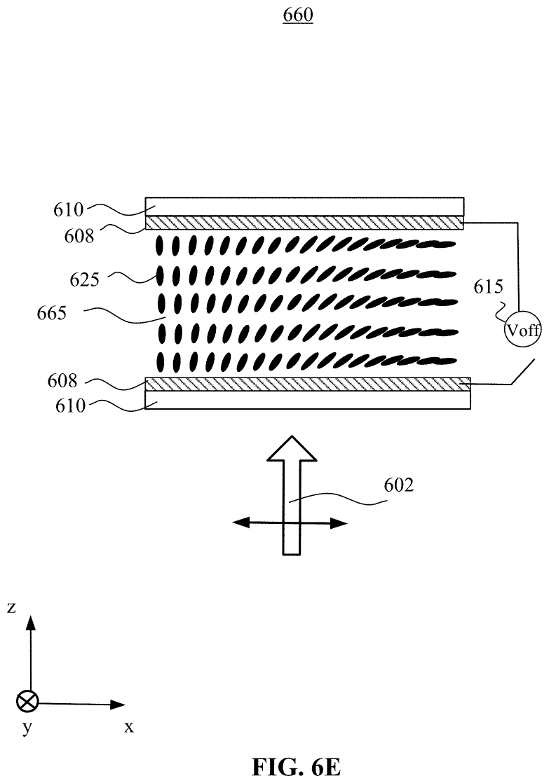

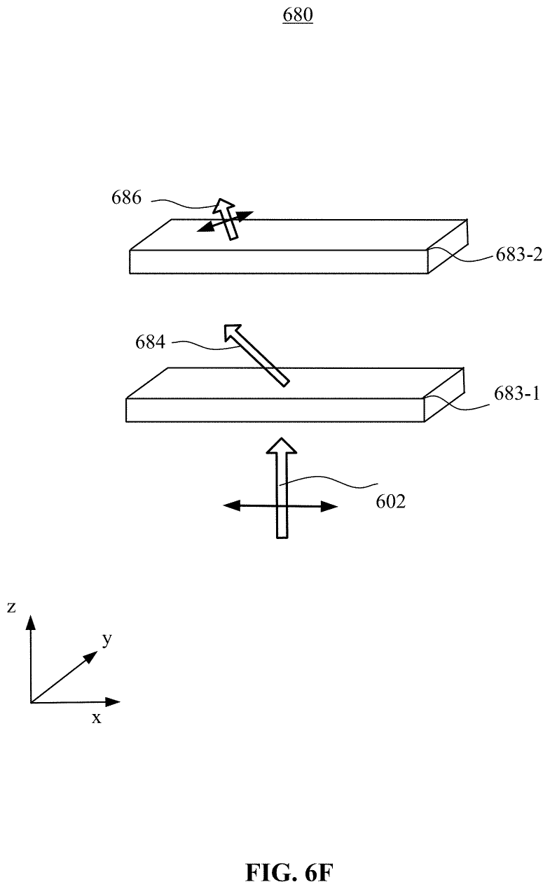

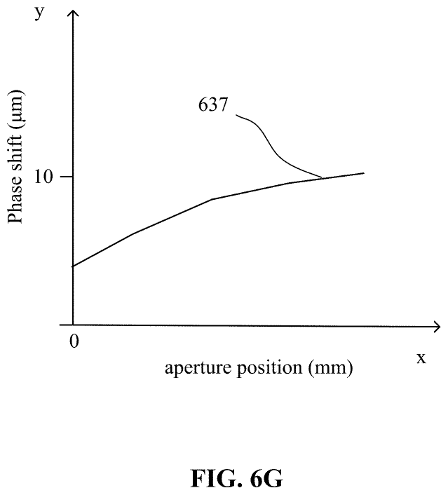

FIG. 6A schematically illustrates an x-z sectional view of a beam steering device 600, according to an embodiment of the present disclosure. The LC device 221-1 or 221-2 included in the path correction device 225-1 or 225-2 shown in FIGS. 2A-4D may include one or more beam steering devices 600. As shown in FIG. 6A, the beam steering device 600 may include an LC layer 605 disposed between two substrates 610. The LC layer 605 may include LC molecules 625. For discussion purposes, FIG. 6A shows that the LC molecules 625 have elongated shapes (represented by black rods in FIG. 6A). Each substrate 610 may be provided with a transparent conductive electrode 608 or 618. In the embodiment shown in FIG. 6A, the electrode 608 (which may be disposed at the lower substrate 610) may be a continuous planar electrode, and the electrode 618 (which may be disposed at the upper substrate 610) may be a patterned electrode including a plurality of sub-electrodes (e.g., a plurality of striped electrodes arranged in parallel). In some embodiments, both of the electrode 608 and electrode 618 may be patterned electrodes, each of which may include a plurality of sub-electrodes (e.g., a plurality of striped electrodes arranged in parallel). In some embodiments, the sub-electrodes of the lower electrode 608 may be substantially aligned with the sub-electrodes of the upper electrode 618. In some embodiments, the sub-electrodes of the lower electrode 608 may be partially offset from the sub-electrodes of the upper electrode 618.

A power source 615 may supply a voltage to the electrodes 608 and 618 to generate an electric field in the LC layer 605 to re-orient the LC molecules 625. An alignment layer (not shown) may be disposed at an inner surface (a surface facing the LC layer 605) of at least one (e.g., each) of the electrodes 608 and 618. In some embodiments, the alignment layers may be configured with homogeneous anti-parallel alignment directions, e.g., directions along the x-axis shown in FIG. 6A, through which the LC molecules 625 may be homogeneously aligned at a voltage-off state (e.g., V=0, not shown in FIG. 6A). In the embodiment shown in FIG. 6A, the tilt angles of the LC molecules 625 may be configured to be substantially the same at the voltage-off state (e.g., V=0, not shown in FIG. 6A).

In the embodiment shown in FIG. 6A, an optical phase modulation may be achieved by applying an electric field across the LC layer 605, which results in a corresponding change in the local refractive index of the LC layer 605. In some embodiments, the lower electrode 608 may be applied with a uniform driving voltage, e.g., may be grounded. The amplitudes of driving voltages applied to the sub-electrodes of the upper electrode 618 via the power source 615 may be individually controlled. For example, the amplitudes of driving voltages may be configured to be progressively changed (e.g., decreased) from a leftmost sub-electrode 618L to a rightmost sub-electrode 618R. Thus, from a leftmost edge to a rightmost edge of the LC layer 605, the amplitude of the electric field in the LC layer 605 may gradually change (e.g., decrease). Accordingly, from the leftmost edge to the rightmost edge of the LC layer 605, the orientation of the directors of the LC molecules 625 (of the LC material having the positive dielectric anisotropy) may change from being substantially perpendicular to the surface of the substrate 610 to being substantially parallel to the surface of the substrate 610. Thus, for a linearly polarized input beam 602 polarized in the alignment direction (e.g., the x-axis direction), the refractive index experienced by the linearly polarized input beam 602 may gradually increase from the leftmost edge to the rightmost edge of the LC layer 605. Accordingly, the phase shift experienced by the linearly polarized input beam 602 may gradually increase from the leftmost edge to the rightmost edge of the LC layer 605. In other words, the beam steering device 600 may provide a phase shift to the linearly polarized input beam 602 according to spatially varying phase profile. Thus, the beam steering device 600 may forwardly deflect (or forwardly steer) the linearly polarized input beam 602 counter-clockwise with respect to an initial input optical path of the input beam 602. The beam steering device 600 may forwardly deflect (or forwardly steer) the linearly polarized input beam 602 as a beam 604 having, e.g., a positive steering angle.

FIG. 6C illustrates a spatially varying phase profile 630 of the beam steering device 600 shown in FIG. 6A, according to an embodiment of the present disclosure. As shown in FIG. 6C, the horizontal axis represents an aperture position (which is a position at the aperture of the beam steering device 600), and the vertical axis represents a phase shift experienced by the linearly polarized input beam 602. As shown in FIG. 6C, the spatially varying phase profile 630 provided by the beam steering device 600 to the linearly polarized input beam 602 may be a continuous phase profile that includes a single straight line with only one slope. Accordingly, the beam steering device 600 may provide a same steering angle to the linearly polarized input beam 602 when the linearly polarized input beam 602 is incident onto different portions of the beam steering device 600.

FIG. 6G illustrates a spatially varying phase profile 637 of the beam steering device 600 shown in FIG. 6A, according to an embodiment of the present disclosure. As shown in FIG. 6G, the horizontal axis represents an aperture position (which is a position at the aperture of the beam steering device 600), and the vertical axis represents a phase shift experienced by the linearly polarized input beam 602. As shown in FIG. 6G, the spatially varying phase profile 630 provided by the beam steering device 600 to the linearly polarized input beam 602 may be a continuous phase profile that includes multiple straight lines with different slopes. Accordingly, the beam steering device 600 may provide different steering angles to the linearly polarized input beam 602 when the linearly polarized input beam 602 is incident onto different portions of the beam steering device 600 along the longitudinal direction (e.g., the x-axis direction shown in FIG. 6A).

When the amplitudes of driving voltages applied to the sub-electrodes of the upper electrode 618 are substantially uniform from the leftmost sub-electrode 618L to the rightmost sub-electrode 618R of the LC layer 605, the orientation of the directors of the LC molecules 625 may be substantially the same. Thus, the beam steering device 600 may function as a substantially optically uniform plate for the input beam 602. The beam steering device 600 may provide a spatially constant phase profile (or phase shift) to the linearly polarized input beam 602, and may transmit the beam 602 therethrough with the propagation direction substantially maintained. For a linearly polarized input beam polarized in an in-plane direction (e.g., a y-axis direction) perpendicular to the alignment direction (e.g., the x-axis direction), the beam steering device 600 may substantially transmit the beam therethrough with the propagation direction substantially maintained, independent of the operation state of the beam steering device 600.

FIG. 6B schematically illustrates an x-z sectional view of a beam steering device 640, according to an embodiment of the present disclosure. The LC device 221-1 or 221-2 included in the path correction device 225-1 or 225-2 shown in FIGS. 2A-4E may include one or more beam steering devices 640. The beam steering device 640 may include elements, structures, and/or functions that are the same as or similar to those included in the beam steering device 600 shown in FIG. 6A. Descriptions of the same or similar elements, structures, and/or functions can refer to the above descriptions rendered in connection with FIG. 6A. The beam steering device 640 may be configured to provide a Fresnel type phase profile. The thickness of the beam steering device 640 may be reduced compared to a polarization selective beam steering device that provides a continuous varying phase profile (e.g., the beam steering device 600 shown in FIG. 6A).

As shown in FIG. 6B, the beam steering device 640 may include an LC layer 645 disposed between two substrates 610. The beam steering device 640 may include a plurality of 2π phase resets, e.g., 643-1 and 643-2. The lower electrode 618 may be applied with a uniform driving voltage, e.g. may be grounded. For each 2π phase reset 643-1 or 643-2, the amplitudes of driving voltages applied to the sub-electrodes of the upper electrode 618 via the power source 615 may be progressively changed (e.g., decreased) from a leftmost sub-electrode 618L to a rightmost sub-electrode 618R. Thus, from a leftmost edge to a rightmost edge of the 2π phase reset 643-1 or 643-2, the amplitude of the electric field in the 2π phase reset 643-1 or 643-2 may gradually change (e.g., decrease). Accordingly, from the leftmost edge to the rightmost edge of the 2π phase reset 643-1 or 643-2, the orientation of the directors of the LC molecules 625 of LCs having the positive dielectric anisotropy may change from being substantially perpendicular to the surface of the substrate 610 to being substantially parallel to the surface of the substrate 610. As a result, the beam steering device 640 may forwardly diffract (or forwardly steer) the linearly polarized input beam 602 counter-clockwise with respect to an initial input optical path of the input beam 602. The beam steering device 640 may forwardly diffract (or forwardly steer) the linearly polarized input beam 602 as a beam 606 having, e.g., a positive steering angle.

FIG. 6D illustrates a spatially varying phase profile 635 of the beam steering device 640 shown in FIG. 6B, according to an embodiment of the present disclosure. As shown in FIG. 6D, the horizontal axis represents an aperture position (which is a position at the aperture of the beam steering device 640), and the vertical axis represents a phase shift experienced by the linearly polarized input beam 602. As shown in FIG. 6D, the spatially varying phase profile 635 provided by the beam steering device 640 to the linearly polarized input beam 602 may be a Fresnel type phase profile.

When the amplitudes of driving voltages applied to the sub-electrodes of the upper electrode 618 are substantially uniform from the leftmost sub-electrode 618L to the rightmost sub-electrode 618R of the LC layer 645, the orientation of the directors of the LC molecules 625 in each 2π phase reset 643-1 or 643-2 may be substantially the same. Thus, the beam steering device 640 may function as a substantially optically uniform plate for the input beam 602. The beam steering device 640 may provide a phase shift to the linearly polarized input beam 602 according to a spatially constant phase profile, and may transmit the beam 602 therethrough with the propagation direction substantially maintained.

FIG. 6E schematically illustrates an x-z sectional view of a beam steering device 660, according to an embodiment of the present disclosure. The LC device 221-1 or 221-2 included in the path correction device 225-1 or 225-2 shown in FIGS. 2A-4E may include one or more beam steering devices 660. The beam steering device 660 may include elements, structures, and/or functions that are the same as or similar to those included in the beam steering device 600 shown in FIG. 6A, or the beam steering device 640 shown in FIG. 6B. Descriptions of the same or similar elements, structures, and/or functions can refer to the above descriptions rendered in connection with FIG. 6A or FIG. 6B.

As shown in FIG. 6E, the beam steering device 660 may include an LC layer 665 disposed between two substrates 610. Each substrate 610 may be provided with the transparent conductive electrode 608 that may be a continuous planar electrode. An alignment layer (not shown) may be disposed at an inner surface (a surface facing the LC layer 665) of at least one (e.g., each) of the two electrodes 608. In some embodiments, the alignment layers may be configured with homogeneous anti-parallel alignment directions, e.g., x-direction in FIG. 6E. In the embodiment shown in FIG. 6E, the tilt angles of the LC molecules 625 may be configured to be spatially varying at the voltage-off state (e.g., V=0). For example, as shown in FIG. 6E, at the voltage-off state (e.g., V=0), from a leftmost edge to a rightmost edge of the LC layer 665, the tilt angles of the LC molecules 625 may be configured to gradually change, e.g., decreasing from about 90 degrees to about 3 degrees.

When the power source 615 supplies a voltage to the electrodes 608, a uniform vertical electric field may be generated in the LC layer 645 to re-orient the LC molecules 625 (not shown in FIG. 6E). As the LC molecules 625 are configured with spatially varying tilt angles at the voltage-off state (e.g., V=0), the LC molecules 625 may be re-oriented to different orientations under the uniform vertical electric field. Through configuring the applied voltage and the spatially varying tilt angles of the LC molecules 625 at the voltage-off state (e.g., V=0), the beam steering device 660 may be configured to provide a desirable spatially varying phase profile to the linearly polarized input beam 602 at a voltage-on state.

The beam steering device 600 shown in FIG. 6A, the beam steering device 640 shown in FIG. 6B, or the beam steering device 660 shown in FIG. 6E may be configured to provide a 1D spatially varying phase profile (or 1D phase shift variation) to the linearly polarized input beam 602. Thus, the beam steering device 600 shown in FIG. 6A, the beam steering device 640 shown in FIG. 6B, or the beam steering device 660 shown in FIG. 6E may forwardly steer the linearly polarized input beam 602 along a single axis, e.g., the x-axis direction in FIG. 6A, FIG. 6B, or FIG. 6E. For discussion purposes, the beam steering device 600 shown in FIG. 6A, the beam steering device 640 shown in FIG. 6B, or the beam steering device 660 shown in FIG. 6E may be referred to as a 1D beam steering device.

In some embodiments, the patterned electrode 618 in the beam steering device 600 shown in FIG. 6A or the beam steering device 640 shown in FIG. 6B may be configured to include a plurality of pixelated sub-electrodes arranged in a 2D array. The amplitudes of driving voltages applied to the sub-electrodes of the patterned electrode 618 via the power source 615 may be individually controlled. In some embodiments, the tilt angles of the LC molecules 625 in beam steering device 660 shown in FIG. 6E may be configured to have 2D variations in a film plane of the LC layer 665, at the voltage-off state (e.g., V=0). Accordingly, the beam steering device 600 shown in FIG. 6A, the beam steering device 640 shown in FIG. 6B, or the beam steering device 660 shown in FIG. 6E may be configured to function as a 2D beam steering device. In some embodiments, two of the 1D beam steering devices may be stacked to form a 2D beam steering device. The two 1D beam steering devices may be configured to forwardly steer the linearly polarized input beam 602 along two different axes. Thus, the 2D beam steering device may provide a 2D spatially varying phase profile (or 2D phase shift variation) to the linearly polarized input beam 602, and forwardly steer the linearly polarized input beam 602 along two different axes, e.g., the x-axis direction and the y-axis direction in FIG. 6A, FIG. 6B, or FIG. 6E.

FIG. 6F schematically illustrates an x-z sectional view of a beam steering device 680, according to an embodiment of the present disclosure. The beam steering device 680 may be an embodiment of the LC device 221-1 or 221-2 included in the path correction device 225-1 or 225-2 shown in FIGS. 2A-4E. The beam steering device 680 may include elements, structures, and/or functions that are the same as or similar to those included in the beam steering device 600 shown in FIG. 6A, the beam steering device 640 shown in FIG. 6B, or the beam steering device 660 shown in FIG. 6E. Descriptions of the same or similar elements, structures, and/or functions can refer to the above descriptions rendered in connection with FIG. 6A, FIG. 6B, or FIG. 6E.

The beam steering device 680 may function as a 2D beam steering device. As shown in FIG. 6F, the beam steering device 680 may include a first steering element 683-1 and a second steering element 683-2 arranged in an optical series. Each of the first steering element 683-1 and the second steering element 683-2 may function a 1D beam steering device, e.g., may be an embodiment of the beam steering device 600 shown in FIG. 6A, the beam steering device 640 shown in FIG. 6B, or the beam steering device 660 shown in FIG. 6E. For discussion purposes, the first steering element 683-1 and the second steering element 683-2 may also be referred to as the 1D beam steering device 683-1 and the 1D beam steering device 683-2, respectively. The 1D beam steering device 683-1 and the 1D beam steering device 683-2 may be configured to forwardly steer a linearly polarized input beam having a predetermined direction along two different axes, e.g., along the x-axis direction and the y-axis direction, respectively.

For example, in some embodiments, the 1D beam steering device 683-1 may include one or two patterned electrodes, each of which includes a plurality of sub-electrodes (e.g., a plurality of striped electrodes) arranged in parallel in a first direction, e.g., the x-axis direction. In some embodiments, the 1D beam steering device 683-2 may include one or two patterned electrodes, each of which includes a plurality of sub-electrodes (e.g., a plurality of striped electrodes) arranged in parallel in a second direction different from the first direction, e.g., the y-axis direction. In some embodiments, the 1D beam steering device 683-1 may include LC molecules configured with 1D variation in the tilt angles of the LC molecules in a first direction, e.g., the x-axis direction. In some embodiments, the 1D beam steering device 683-2 may include LC molecules configured with 1D variation in the tilt angles of the LC molecules in a second direction different from the first direction, e.g., the y-axis direction.

Thus, the 1D beam steering device 683-1 may provide a 1D phase variation that varies in the first direction, e.g., the x-axis direction, and forwardly steer the linearly polarized input beam 602 in the first direction, e.g., the x-axis direction. The 1D beam steering device 683-2 may provide a 1D phase variation that varies in the second direction, e.g., the y-axis direction, and forwardly steer the linearly polarized input beam 602 in the second direction, e.g., the y-axis direction. Accordingly, the beam steering device 680 may provide a 2D phase variation that varies in both of the first direction (e.g., the x-axis direction) and the second direction (e.g., the y-axis direction), and forwardly steer the linearly polarized input beam 602 in both of the first direction (e.g., the x-axis direction) and the second direction (e.g., the y-axis direction).

FIGS. 6A-6G illustrate exemplary configurations of the beam steering device (or beam deflector), which may be used in the path correction devices disclosed herein. In some embodiments, the beam steering device may have other suitable configurations, which are not shown in the figures. The beam steering device may be linear polarization selective or circular polarization selective. In some embodiments, the beam steering device may include a single steering element, or a stack of two or more steering elements arranged in an optical series. In some embodiments, each steering element may include suitable sub-wavelength structures, a birefringent or optically anisotropic material (e.g., a liquid crystal (“LC”) material), a photo-refractive holographic material, or any combination thereof. For example, in some embodiments, the steering element may be an LC steering element, such as an optical phased array (“OPA”), a switchable Bragg grating, or a surface relief grating (“SRG”) filled with LCs (or an index matched SRG), a PBP element, or a PVH element, etc. In some embodiments, the steering element may be a metasurface steering element.

The lens assembly or the system disclosed herein may include or be implemented in an artificial reality system. Artificial reality is a form of reality that has been adjusted in some manner before presentation to a user, which may include, e.g., a virtual reality (“VR”), an augmented reality (“AR”), a mixed reality (“MR”), or some combination and/or derivatives thereof. Artificial reality content may include computer-generated content or computer-generated content combined with captured real-world content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (“HMD”) connected to a host computer system, a standalone HMD, a mobile device or computing system, or any other hardware platform capable of providing artificial reality content to one or more viewers.

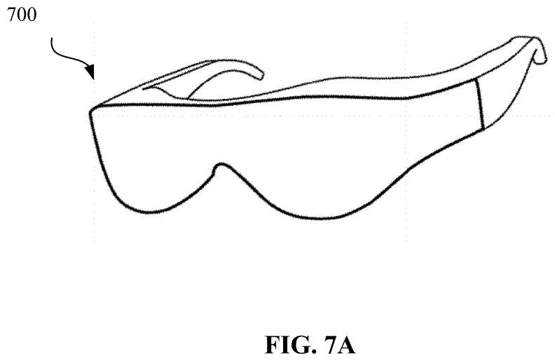

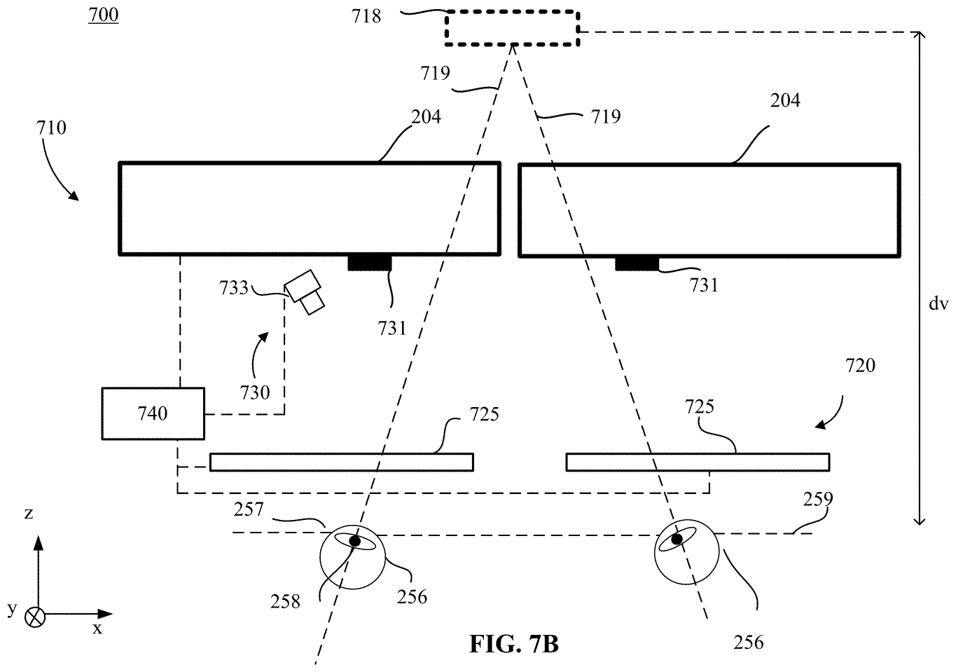

FIG. 7A illustrates a schematic diagram of an NED 700, according to an embodiment of the present disclosure. The NED 700 may be a system configured for AR, MR, and/or VR applications. In some embodiments, the NED 700 may be wearable on a head of a user (e.g., by having the form of spectacles or eyeglasses, as shown in FIG. 7A) or to be included as part of a helmet wearable by the user. In some embodiments, the NED 700 may be mountable to the head of the user, referred to as a head-mounted display. In some embodiments, the NED 700 may be configured for placement in proximity of an eye or eyes of the user at a fixed location in front of the eye(s), without being mounted to the head of the user. For example, the NED 700 may be mountable in a vehicle, such as a car or an airplane, at a location in front of an eye or eyes of the user.

FIG. 7B schematically illustrates an x-y sectional view of the NED 700 shown in FIG. 7A, according to an embodiment of the present disclosure. The NED 700 may include a display device 710, a viewing optical assembly 720, an object tracking system 730, and a controller 740 (e.g., a controller similar to the controller 216). The object tracking system 730 may be an eye tracking system and/or face tracking system. The display device 710 may display virtual (i.e., computer-generated) images to a user. In some embodiments, the display device 710 may include a single electronic display or multiple electronic displays 204. For discussion purposes, FIG. 7B shows two electronic displays 204 for left and right eyes 256 of the user, respectively. The electronic display 204 may include a display panel (also referred to as 204 for discussion purposes).

The viewing optical assembly 720 may be arranged between the display device 710 and the eyes 256, and may be configured to guide an image light for forming a virtual image output from the display device 710 to the exit pupil 257 the eye-box region 259. The exit pupil 257 may be a location where the eye pupil 258 of the eye 256 may be positioned in the eye-box region 259 of the system 700. For example, the viewing optical assembly 720 may include one or more optical elements configured to correct aberrations in an image light output from the display device 710, magnify an image light output from the display device 710, or perform another type of optical adjustment of an image light output from the display device 710. For discussion purpose, FIG. 7B shows that the viewing optical assembly 720 may include two lens assemblies 725 for the left and right eyes 256, respectively. The lens assembly 725 may be an embodiment of the lens assembly disclosed herein, such as the lens assembly 202 shown in FIGS. 2A-2G, the lens assembly 302 shown in FIG. 3A, the lens assembly 342 shown in FIG. 3B, the lens assembly 362 shown in FIG. 3C, the lens assembly 402 shown in FIG. 4A, or the lens assembly 442 shown in FIG. 4C, etc. The lens assembly 725 may provide an improved image quality at the eye-box region 259. The lens assembly 725 may include at least one path correction device to correct an optical path of an image light when one or more elements included in the lens assembly 725 is misaligned, as described above in connection with the various lens assemblies disclosed herein.

The object tracking system 730 may include an IR light source 731 configured to emit an IR light to illuminate the eyes 256 and/or the face. The object tracking system 730 may also include an optical sensor 733, such as a camera, configured to receive the IR light reflected by each eye 256 and generate a tracking signal relating to the eye 256, such as an image of the eye 256. In some embodiments, the object tracking system 730 may also include an IR deflecting element (not shown) configured to deflect the IR light reflected by the eye 256 toward the optical sensor 733. The controller 740 may be communicatively coupled with the display device 710, the viewing optical assembly 720, and/or the object tracking system 730 to control the operations thereof.

In some embodiments, the lens assembly 725 may be configured with an adjustable optical power to address an accommodation-vergence conflict in the system 700. For example, the lens assembly 725 may be configured with a large aperture size, such as 50 mm, for a large field of view, such as 65 degrees with 20 mm eye relief distance, a large optical power for adapting human eye vergence accommodation, such as ±2.0 Diopters, a fast switching speed at the milli-seconds level or tens of milliseconds level for adapting vergence-accommodation of human eyes, and a high image quality for meeting human eye acuity.

For example, each electronic display 204 may display a virtual image or a portion of the virtual image. Based on the eye tracking information provided by the eye tracking system 730, the controller 740 may determine a virtual object 718 within the virtual image at which the eyes 256 are currently looking. The controller 740 may determine a vergence depth (dv) of the gaze of the user based on the gaze point or an estimated intersection of gaze lines 719 determined by the object tracking system 730. As shown in FIG. 7B, the gaze lines 719 may converge or intersect at the distance dv, where the virtual object 718 is located. The controller 740 may control the lens assemblies 725 to adjust the optical power to provide an accommodation that matches the vergence depth (dv) associated with the virtual object 718 at which the eyes 256 are currently looking, thereby reducing the accommodation-vergence conflict in the system 700. For example, the controller 740 may control the lens assembly 725 to operate in a desirable operation state to provide an optical power corresponding to a focal plane or an image plane that matches with the vergence depth (dv).

In some embodiments, the present disclosure provides a device including a polarization non-selective partial reflector configured to transmit a first portion of a first light and reflect a second portion of the first light. The device also includes a polarization selective reflector configured to reflect the first portion of the first light received from the polarization non-selective reflector back to the polarization non-selective reflector. The device further includes a path correction device disposed between the polarization non-selective partial reflector and the polarization selective reflector, and configured to forwardly steer the first portion of the first light propagating between the polarization non-selective partial reflector and the polarization selective reflector.

In some embodiments, the device further includes a sensor configured to measure one or more alignment parameters relating to at least one of the polarization non-selective partial reflector or the polarization selective reflector. In some embodiments, the device further includes a controller configured to detect, based on the one or more alignment parameters, a misalignment of at least one of the polarization non-selective partial reflector or the polarization selective reflector. In some embodiments, the controller is further configured to control, based on the detected misalignment, the path correction device to forwardly steer the first portion of the first light by a predetermined angle, to reduce a derivation of an actual optical path from a target optical path of the first portion of the first light. In some embodiments, the path correction device includes two waveplates and a liquid crystal device disposed between the two waveplates. In some embodiments, the liquid crystal device is configured to provide a spatially varying phase shift to the first portion of the first light propagating between the polarization non-selective partial reflector and the polarization selective reflector.

In some embodiments, the polarization non-selective partial reflector is configured to reflect the first portion of the first light received from the polarization selective reflector as a second light having a predetermined polarization toward the polarization selective reflector. In some embodiments, the polarization selective reflector is configured to transmit the second light having the predetermined polarization. In some embodiments, the path correction device is configured to forwardly steer the first portion of the first light two times while the first portion of the first light propagates between the polarization non-selective partial reflector and the polarization selective reflector. In some embodiments, the path correction device is configured to maintain a propagation direction of the second light having the predetermined polarization, while transmitting the second light having the predetermined polarization. In some embodiments, the polarization non-selective partial reflector includes a 50:50 mirror. In some embodiments, the polarization selective reflector includes a reflective polarization volume hologram (“PVH”) element configured with an optical power. In some embodiments, the polarization selective reflector includes a circular reflective polarizer or a linear reflective polarizer, and the device further comprises an optical lens disposed between the polarization selective reflector and the path correction device. In some embodiments, the optical lens is a first optical lens, and the device further comprises a second optical lens, the polarization non-selective partial reflector being disposed between the path correction device and the second optical lens.

In some embodiments, the polarization selective reflector is a first polarization selective reflector, and the path correction device is a first path correction device, and the device further includes a second polarization selective reflector configured to transmit the first light toward the polarization non-selective partial reflector, the polarization non-selective partial reflector being disposed between the first path correction device and the second polarization selective reflector. The second polarization selective reflector is configured to reflect the second portion of the first light received from the polarization non-selective partial reflector back to the polarization non-selective partial reflector.

In some embodiments, the device further includes a second path correction device disposed between the polarization non-selective partial reflector and the second polarization selective reflector. The second path correction device is configured to forwardly steer the second portion of the first light propagating between the polarization non-selective partial reflector and the second polarization selective reflector to reduce a derivation of an actual optical path from a target optical path of the second portion of the first light. In some embodiments, the second path correction device is configured to forwardly steer the second portion of the first light two times while the second portion of the first light propagates between the polarization non-selective partial reflector and the second polarization selective reflector. In some embodiments, the second path correction device is configured to maintain a propagation direction of the first light received from the second polarization selective reflector, while transmitting the first light toward the polarization non-selective partial reflector.

In some embodiments, the first polarization selective reflector includes a first reflective PVH element configured with a first optical power, the first reflective PVH element being configured to reflect an input light when the input light has a first polarization, and transmit the input light when the input light has a second polarization orthogonal to the first polarization. In some embodiments, the second polarization selective reflector includes a second reflective PVH element configured with a second optical power, the second reflective PVH element being configured to reflect the input light when the input light has the second polarization, and transmit the input light when the input light has the first polarization.

In some embodiments, the present disclosure provides a method including detecting, by a controller based on a signal received from a sensor, a misalignment of at least one of a polarization non-selective partial reflector or a polarization selective reflector. The polarization non-selective partial reflector is configured to transmit a first portion of a first light and reflect a second portion of the first light, and the polarization selective reflector is configured to reflect the first portion of the first light received from the polarization non-selective reflector back to the polarization non-selective reflector. The method also includes controlling, by the controller, a path correction device disposed between the polarization non-selective partial reflector and the polarization selective reflector, to forwardly steer the first portion of the first light propagating between the polarization non-selective partial reflector and the polarization selective reflector. In some embodiments, the polarization selective reflector includes a reflective polarization volume hologram (“PVH”) element configured with an optical power. In some embodiments, the method further includes converging, by an optical lens disposed between the polarization non-selective partial reflector and the polarization selective reflector, the first portion of the first light while the first portion of the first light propagates between the polarization non-selective partial reflector and the polarization selective reflector.

In some embodiments, the present disclosure provides an optical system including a first optical component having a lens function and configured to converge an image light. The optical system also includes a second optical component having a lens function configured to converge the image light output from the first optical component to an eye-box region of the optical system. The optical system also includes a path correction device disposed between the first optical component and the second optical component, and configured to be operable in an activation state to steer the image light propagating between the first optical component and the second optical component two times to reduce an optical path deviation from a target optical path. In some embodiments, the optical system includes a controller configured to detect a misalignment of at least one of the first optical component or the second optical component, and to control the path correction device to steer the image light based on the detected misalignment. In some embodiments, the optical system also includes a sensor configured to measure an alignment parameter relating to at least one of the first optical component or the second optical component. The optical path deviation may be caused by the misalignment.

In some embodiments, the present disclosure provides an optical system including a first PVH element having a lens function and a reflection function and a second PVH element having a lens function and a reflection function. The optical system also includes a partial reflector disposed between the first PVH element and second PVH element, and configured to partially transmit an image light received from the first PVH element and partially reflect the image light independent of a polarization of the image light. The optical system includes a first path correction device disposed between the first PVH element and the partial reflector, and a second path correction device disposed between the second PVH element and the partial reflector. Each of the first path correction device and the second path correction device is operable in an activation state to steer the image light for two times as the image light propagates through each of the first path correction device and the second path correction device to reduce a deviation of an optical path from a target optical path. The optical system also includes a controller configured to detect a misalignment of at least one of the first PVH element or the second PVH element, and to control at least one of the first path correction device or the second path correction device to reduce the deviation of the optical path from the target optical path.

In some embodiments, the present disclosure also provides an optical system including an optical component having a lens and a polarization selective reflector and a PVH element having a lens function and a reflection function. The optical system also includes a partial reflector disposed between the optical component and the PVH element, and configured to partially transmit an image light received from the optical component and partially reflect the image light independent of a polarization of the image light. The optical system includes a first path correction device disposed between the optical component and the partial reflector, and a second path correction device disposed between the PVH element and the partial reflector. Each of the first path correction device and the second path correction device is operable in an activation state to steer the image light for two times as the image light propagates through each of the first path correction device and the second path correction device to reduce a deviation of an optical path from a target optical path. The optical system also includes a controller configured to detect a misalignment of at least one of the optical component or the PVH element, and to control at least one of the first path correction device or the second path correction device to reduce the deviation of the optical path from the target optical path.

In some embodiments, the present disclosure also provides an optical system including a first optical component having a first lens and a first polarization selective reflector and a second optical component having a second lens and a second polarization selective reflector. The optical system also includes a partial reflector disposed between the first optical component and the second optical component, and configured to partially transmit an image light received from the first optical component and partially reflect the image light independent of a polarization of the image light. The optical system includes a first path correction device disposed between the first optical component and the partial reflector, and a second path correction device disposed between the second optical component and the partial reflector. Each of the first path correction device and the second path correction device is operable in an activation state to steer the image light for two times as the image light propagates through each of the first path correction device and the second path correction device to reduce a deviation of an optical path from a target optical path. The optical system also includes a controller configured to detect a misalignment of at least one of the first optical component or the second optical component, and to control at least one of the first path correction device or the second path correction device to reduce the deviation of the optical path from the target optical path.

In some embodiments, the present disclosure provides an optical system including a first optical component having a first lens and a mirror, and a second optical component having a second lens and a reflective polarizer. The optical system also includes a path correction device disposed between the first optical component and the second optical component, and configured to steer an image light propagating between the first optical component and the second optical component and passing through the path correction device. The path correction device is configured to steer the image light two times to correct a deviation of an optical path of the image light from a target optical path. The deviation is caused by a misalignment of at least one of the first optical component or the second optical component.

The foregoing description of the embodiments of the present disclosure have been presented for the purpose of illustration. It is not intended to be exhaustive or to limit the disclosure to the precise forms disclosed. Persons skilled in the relevant art can appreciate that modifications and variations are possible in light of the above disclosure.

Some portions of this description may describe the embodiments of the present disclosure in terms of algorithms and symbolic representations of operations on information. These operations, while described functionally, computationally, or logically, may be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware and/or software modules, alone or in combination with other devices. In one embodiment, a software module is implemented with a computer program product including a computer-readable medium containing computer program code, which can be executed by a computer processor for performing any or all of the steps, operations, or processes described. In some embodiments, a hardware module may include hardware components such as a device, a system, an optical element, a controller, an electrical circuit, a logic gate, etc.

Embodiments of the present disclosure may also relate to an apparatus for performing the operations herein. This apparatus may be specially constructed for the specific purposes, and/or it may include a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. The non-transitory computer-readable storage medium can be a suitable medium that can store program codes, for example, a magnetic disk, an optical disk, a read-only memory (“ROM”), or a random access memory (“RAM”), an Electrically Programmable read only memory (“EPROM”), an Electrically Erasable Programmable read only memory (“EEPROM”), a register, a hard disk, a solid-state disk drive, a smart media card (“SMC”), a secure digital card (“SD”), a flash card, etc. Furthermore, computing systems described in the specification may include a single processor or may be architectures employing multiple processors for increased computing capability. The processor may be a central processing unit (“CPU”), a graphics processing unit (“GPU”), or another suitable processing device configured to process data and/or performing computation based on data. The processor may include both software and hardware components. For example, the processor may include a hardware component, such as an application-specific integrated circuit (“ASIC”), a programmable logic device (“PLD”), or a combination thereof. The PLD may be a complex programmable logic device (“CPLD”), a field-programmable gate array (“FPGA”), etc.

Embodiments of the present disclosure may also relate to a product that is produced by a computing process described herein. Such a product may include information resulting from a computing process, where the information is stored on a non-transitory, tangible computer readable storage medium and may include any embodiment of a computer program product or other data combination described herein.

Further, when an embodiment illustrated in a drawing shows a single element, it is understood that the embodiment or an embodiment not shown in the figures but within the scope of the present disclosure may include a plurality of such elements. Likewise, when an embodiment illustrated in a drawing shows a plurality of such elements, it is understood that the embodiment or an embodiment not shown in the figures but within the scope of the present disclosure may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in a suitable manner. For example, elements shown in one figure/embodiment but not shown in another figure/embodiment may nevertheless be included in the other figure/embodiment. In an optical device disclosed herein including one or more optical layers, films, plates, or elements, the numbers of the layers, films, plates, or elements shown in the figures are for illustrative purposes only. In other embodiments not shown in the figures, which are still within the scope of the present disclosure, the same or different layers, films, plates, or elements shown in the same or different figures/embodiments may be combined or repeated in various manners to form a stack.

Various embodiments have been described to illustrate the exemplary implementations. Based on the disclosed embodiments, a person having ordinary skills in the art may make various other changes, modifications, rearrangements, and substitutions without departing from the scope of the present disclosure. Thus, while the present disclosure has been described in detail with reference to the above embodiments, the present disclosure is not limited to the above described embodiments. The present disclosure may be embodied in other equivalent forms without departing from the scope of the present disclosure. The scope of the present disclosure is defined in the appended claims.

What is claimed is:

1. A device, comprising:
a polarization non-selective partial reflector configured to transmit a first portion of a first light and reflect a second portion of the first light;
a polarization selective reflector configured to reflect the first portion of the first light received from the polarization non-selective reflector back to the polarization non-selective reflector; and
a path correction device disposed between the polarization non-selective partial reflector and the polarization selective reflector, and configured to forwardly steer the first portion of the first light propagating between the polarization non-selective partial reflector and the polarization selective reflector.

2. The device of claim 1, further comprising a sensor configured to measure one or more alignment parameters relating to at least one of the polarization non-selective partial reflector or the polarization selective reflector.

3. The device of claim 2, further comprising a controller configured to detect, based on the one or more alignment parameters, a misalignment of at least one of the polarization non-selective partial reflector or the polarization selective reflector.

4. The device of claim 3, wherein the controller is further configured to control, based on the detected misalignment, the path correction device to forwardly steer the first portion of the first light by a predetermined angle, to reduce a derivation of an actual optical path from a target optical path of the first portion of the first light.

5. The device of claim 1, wherein
the path correction device includes two waveplates and a liquid crystal device disposed between the two waveplates, and
the liquid crystal device is configured to provide a spatially varying phase shift to the first portion of the first light propagating between the polarization non-selective partial reflector and the polarization selective reflector.

6. The device of claim 1, wherein
the polarization non-selective partial reflector is configured to reflect the first portion of the first light received from the polarization selective reflector as a second light having a predetermined polarization toward the polarization selective reflector, and
the polarization selective reflector is configured to transmit the second light having the predetermined polarization.

7. The device of claim 6, wherein the path correction device is configured to forwardly steer the first portion of the first light two times while the first portion of the first light propagates between the polarization non-selective partial reflector and the polarization selective reflector.

8. The device of claim 6, wherein the path correction device is configured to maintain a propagation direction of the second light having the predetermined polarization, while transmitting the second light having the predetermined polarization.

9. The device of claim 1, wherein the polarization non-selective partial reflector includes a 50:50 mirror.

10. The device of claim 1, wherein the polarization selective reflector includes a reflective polarization volume hologram (“PVH”) element configured with an optical power.

11. The device of claim 1, wherein the polarization selective reflector includes a circular reflective polarizer or a linear reflective polarizer, and the device further comprises an optical lens disposed between the polarization selective reflector and the path correction device.

12. The device of claim 11, wherein the optical lens is a first optical lens, and the device further comprises a second optical lens, the polarization non-selective partial reflector being disposed between the path correction device and the second optical lens.

13. The device of claim 1, wherein the polarization selective reflector is a first polarization selective reflector, and the path correction device is a first path correction device, and the device further includes:
a second polarization selective reflector configured to transmit the first light toward the polarization non-selective partial reflector, the polarization non-selective partial reflector being disposed between the first path correction device and the second polarization selective reflector,
wherein the second polarization selective reflector is configured to reflect the second portion of the first light received from the polarization non-selective partial reflector back to the polarization non-selective partial reflector.

14. The device of claim 13, further comprising:
a second path correction device disposed between the polarization non-selective partial reflector and the second polarization selective reflector,
wherein the second path correction device is configured to forwardly steer the second portion of the first light propagating between the polarization non-selective partial reflector and the second polarization selective reflector to reduce a derivation of an actual optical path from a target optical path of the second portion of the first light.

15. The device of claim 14, wherein the second path correction device is configured to forwardly steer the second portion of the first light two times while the second portion of the first light propagates between the polarization non-selective partial reflector and the second polarization selective reflector.

16. The device of claim 14, wherein the second path correction device is configured to maintain a propagation direction of the first light received from the second polarization selective reflector, while transmitting the first light toward the polarization non-selective partial reflector.

17. The device of claim 13, wherein
the first polarization selective reflector includes a first reflective PVH element configured with a first optical power, the first reflective PVH element being configured to reflect an input light when the input light has a first polarization, and transmit the input light when the input light has a second polarization orthogonal to the first polarization,
the second polarization selective reflector includes a second reflective PVH element configured with a second optical power, the second reflective PVH element being configured to reflect the input light when the input light has the second polarization, and transmit the input light when the input light has the first polarization.

18. A method, comprising:
detecting, by a controller based on a signal received from a sensor, a misalignment of at least one of a polarization non-selective partial reflector or a polarization selective reflector, the polarization non-selective partial reflector being configured to transmit a first portion of a first light and reflect a second portion of the first light, and the polarization selective reflector being configured to reflect the first portion of the first light received from the polarization non-selective reflector back to the polarization non-selective reflector; and
controlling, by the controller, a path correction device disposed between the polarization non-selective partial reflector and the polarization selective reflector, to forwardly steer the first portion of the first light propagating between the polarization non-selective partial reflector and the polarization selective reflector.

19. The method of claim 18, wherein the polarization selective reflector includes a reflective polarization volume hologram (“PVH”) element configured with an optical power.

20. The method of claim 18, further comprising:
converging, by an optical lens disposed between the polarization non-selective partial reflector and the polarization selective reflector, the first portion of the first light while the first portion of the first light propagates between the polarization non-selective partial reflector and the polarization selective reflector.
